(19) United States
(12) Patent Application Publication
(10) Pub. No.: US 2006/0032390 A1
(43) Pub. Date: Feb. 16, 2006

(54) Lithographic printing plate precursor and lithographic printing method

(75) Inventors: Satoshi Hoshi, Haibara-gun (JP); Kazuto Shimada, Haibara-gun (JP); Norio Aoshima, Haibara-gun (JP); Masatoshi Yumoto, Fujinomiya-shi (JP); Koreshige Ito, Fujinomiya-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/190,924

(22) Filed: Jul. 28, 2005

(30) Foreign Application Priority Data
Jul. 30, 2004 (JP) P.2004-222932
Sep. 13, 2004 (JP) P.2004-264982

(51) Int. Cl. B41N 1/00

(52) U.S. Cl. 101/453

(57) ABSTRACT

A lithographic printing plate precursor having a support, and an image recording layer containing a microcapsule and (A) an active light absorber, removable by a printing ink and/or fountain solution on the support, characterized in that the microcapsule is a specific urethane type microcapsule, and a lithographic printing method using the same.

### BACKGROUND OF THE INVENTION

1. Field of the Invention

The present invention relates to an on-press development type lithographic printing plate precursor capable of image recording by a laser, and a lithographic printing method using the same.

2. Background Art

In general, a lithographic printing plate includes oleophilic image areas which receive ink during a printing process, and hydrophilic non-image areas which receive fountain solution. The lithographic printing is the following printing method. Utilizing the property that water and an oil base ink mutually repel, the oleophilic image areas of the lithographic printing plate are allowed to serve as ink-receptive areas, and the hydrophilic non-image areas are allowed to serve as fountain solution-receptive areas (non-ink receptive areas). This causes a difference in deposition of the ink in the surface of the lithographic printing plate. Accordingly, only the image areas are subjected to inking. Then, the ink is transferred onto a to-be-printed matter such as paper.

For fabricating the lithographic printing plate, conventionally, a lithographic printing plate precursor (PS plate) including an oleophilic photosensitive resin layer (image recording layer) on a hydrophilic support has been widely used. In general, a lithographic printing plate precursor is exposed to light through an original picture of a lith film or the like. Then, the portions to be the image areas of an image recording layer are left, and other unnecessary portions of the image recording layer are dissolved and removed by an alkaline developer or an organic solvent, so that the hydrophilic support surface is exposed, resulting in the formation of the non-image areas. Plate-making is carried out in this manner, thereby to obtain a lithographic printing plate.

In the conventional plate-making process of a lithographic printing plate precursor, a step of dissolving and removing the unnecessary portions of the image recording layer by a developer or the like after exposure is required. Elimination of the necessity of, or simplification of such a wet treatment to be additionally carried out is mentioned as one of the problems. Particularly, in recent years, disposal of the liquid wastes exhausted in connection with the wet treatment has become a large interest for the entire industry in consideration of the global environment. Thus, a demand for the solution of the problem has become increasingly stronger.

In contrast, as one of simple plate-making methods, the following method referred to as an on-press development has been proposed. Such an image recording layer as to enable the removal of the unnecessary portions of the image recording layer in a general printing process is used. After exposure, the unnecessary portions of the image recording layer are removed on a printer press, thereby to obtain a lithographic printing plate.

As specific methods of the on-press development, for example, mention may be made of: a method using a lithographic printing plate precursor having an image recording layer capable of being dissolved or dispersed in fountain solution, an ink solvent, or an emulsion of fountain solution and an ink, a method in which the mechanical removal of the image recording layer is carried out by contact with the rollers or a blanket of a printer press, and a method in which the cohesion power of the image recording layer or the adhesion between the image recording layer and a support is weakened by permeation of fountain solution, an ink solvent, or the like, and then, the mechanical removal of the image recording layer is carried out by contact with the rollers or a blanket.

Incidentally, in the invention, unless otherwise specified, the term “development treatment step” denotes the step of, by the use of a device other than a printer press (generally, an automatic developing machine), removing the infrared laser-unexposed portions of an image recording layer of a lithographic printing plate precursor by contact with a liquid (generally, an alkaline developer), and exposing the hydrophilic support surface. The term “on-press development” denotes the method and the step of, by the use of a printer press, removing the infrared laser-unexposed portions of an image recording layer of a lithographic printing plate precursor by contact with a liquid (generally, a printing ink and/or fountain solution), and exposing the hydrophilic support surface.

On the other hand, in recent years, a digitization technology for electronically processing image information by using a computer, and storing and outputting it has come into widespread use. Various new image output systems adaptable to such a digitization technology have come into actual use. Accordingly, a computer-to-plate technology has attracted attention, in which digitized information is carried on a highly converging radiation such as a laser light, and a lithographic printing plate precursor is scan-exposed to the light, thus to directly manufacture a lithographic printing plate without the intervention of a lith film. Therefore, it becomes one of the important technical problems to obtain a lithographic printing plate precursor adaptable to such a technology.

As described above, in recent years, the demand for a simplified, dry-system, and non-processing plate-making operation has become stronger than ever from both aspects of consideration for global environment and adaptation for digitization. Thus, a study responding thereto has been conducted.

For example, Patent Document 1: Japanese Patent No. 2938397 described a lithographic printing plate precursor including an image forming layer in which hydrophobic thermoplastic polymer particles are dispersed in a hydrophilic binder on a hydrophilic support. The Patent Document 1 describes to the effect that the following procedure is possible. The lithographic printing plate precursor is exposed to an infrared laser, so that the hydrophobic thermoplastic polymer particles are united by heat, thereby forming an image. Then, the plate is attached on a cylinder of a printer press to be subjected to on-press development by fountain solution and/or an ink.

The method in which an image is thus formed by merely the union of fine particles due to thermal fusion exhibits a favorable on-press developability. However, unfavorably, the image strength is very weak and the plate wear resistance is insufficient.

For this reason, a study has been conducted on the use of a polymerization reaction for the improvement of the plate wear resistance. For example, Patent Documents 2 and 3: JP-A-2001-277740 and JP-A-2001-277742 describe a lithographic printing precursor including a microcapsule encapsulating a polymerizable compound on a hydrophilic support.

Whereas, Patent Document 4: JP-A-2002-287334 describes a lithographic printing plate precursor including a photosensitive layer containing an infrared absorber, a radical polymerization initiator, and a polymerizable compound provided on a support.

Further, Patent Document 5: JP-A-2000-39711 describes a lithographic printing plate precursor using a photosensitive composition containing on an aluminum support, (a) water-soluble or water-dispersible polymer, (b) a monomer or oligomer having a photopolymerizable ethylenically unsaturated double bond, and (c) a photopolymerization initiation system having an absorption maximum in the ultraviolet region, which is on-press developable after exposure.

Still further, Patent Document 6: JP-A-2004-98555 describes, as a lithographic printing plate precursor excellent in on-press developability, an precursor for a lithographic printing plate having, on a support, an image forming layer containing (1) a microcapsule encapsulating at least one compound selected from compounds having at least two functional groups crosslinkable by an acid, and compounds having at least two functional groups polymerizable by a radical, (2) a light-heat converting agent, and (3) a reaction accelerator, characterized in that a hydrophilic polymer is covalently bonded to the surface of the capsule wall of the microcapsule.

Herein, Patent Document 6 describes that as the microcapsule wall to which a hydrophilic polymer is covalently bonded, the one formed by polymerization with an isocyanate compound containing an adduct of (A) a hydrophilic polymer having an active hydrogen group reactable with an isocyanate group in the molecule, and having an average molecular weight of 500 to 50,000 with (B) a multifunctional isocyanate compound having two or more isocyanate groups in the molecule is used. However, this document relates to a coating solution system using a hydrophilic resin as a binder, if required, and mainly containing water. Whereas, the microcapsule of Patent Document 6 is characterized in that an adduct obtained by previously allowing an isocyanate group and a hydrophilic polymer having and an active hydrogen group is prepared, and then, the capsule wall is formed. However, with this method, the ratio of active hydrogen and isocyanate is preferably a ratio of 1/100 to 50/100 mol ratio, and hence an increase in active hydrogen group ratio makes the capsule formation difficult. Namely, from the viewpoints of imparting the dispersion stability and surface hydrophilicity to the microcapsule, a hydrophilic polymer having a larger number of active hydrogen groups is preferably introduced. However, this is difficult to achieve for the foregoing reason. Whereas, the hydrophilic polymer is most preferably present only on the outermost surface of the wall. However, with this method, the hydrophilic polymer is also present in the interior of the wall structure. This entails a concern with the encapsulated matters due to the reduction of the crosslinking density of the wall. Thus, in order to apply the microcapsule of Patent Document 6 to a completely processing-free printing plate not requiring a development treatment step, it is necessary to further improve the surface hydrophilicity, and the leakage of the encapsulated matters, thereby to improve the printing stain resistance.

Whereas, there is disclosed a heat-sensitive precursor for a lithographic printing plate having a hydrophilic image forming layer in which thermoplastic polymer fine particles are dispersed in a matrix such as a hydrophilic resin, on a support having a hydrophilic surface (e.g., see, Patent Document 1: Japanese Patent No. 2938397, and Patent Documents 7 and 8: JP-A-9-127683 and WO 99/10186, respectively). With this configuration, the image forming layer is applied with heat by infrared exposure or the like, so that the thermoplastic polymer fine particles are fused and united. As a result, the hydrophilic image forming layer surface is converted to the oleophilic image portion. The lithographic printing plate including the image areas formed therein is mounted on a printer press. While rotating a plate cylinder, fountain solution and an ink are supplied to the printing plate. As a result, the unheated portions are removed as if they have been subjected to a development treatment. This method (on-press development method) can omit the conventionally performed development treatment using an automatic developing machine or the like.

Whereas, a proposal has been also made in which a material for lithographic printing containing a micro gel having a group to be decomposed by at least one energy of light and heat on the surface, and an infrared absorber in an image recording layer is subjected to on-press development (e.g., see, Patent Document 9: JP-A-2000-238452).

However, the on-press development type processing-free lithographic printing plate has the cost- and time-consuming problems as follows: the removal of unexposed areas depends upon the conditions for the start of the operation of the printer press; the removed matters containing a large amount of oleophilic components contaminate a fountain solution roller or fountain solution, and hence several tens to several hundreds sheets are required to be printed, or the roller is required to be cleaned for obtaining favorable printed matters; and the like.

Further, a heat-sensitive precursor for a lithographic printing plate having a photosensitive layer in which thermoplastic polymer fine particles are dispersed in a crosslinked hydrophilic resin is proposed (e.g., see, Non-Patent Document 1: Research/Disclosure Journal, January, 1992, No. 33303). Whereas, a heat-sensitive precursor for a lithographic printing plate having a hydrophilic layer in which microcapsules encapsulating an oleophilic component as oleophilic fine particles are dispersed in a crosslinked hydrophilic binder polymer is also proposed (e.g., see, Patent Documents 10 to 13: JP-A-7-1849, JP-A-7-1850, JP-A-10-6468, and JP-A-11-70756, respectively). These heat-sensitive precursors for lithographic printing plates each use the surface configuration of oleophilic image areas formed by heat resulting from exposure and hydrophilic non-image areas of the unexposed portions as a printing surface, and hence can carry out lithographic printing using fountain solution without requiring on-press development on a completely processing-free basis.

The image recording layer of the on-press development type lithographic printing plate precursor has a composition containing a larger amount of low molecular weight components (e.g., a polymerizable compound) and hydrophilic components (e.g., a water soluble polymerization initiator, a surfactant, and a water dispersible microcapsule) as compared with the one of a general alkali development treatment type in order to facilitate the removal of the unexposed areas on a printer press.

The formation of the image recording layer is generally carried out by dissolving or dispersing these on-press development accelerating components with other components, and thereby preparing a coating solution, followed by coating and drying. Conventionally, the microcapsule uses a water soluble polymer such as partially saponified polyvinyl alcohol as a protective colloid, and hence it is excellent in stability in a coating solution containing water as a main component. However, in a coating solution containing an organic solvent as a main component, the hydrophilic on-press development accelerating components are poor in stability. Particularly, the microcapsules unfavorably agglomerate and precipitate upon standing of the coating solution.

### SUMMARY OF THE INVENTION

The invention aims to solve the problems. An object of the invention is to provide a lithographic printing plate precursor excellent in stability with time of an image recording layer coating solution, and further, good in on-press developability and printing performances.

Further, when on-press development is carried out using a conventional precursor for a lithographic printing plate, the hydrophilicity and durability of a hydrophilic layer provided on a substrate is insufficient. Unfavorably, greasing tends to occur depending upon the printing conditions, and further, stains gradually occur in non-image areas with printing.

Another object of the invention is to provide a lithographic printing plate precursor excellent in plate wear resistance, and further good in on-press developability and printing performance.

The inventors conducted a close study on the improvement of the stability with time of a coating solution containing an organic solvent as a main component. As a result, they found that a specific urethane type microcapsule can solve the foregoing problems, leading to the completion of the invention.

Namely, the invention is as follows.

1. A lithographic printing plate precursor comprising a support and an image recording layer removable by a printing ink and/or fountain solution, the image recording layer containing a microcapsule and (A) an active light absorber, wherein the microcapsule is produced by

dissolving a multifunctional isocyanate compound having two or more isocyanate groups in a water immiscible solvent,

emulsifying and dispersing the solution in an aqueous solution containing a hydrophilic polymer having one or more active hydrogen groups reactable with isocyanate groups at one terminal, and then,

removing the solvent from the oil droplet in the emulsified and dispersed solution.

2. A lithographic printing plate precursor comprising a support and an image recording layer removable by a printing ink and/or fountain solution, the image recording layer containing (A) an active light absorber and a microcapsule encapsulating a hydrophobic compound, wherein the microcapsule is produced by

dissolving a multifunctional isocyanate compound having two or more isocyanate groups and the hydrophobic compound in a water immiscible solvent,

emulsifying and dispersing the solution in an aqueous solution containing a hydrophilic polymer having one or more active hydrogen groups reactable with isocyanate groups at one terminal, and then,

removing the solvent from the oil droplet in the emulsified and dispersed solution.

3. A lithographic printing plate precursor comprising a support and an image recording layer removable by a printing ink and/or fountain solution, the image recording layer containing (A) an active light absorber, (B) a polymerization initiator, (C) a polymerizable compound, (D) a hydrophobic binder polymer and a microcapsule, in which the microcapsule encapsulates at least one of the (A) to (D), wherein the microcapsule is produced by

dissolving a multifunctional isocyanate compound having two or more isocyanate groups and at least one of (A) the active light absorber, (B) the polymerization initiator, (C) the polymerizable compound, and (D) the hydrophobic binder polymer in a water immiscible solvent,

emulsifying and dispersing the solution in an aqueous solution containing a hydrophilic polymer having one or more active hydrogen groups reactable with isocyanate groups at one terminal, and then,

removing the solvent from the oil droplet in the emulsified and dispersed solution.

4. A lithographic printing plate precursor comprising a support and an image recording layer removable by a printing ink and/or fountain solution, the image recording layer containing (A) an active light absorber, (B) a polymerization initiator, (C) a polymerizable compound, (D) a hydrophobic binder polymer and a microcapsule, wherein the microcapsule encapsulates at least one of the (A) to (D), and the microcapsule includes polyurea or polyurethane/urea obtained by the polymerization reaction of an isocyanate compound and a compound having an active hydrogen as the wall material, in which the isocyanate compound includes a reaction product of (1) an at least di-functional isocyanate compound and (2) a polyether derivative having a terminal amino group, represented by the following general formula (I):
R—O [symbol] L-O [symbol] ₙ [symbol] X [symbol] ₘA-NH₂ (I)
where X represents a linking group, A represents an allylene group or an alkylene group, L represents an alkylene group, and R represents an organic group not having an active hydrogen, m represents 0 or 1; and n is a number of 10 to 500 in terms of the average addition mole number of a polyether group.

5. The lithographic printing plate precursor according to any one of the above items 1 to 4, wherein the image recording layer further contains another microcapsule or micro gel encapsulating at least one of the components (A) to (D).

6. a lithographic printing method comprising:

mounting the lithographic printing plate precursor according to any one of the above items 1 to 5 on a printer press and then imagewise exposing the plate precursor to light by an infrared laser, or imagewise exposing the plate precursor to light by an infrared laser and then mounting the plate precursor on a printer press; and

feeding a printing ink and fountain solution to the plate precursor and thereby removing the infrared laser unexposed areas of the image recording layer to perform a printing.

In accordance with the present invention, it is possible to provide a lithographic printing plate precursor excellent in stability with time of an image recording layer coating solution, excellent in plate wear resistance, and further good in on-press developability and printing performance.

### DETAILED DESCRIPTION OF THE INVENTION

[Image Recording Layer]

A lithographic printing plate precursor of the present invention has, on a support, an image recording layer removable by a printing ink and/or fountain solution, containing a microcapsule, and (A) an active light absorber.

The lithographic printing plate precursor of the invention preferably has, on a support, an image recording layer removable by a printing ink and/or fountain solution, containing a microcapsule encapsulating a hydrophobic compound, and (A) an active light absorber.

The lithographic printing plate precursor of the invention more preferably has, on a support, an image recording layer removable by a printing ink and/or fountain solution, containing (A) an active light absorber, (B) a polymerization initiator, (C) a polymerizable compound, and (D) a hydrophobic binder polymer, and containing a microcapsule encapsulating at least one of the foregoing items (A) to (C).

Below, these image recording layer components will be described.

(A) Active Light Absorber

When the lithographic printing plate precursor of the invention is exposed to an infrared ray, the image recording layer is preferably allowed to contain an infrared absorber as an active light absorber. Whereas, when the lithographic printing plate precursor of the invention is exposed to a 250- to 420-nm light, the image recording layer is preferably allowed to contain a sensitizing dye absorbing a 250- to 420-nm light as an active light absorber.

The infrared absorber has a function of converting the absorbed infrared ray into heat, and thermally decomposes a polymerization initiator described later by the heat generated in this step. Whereas, the sensitizing dye causes electron transfer or energy transfer of the light energy to the polymerization initiator. Thus, they efficiently generate radicals. This can improve the sensitivity of the lithographic printing plate precursor.

The infrared absorber for use in the invention is a dye or a pigment having an absorption maximum at a wavelength of 760 to 1200 nm.

As the dyes, there can be used commercially available dyes, and, for example, the known ones described in literatures such as Sennryo Binnran, (edited by the Society of Synthetic Organic Chemistry, Japan, published in 1970). Specific examples thereof may include dyes such as azo dyes, metal complex salt azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts, and metal thiolate complexes.

As preferred dyes, for example, mention may be made of cyamine dyes described in JP-A-58-125246, JP-A-59-84356, JP-A-60-78787, and the like; methine dyes described in JP-A-58-173696, JP-A-58-181690, JP-A-58-194595, and the like; naphthoquinone dyes described in JP-A-58-112793, JP-A-58-224793, JP-A-59-48187, JP-A-59-73996, JP-A-60-52940, JP-A-60-63744, and the like; squarylium dyes described in JP-A-58-112792 and the like; and cyanine dyes described in GB No. 434,875.

Further, the near infrared absorbing sensitizers described in U.S. Pat. No. 5,156,938 are also preferably used. Whereas, substituted arylbenzo(thio)pyrylium salts described in U.S. Pat. No. 3,881,924, trimethinethiapyrylium salts described in JP-A-57-142645 (U.S. Pat. No. 4,327,169), pyrylium type compounds described in JP-A-58-181051, JP-A-58-220143, JP-A-59-41363, JP-A-59-84248, JP-A-59-84249, JP-A-59-146063, and JP-A-59-146061, cyanine dyes described in JP-A-59-216146, pentamethinethiopyrylium salts and the like described in U.S. Pat. No. 4,283,475, and pyrylium compounds described in JP-B-5-13514 and JP-B-5-19702 are also preferably used. Further, other preferred examples of the dye may include near infrared absorbing dyes described as formulae (I) and (II) in U.S. Pat. No. 4,756,993.

Out of these dyes, as particularly preferred ones, mention may be made of cyanine dyes, squarylium dyes, pyrylium salts, nickel thiolate complexes, and indolenine cyanine dyes. Further, cyanine dyes and indolenine cyanine dyes are preferred. As one particularly preferred example thereof, mention may be made of a cyanine dye represented by the following formula (V): 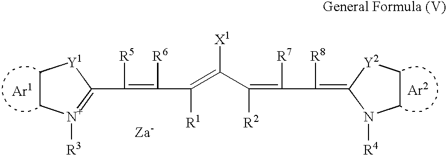
where in the general formula (V), X¹ represents a hydrogen atom, a halogen atom, —NPh₂, X²L¹, or a group shown below:

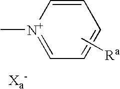

X² represents an oxygen atom, a nitrogen atom, or a sulfur atom, L¹ represents a hydrocarbon group having 1 to 12 carbon atoms, an aromatic ring having a heteroatom, or a heteroatom-containing hydrocarbon group having 1 to 12 carbon atoms. Incidentally, herein, the heteroatom represents N, S, O, a halogen atom, or Se. Xa⁻ is defined in the same manner as Za⁻ described below, and R⁴ represents a substituent selected from a hydrogen atom, an alkyl group, an aryl group, a substituted or unsubstituted amino group, and a halogen atom.

R¹ and R² each independently represent a hydrogen group having 1 to 12 carbon atoms. In view of the storage stability of the recording layer coating solution, R¹ and R² each are preferably a hydrocarbon group having two or more carbon atoms, and further R¹ and R² are in particular preferably combined with each other to form a 5-membered or 6-membered ring.

Ar¹ and Ar² may be respectively the same or different, and each represent an aromatic hydrocarbon which may have a substituent. As preferred aromatic hydrocarbon groups, mention may be made of a benzene ring and a naphthalene ring. Whereas, as preferred substituents, mention may be made of a hydrocarbon group having 12 or less carbon atoms, a halogen atom, and an alkoxy group having 12 or less carbon atoms. Y¹ and Y² may be respectively the same or different, and each represent a sulfur atom or a dialkylmethylene group having 12 or less carbon atoms. R³ and R⁴ may be respectively the same or different, and each represent a hydrocarbon group having 20 or less carbon atoms, which may have a substituent. As preferred substituents, mention may be made of an alkoxy group having 12 or less carbon atoms, a carboxyl group, and a sulfo group. R⁵, R⁶, R⁷, and R⁸ may be respectively the same or different, and each represent a hydrogen atom or a hydrocarbon group having 12 or less carbon atoms. They are each preferably a hydrogen atom in terms of the availability of the raw material. Whereas, Za⁻ represents a counter anion. However, when the cyanine coloring matter represented by the general formula (V) has an anionic substituent in the structure, and does not require the neutralization of electric charge, Za⁻ is not necessary. Preferred Za⁻ is, in view of the storage stability of the recording layer coating solution, a halogen ion, a perchlorate ion, a tetrafluoroborate ion, a hexafluorophosphate ion, or a sulfonate ion, and in particular preferably, a perchlorate ion, a hexafluorophosphate ion, or an aryl sulfonate ion.

In the invention, specific examples of the preferably usable cyanine coloring matter represented by the general formula (V) may include the ones described in paragraph Nos. [0017] to [0019] of JP-A-2001-133969.

Whereas, other particularly preferred examples thereof may further include specific indolenine cyanine coloring matters described in JP-A-2002-278057.

As the pigment for use in the invention, there may be used commercially available pigments, and the pigments described in Color Index (C.I.) catalog, SAISHINN GANNRYOU BINNRANN (edited by Japan Pigment Technical Association, published in 1977), SAISHINN GANNRYOU OUYOU GIJYUTSU (CMC Publishing Co., Ltd., published in 1986), and INNSATSU INK GIJYUTSU (CMC Publishing Co., Ltd., published in 1984).

As the types of pigments, mention may be made of black pigments, yellow pigments, orange pigments, brown pigments, red pigments, purple pigments, blue pigments, green pigments, fluorescent pigments, metal powder pigments, and in addition, polymer-bonded coloring matter. Specifically, there are usable insoluble azo pigments, azo lake pigments, condensed azo pigments, chelate azo pigments, phthalocyanine type pigments, anthraquinone type pigments, perylene and perynone type pigments, thioindigo type pigments, quinacridone type pigments, dioxazine type pigments, isoindolinone type pigments, quinophthalone type pigments, dyed lake pigments, azine pigments, nitroso pigments, nitro pigments, natural pigments, fluorescent pigments, inorganic pigments, carbon black, and the like. Out of these pigments, preferred is carbon black.

The pigments may not be surface-treated to be used, or may be surface-treated to be used. The conceivable methods of surface treatment include: a method of coating resin or wax on the surface, a method of attaching a surfactant, a method of bonding a reactive substance (e.g., a silane coupling agent, an epoxy compound, or polyisocyanate) onto the surface of the pigment, and other methods. The methods are described in KINZOKU SEKKENN NO SEISHITSU TO OUYOU, (Saiwai Shobo), INNSATSU INK GIJYUTSU, (CMC publishing Co., Ltd., 1984), and SAISHINN GANNRYOU OUYOU GIJYUTSU, (CMC Publishing Co. Ltd., 1986).

The particle diameter of the pigment is preferably in the range of 0.01 to 10 μm, further preferably in the range of 0.05 to 1 μm, and in particular preferably in the range of 0.1 to 1 μm. Within this range, it is possible to obtain the favorable stability of the pigment dispersion in the image recording layer coating solution and the favorable uniformity of the image recording layer.

As the methods for dispersing the pigment, known dispersion techniques for use in the production of an ink or the production of a toner may be used. As the dispersing machines, mention may be made of an ultrasonic dispersing machine, a sand mill, an attritor, a pearl mill, a super-mill, a ball mill, an impeller, a disperser, a KD mill, a colloid mill, a dynatron, a three roll mill, and an pressure kneader. These are described in detail in SAISHINN GANNRYOU QUYOU GIJYUTSU, (CMC Publishing Co., Ltd., 1986).

These infrared absorbers are each preferably added to the image recording layer in a required minimum amount in order to suppress the side effects inhibiting the polymerization reaction.

These infrared absorbers can be added in a preparation of 0.001 to 50 mass %, preferably 0.005 to 30 mass %, and in particularly preferably 0.01 to 10 mass % based on the total solid content of the image recording layer. Within this range, it is possible to obtain high sensitivity without imposing undesirable effects on the uniformity and the film strength of the image recording layer.

The sensitizing dye for use in the invention is a compound having an absorption at a wavelength of 250 to 420 nm. Specific examples thereof may include benzoin, benzoinmethyl ether, benzoinethyl ether, 9-fluorenone, 2-chloro-9-fluorenone, 2-methyl-9-fluorenone, 9-anthrone, 2bromo-9-anthrone, 2-ethyl-9-anthrone, 9,10-anthraquinone, 2-ethyl-9,10-anthraquinone, 2-t-butyl-9,10-anthraquinone, 2,6-dichloro-9,10-anthraquinone, xanthene, 2-methylxanthone, 2-methoxyxanthone, thioxanthone, benzyl, dibenzalacetone, p-(dimethylamino)phenyl styryl ketone, p-(dimethylamino)phenyl p-methyl styryl ketone, benzophenone, p-(dimethylamino)benzophenone (or Michler's ketone), p-(diethylamino)benzophenone, and benzanthrone.

Further, as preferred sensitizing dyes in the invention, mention may be made of the compounds represented by the general formula (VI) described in JP-B-51-48516.

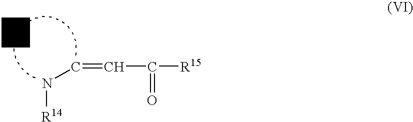

In the formula, R¹⁴ represents an alkyl group (e.g., a methyl group, an ethyl group, or a propyl group), or a substituted alkyl group (e.g., a 2-hydroxyethyl group, a 2-methoxyethyl group, a carboxymethyl group, or a 2-carboxyethyl group). R¹⁵ represents an alkyl group (e.g., a methyl group or an ethyl group), or an aryl group (e.g., a phenyl group, a p-hydroxyphenyl group, a naphthyl group, or a thienyl group).

Z² represents a non metal atomic group necessary for forming a nitrogen-containing heterocyclic nucleus commonly used in a cyanine coloring matter, such as each of benzothiazoles 9(such as benzothiazole, 5-chlorobenzothiazole, or 6-chlorobenzothiazole), naphthothiazole (such as αnaphthothiazole and β-naphthothiazole), benzoselenazoles (such as benzoselenazole, 5-chlorobenzoselenazole, and 6-methoxybenzoselenazole), naphthoselenazoles (such as α-naphthoselenazole and β-naphthoselenazole), benzoxazoles (such as benzoxazole, 5-methylbenzoxazole, and 5-phenylbenzoxazole), and naphthoxazoles (such as α-naphthoxazole and β-naphthoxazole).

Specific examples of the compound represented by the general formula (VI) may include those having a chemical structure of a combination of Z², R¹⁴, and R¹⁵, and mostly present as known substances. Therefore, they may be appropriately selected from the known ones to be used. Further, as the preferred sensitizing dyes in the invention, mention may be made of merocyanine coloring matters described in JP-B-5-47095, and also ketocumarine type compounds represented by the following general formula (VII): 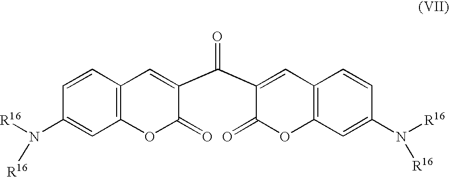
where R¹⁶ represents an alkyl group such as a methyl group or an ethyl group.

As the sensitizing dye, the merocyanine type coloring matters described in JP-A-2000-147763 are also usable. Specifically, mention may be made of the following compounds:

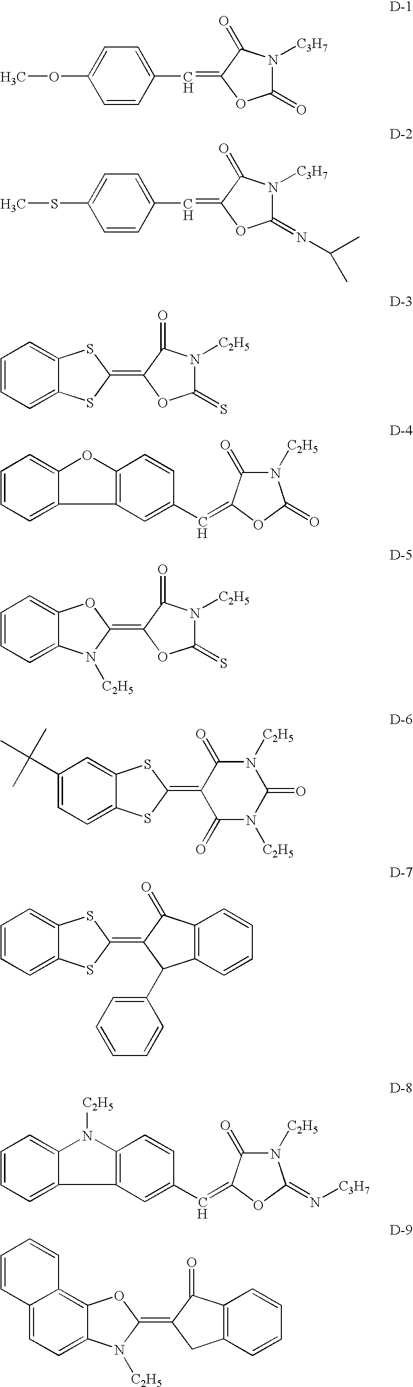

These sensitizing dyes can be added in a preparation of preferably 0.1 to 50 mass %, more preferably 0.5 to 30 mass %, in particular preferably 0.8 to 20 mass % based on the total solid content forming the image recording layer.

(B) Polymerization Initiator

The polymerization initiator usable in the invention is a compound which generates radicals by light or heat, or both the energies, and initiates or accelerates the polymerization of a compound having a polymerizable unsaturated group. As the polymerization initiators usable in the invention, mention may be made of known thermal polymerization initiators, compounds having a bond with a small bond dissociation energy, a photopolymerization initiator, and the like.

Examples of the foregoing polymerization initiator may include organic halogen compounds, carbonyl compounds, organic peroxides, azo type polymerization initiators, azido compounds, metallocene compounds, hexaarylbiimidazole compounds, organoboron compounds, disulfone compounds, oxime ester compounds, and onium salt compounds.

Specific examples of the organohalogen compounds may include the compounds described in Wakabayashi et al., Bull. Chem. Soc., Japan 42, 2924 (1969), U.S. Pat. No. 3,905,815, JP-B-46-4605, JP-A-48-36281, JP-A-53-133428, JP-A-55-32070, JP-A-60-239736, JP-A61-169835, JP-A-61-169837, JP-A-62-58241, JP-A-62-212401, JP-A-63-70243, JP-A-63-298339, M. P. Hutt, Journal of Heterocyclic Chemistry, 1 (No. 3) (1970), and the like. Out of these, trihalomethyl group-substituted oxazole compounds and S-triazine compounds are preferred.

More preferably, mention may be made of s-triazine derivatives in which at least one mono-, di-, or tri-halogen-substituted methyl group is bonded to the s-triazine ring, specifically, for example, 2,4,6-tris(monochloromethyl)-s-triazine, 2,4,6-tris(dichloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichloroethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(p-i-propyloxystyryl)-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2-[4-(p-hydroxybenzoylamino)phenyl]-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethyl)-s-triazine.

As the carbonyl compounds, mention may be made of benzophenone derivatives such as benzophenone, Michler's ketone, 2-methylbenzophenone, 3-methylbenzophenone, 4-methylbenzophenone, 2-chlorobenzophenone, 4-bromobenzophenone, and 2-carboxybenzophenone, acetophenone derivatives such as 2,2-dimethoxy-2-phenylacetophenone, 2,2-diethoxyacetophenone, 1-hydroxycyclohexyl phenyl ketone, α-hydroxy-2-methylphenyl propanone, 1-hydroxy-1-methylethyl-(p-isopropyl phenyl)ketone, 1-hydroxy-1-(p-dodecyl phenyl)ketone, 2-methyl-(4′-(methylthio)phenyl)-2-morpholino-1-propanone, and 1,1,1-trichloromethyl-(p-butylphenyl)ketone, thioxanthone derivatives such as thioxanthone, 2-ethylthioxanthone, 2-isopropylthioxanthone, 2-chlorothioxanthone, 2,4-dimethylthioxanthone, 2,4-diethylthioxanthone, and 2,4-diisopropylthioxanthone, benzoate derivatives such as ethyl p-dimethylaminobenzoate and ethyl p-diethylaminobenzoate, and the like.

As the azo compounds, for example, the azo compounds described in JP-A-8-108621, and the like are usable.

Examples of the organic peroxide may include trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butyl hydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, succinic acid peroxide, benzoyl peroxide, 2,4-dichlorobenzoyl peroxide, diisopropyl peroxydicarbonate, di-2-ethylhexyl peroxydicarbonate, di-2-ethoxyethyl peroxydicarbonate, dimethoxy isopropylperoxy carbonate, di(3-methyl-3-methoxybutyl)peroxydicarbonate, tert-butylperoxy acetate, tert-butylperoxy pivalate, tert-butylperoxy neodecanoate, tert-butylperoxy octanoate, tert-butylperoxy laurate, tertiary carbonate, 3,3′,4,4′-tetra-(t-butylperoxycarbonyl)benzophenone, 3,3′,4,4′-tetra-(t-hexylperoxycarbonyl)benzophenone, 3,3′,4,4′-tetra-(p-isopropylcumylperoxycarbonyl)benzophenone, carbonyl di(t-butylperoxy dihydrogen diphthalate), and carbonyl di(t-hexylperoxy dihydrogen diphthalate).

As the metallocene compounds, mention may be made of various titanocene compounds described in JP-A-59-152396, JP-A-61-151197, JP-A-63-41484, JP-A-2-249, JP-A-2-4705, and JP-A-5-83588, for example, di-cyclopentadienyl-Ti-bis-phenyl, di-cyclopentadienyl-Ti-bis-2,6-diflourophen-1-yl, di-cyclopentadienyl-Ti-bis-2,4-di-fluorophen-1-yl, di-cyclopentadienyl-Ti-bis-2,4,6-trifluorophen-1-yl, di-cyclopentadienyl-Ti-bis-2,3,5,6-tetra-fluorophen-1-yl, di-cyclopentadienyl-Ti-bis-2,3,4,5,6-pentafluorophen-1-yl, di-methylcyclopentadienyl-Ti-bis-2,6-difluorophen-1-yl, di-methylcyclopentadienyl-Ti-bis-2,4,6-trifluorophen-1-yl, di-methylcyclopentadienyl-Ti-bis-2,3,5,6-tetrafluorophen-1-yl, di-methylcyclopentadienyl-Ti-bis-2,3,4,5,6-pentafluorophen-1-yl, bis(cyclopentadienyl)-bis(2,6-difluoro-3-(pyl-1-yl)phenyl)titanium, and the iron-arene complexes described in JP-A-1-304453 and JP-A-1-152109.

Examples of the hexaarylbiimidazole compounds may include various compounds described in JP-B-6-29285, U.S. Pat. Nos. 3,479,185, 4,311,783, and 4,622,286, and the like. Specifically, mention may be made of 2,2′-bis(o-chlorophenyl)-4,4′,5,5′-tetraphenylbiimidazole, 2,2′-bis(o-bromophenyl))4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra-(m-methoxyphenyl)biimidazole, 2,2′-bis(o,o′-dichlorophenyl)-4,4′,5,5′-tetraphenylbiimidazole, 2,2′-bis(o-nitro phenyl)-4,4′,5,5′-tetraphenylbiimidazole, 2,2′-bis(o-methylphenyl)-4,4′,5,5′-tetraphenylbiimidazole, 2,2′-bis(o-trifluorophenyl)-4,4′,5,5′-tetraphenylbiimidazole, and the like.

Examples of the organoboron compounds may include the organic borates described in JP-A-62-143044, JP-A-62-150242, JP-A-9-188685, JP-A-9-188686, JP-A-9-188710, JP-A-2000-131837, JP-A-2002-107916, Japanese Patent No. 2764769, JP-A-2002-116539, and, Kunz, Martin Rad Tech '98, Proceeding Apr. 19-22, 1998, Chicago, and the like, the organic boron sulfonium complexes or organic boron oxosulfonium complexes described in JP-A-6-157623, JP-A-6-175564, and JP-A-6-175561, the organic boron iodonium complexes described in JP-A-6-175554 and JP-A-6-175553, the organic boron phosphonium complexes described in JP-A-9-188710, and the organic boron transition metal-coordinated complexes described in JP-A-6-348011, JP-A-7-128785, JP-A-7-140589, JP-A-7-306527, JP-A-7-292014, and the like.

As the disulfone compounds, mention may be made of the compounds described in JP-A-61-166544, JP-A-2003-328465, and the like.

As the oxime ester compounds, mention may be made of the compounds described in J. C. S. Perkin II (1979) 1653-1660, J. C. S. Perkin II (1979) 156-162, Journal of Photopolymer Science and Technology (1995) 202-232, and JP-A-2000-66385, and the compounds described in JP-A-2000-80068, specifically the compounds represented by the following structural formulae:

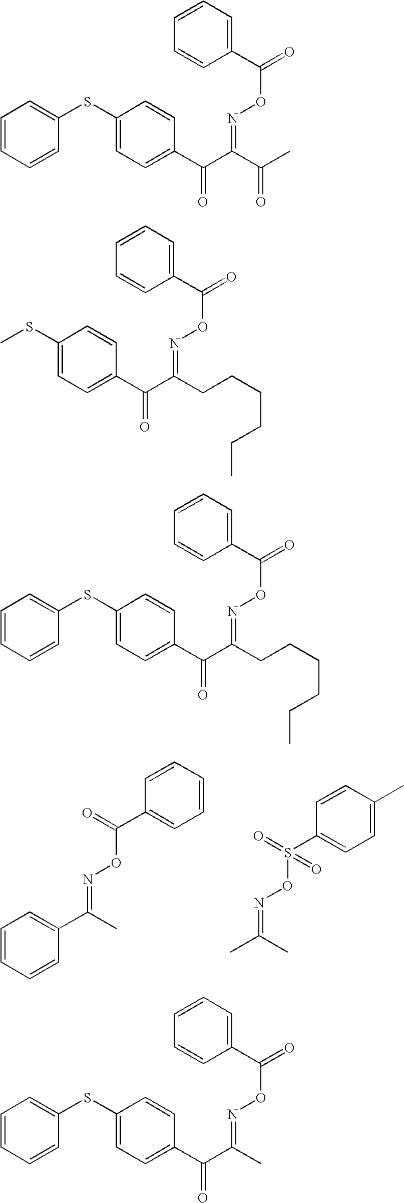

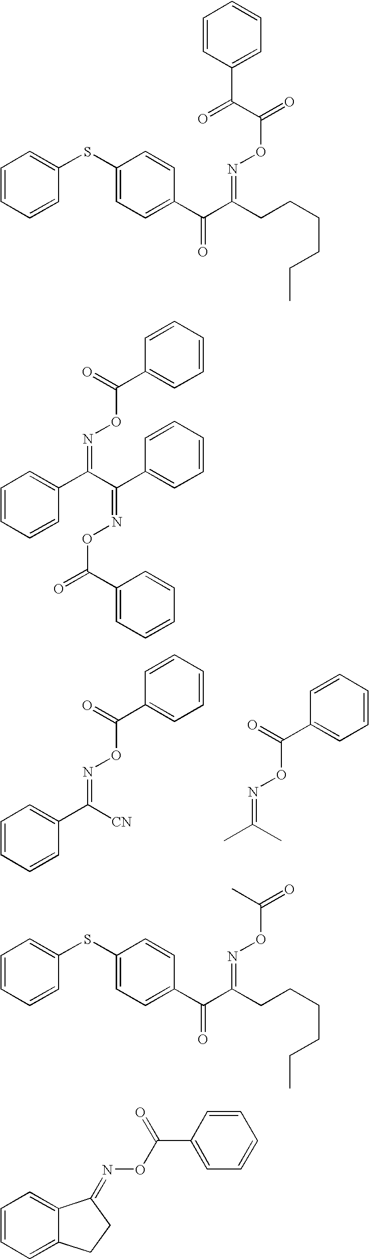

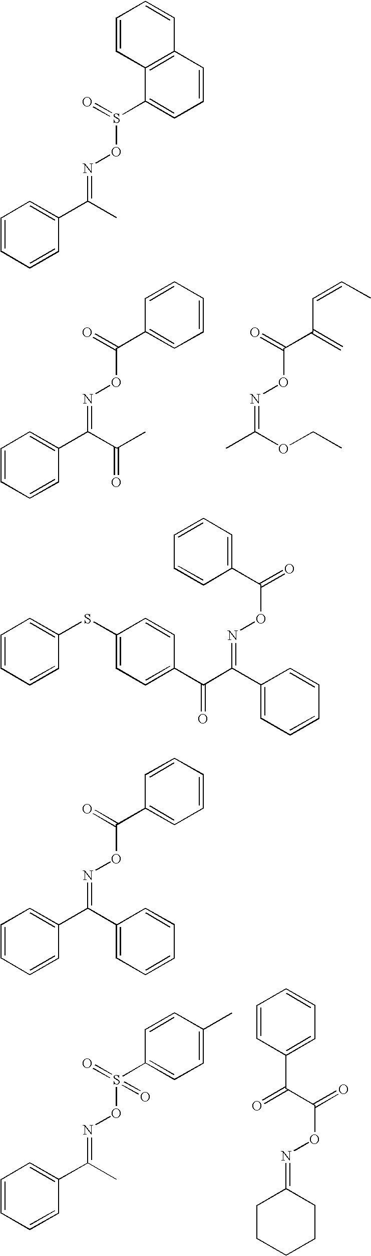

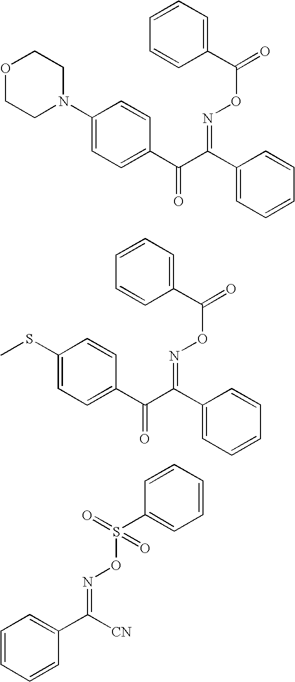

Examples of the onium salt compounds may include the onium salts such as: the diazonium salts described in S. I. Shlesinger, Photogr. Sci. Eng., 18,387 (1974) and T. S. Bal et al, Polymer, 21, 423 (1980), the ammonium salts described in U.S. Pat. No. 4,069,055, JP-A-4-365049, and the like, the phosphonium salts described in U.S. Pat. Nos. 4,069,055 and 4,069,056, the iodonium salts described in EP No. 104, 143, U.S. Pat. Nos. 339,049 and 410,201, JP-A-2-150848, and JP-A-2-296514, the sulfonium salts described in EP Nos. 370,693, 390,214, 233,567, 297,443, and 297,442, and U.S. Pat. Nos. 4,933,377, 161,811, 410,201, 339,049, 4,760,013, 4,734,444, and 2,833,827, and GP Nos. 2,904,626, 3,604,580, and 3,604,581, selenonium salts described in J. V. Crivello et al., Macromolecules, 10 (6), 1307 (1977), and J. V. Crivello et al., J. Polymer Sci. Polymer Chem. Ed., 17, 1047 (1979), and the arsonium salts described in C. S. Wen et al., Tch, Proc. Conf. Rad. Curing ASIA, P478 Tokyo, October (1998).

As particularly preferred ones in terms of the reactivity and the stability, mention may be made of the foregoing oxime ester compounds or onium salts (diazonium salts, iodonium salts, or sulfonium salts). In the invention, these onium slats are not acid generators, and function as ionic radical polymerization initiators.

The onium slats preferably for use in the invention are the onium salts represented by the following general formulae (RI-I) to (RI-III):

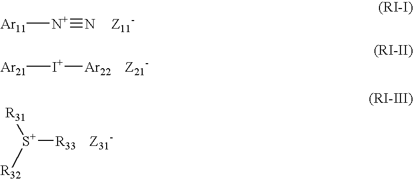

In the formula (RI-I), Ar₁₁ represents an aryl group having 20 or less carbon atoms, which may have 1 to 6 substituents. As the preferred substituents, mention may be made of an alkyl group having 1 to 12 carbon atoms, an alkenyl group having 1 to 12 carbon atoms, an alkynyl group having 1 to 12 carbon atoms, an aryl group having 1 to 12 carbon atoms, an alkoxy group having 1 to 12 carbon atoms, an aryloxy group having 1 to 12 carbon atoms, a halogen atom, an alkylamino group having 1 to 12 carbon atoms, a dialkylamino group having 1 to 12 carbon atoms, an alkyl amide group or an aryl amide group having 1 to 12 carbon atoms, a carbonyl group, a carboxyl group, a cyano group, a sulfonyl group, a thioalkyl group having 1 to 12 carbon atoms, and a thoiaryl group having 1 to 12 carbon atoms. Z₁₁⁻ represents a monovalent anion. Specifically, mention may be made of a halogen ion, a perchlorate ion, a hexafluorophosphate ion, a tetrafluoroborate ion, a sulfonate ion, a sulfinate ion, a thiosulfonate ion, and a sulfate ion. Out of these, in view of the stability, a perchlorate ion, a hexafluorophosphate ion, a tetrafluoroborate ion, a sulfonate ion, and a sulfinate ion are preferred.

In the formula (RI-II), Ar₂₁ and Ar₂₂ each independently represent an aryl group having 20 or less carbon atoms, which may have 1 to 6 substituents. As the preferred substituents, mention may be made of an alkyl group having 1 to 12 carbon atoms, an alkenyl group having 1 to 12 carbon atoms, an alkynyl group having 1 to 12 carbon atoms, an aryl group having 1 to 12 carbon atoms, an alkoxy group having 1 to 12 carbon atoms, an aryloxy group having 1 to 12 carbon atoms, a halogen atom, an alkylamino group having 1 to 12 carbon atoms, a dialkylamino group having 1 to 12 carbon atoms, an alkyl amide group or an aryl amide group having 1 to 12 carbon atoms, a carbonyl group, a carboxyl group, a cyano group, a sulfonyl group, a thioalkyl group having 1 to 12 carbon atoms, and a thioaryl group having 1 to 12 carbon atoms. Z₂₁⁻ represents a monovalent anion. Specifically, mention may be made of a halogen ion, a perchlorate ion, a hexafluorophosphate ion, a tetrafluoroborate ion, a sulfonate ion, a sulfinate ion, a thiosulfonate ion, and a sulfate ion. Out of these, in view of the stability and the reactivity, a perchlorate ion, a hexafluorophosphate ion, a tetrafluoroborate ion, a sulfonate ion a sulfinate ion, and a carboxylate ion are preferred.

In the formula (RI-III), R₃₁, R₃₂ and R₃₃ each independently represent an aryl group, an alkyl group, an alkenyl group, or an alkynyl group, having 20 or less carbon atoms, which may have 1 to 6 substituents. Especially, an aryl group is preferred in view of the reactivity and the stability. As the substituents, mention may be made of an alkyl group having 1 to 12 carbon atoms, an alkenyl group having 1 to 12 carbon atoms, an alkynyl group having 1 to 12 carbon atoms, an aryl group having 1 to 12 carbon atoms, an alkoxy group having 1 to 12 carbon atoms, an aryloxy group having 1 to 12 carbon atoms, a halogen atom, an alkylamino group having 1 to 12 carbon atoms, a dialkylamino group having 1 to 12 carbon atoms, an alkyl amide group or an aryl amide group having 1 to 12 carbon atoms, a carbonyl group a carboxyl group, a cyano group, a sulfonyl group, a thioalkyl group having 1 to 12 carbon atoms, and a thioaryl group having 1 to 12 carbon atoms. Z₃₁⁻ represents a monovalent anion. Specific examples thereof may include a halogen ion, a perchlorate ion, a hexafluorophosphate ion, a tetrafluoroborate ion, a sulfonate ion, a sulfinate ion, a thiosulfonate ion, a sulfate ion, and a carboxylate ion. Out of these, in view of the stability and the reactivity, a perchlorate ion, a hexafluorophosphate ion, a tetrafluoroborate ion, a sulfonate ion, a sulfinate ion, and a carboxylate ion are preferred. As the more preferred ones, mention may be made of the carboxylate ions described in JP-A-2001-343742, and as the particularly preferred ones, the carboxylate ions described in JP-A-2002-148790.

Below, specific non-limiting examples of the onium salt compound preferable for the invention will be shown.

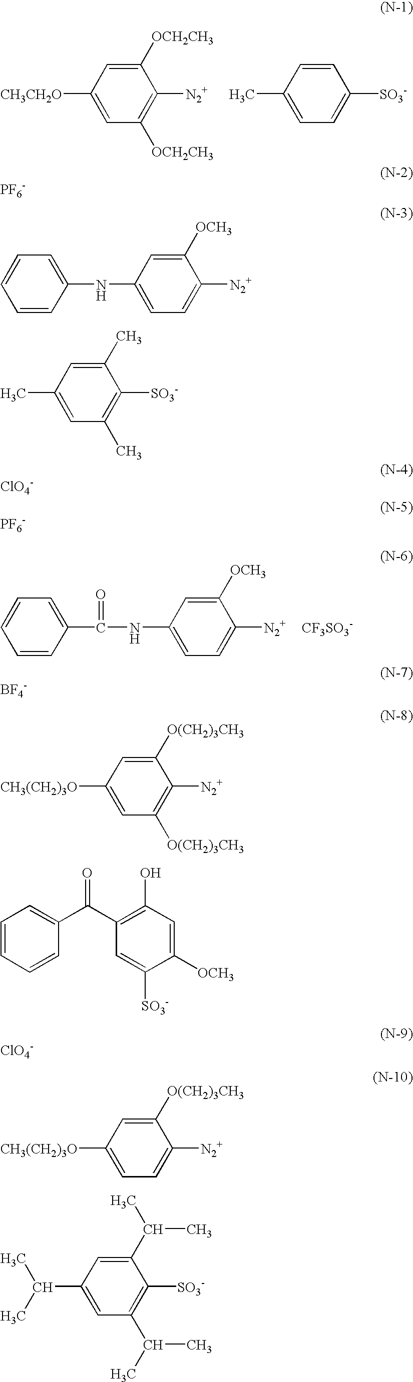

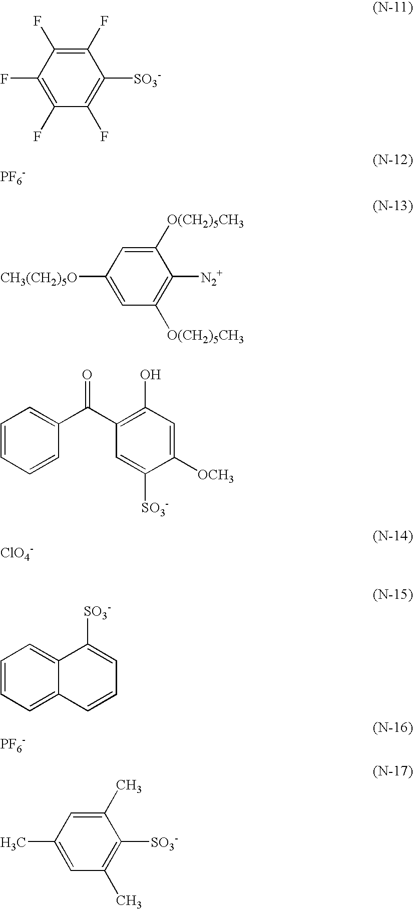

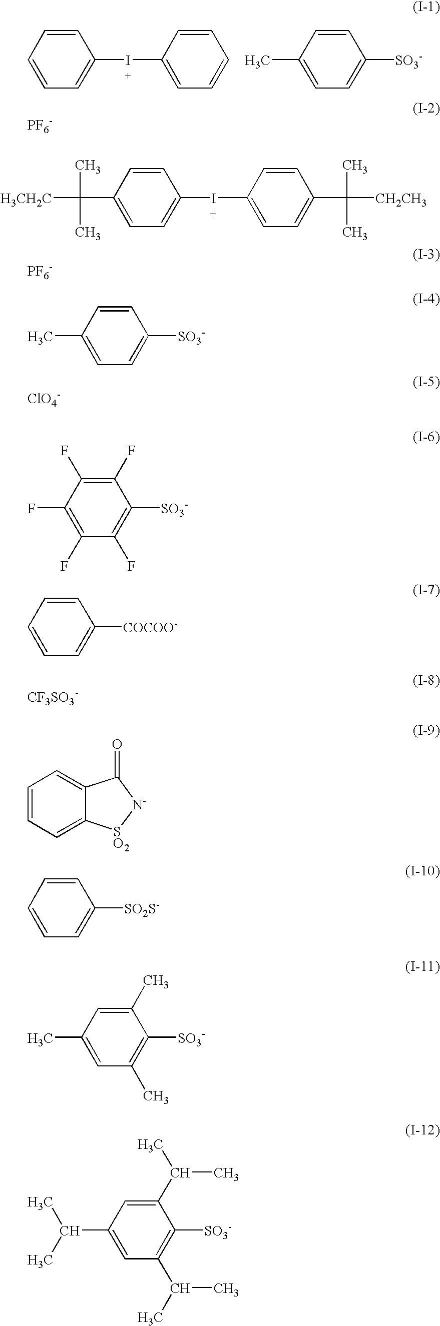

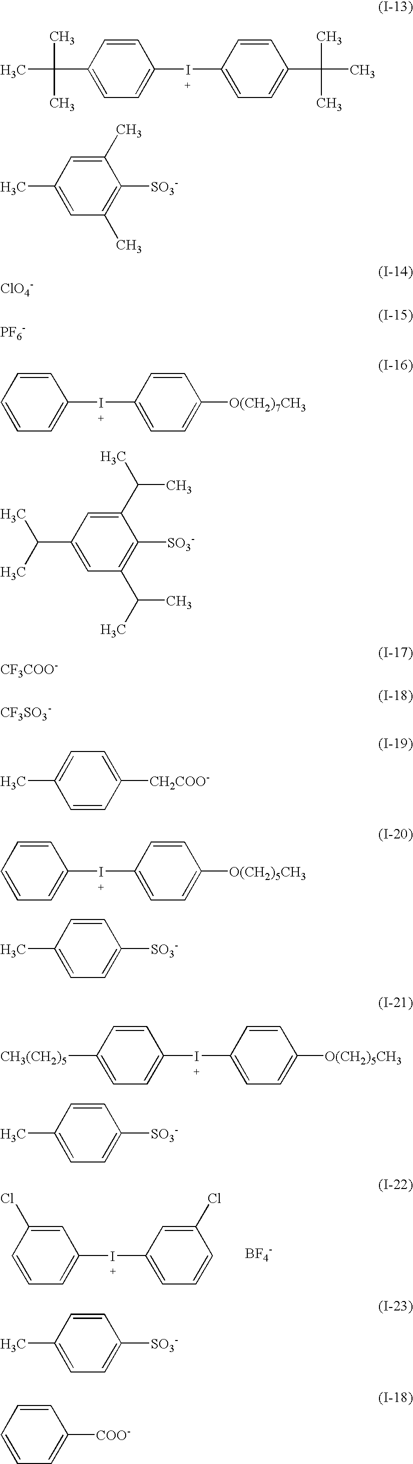

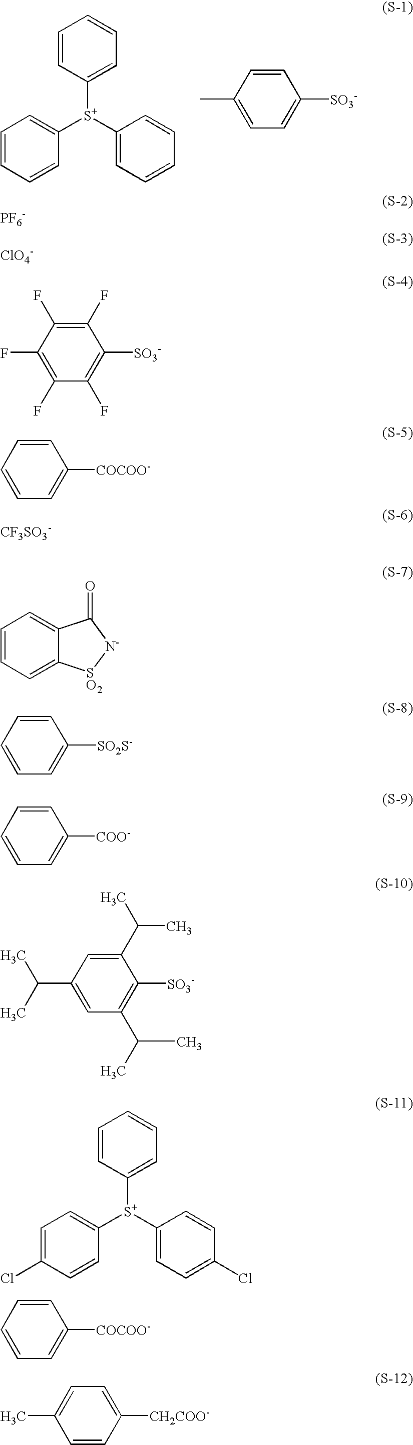

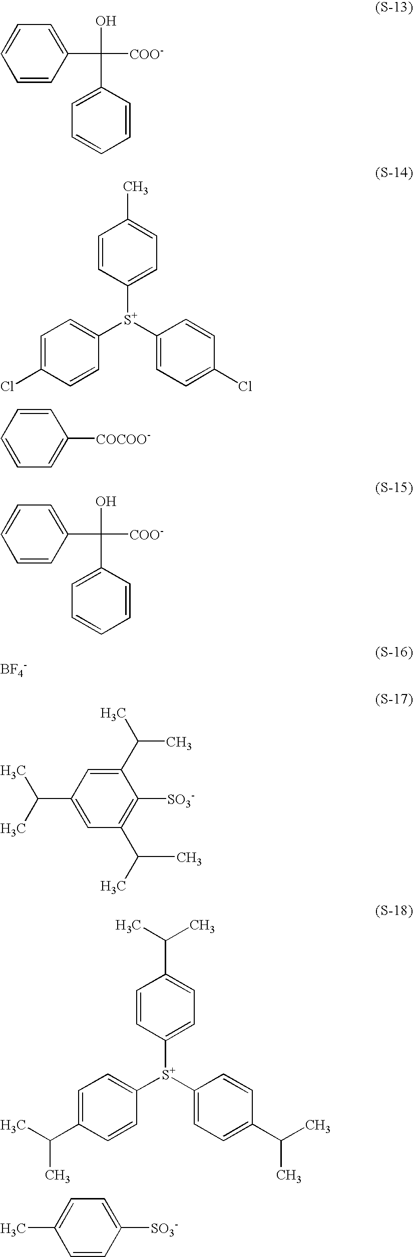

These polymerization initiators can be added in a proportion of 0.1 to 50 mass %, preferably 0.5 to 30 mass %, and in particular preferably 1 to 20 mass % based on the total solid content forming the image recording layer. Within this range, it is possible to obtain favorable sensitivity and favorable stain resistance of the non-image areas for printing. These polymerization initiators may be used alone, or may be used in combination of two or more thereof. Whereas, the polymerization initiators may be added to the same layer as with other components. Alternatively, another layer may be provided, and the polymerization initiators may be added thereto.

(C) Polymerizable Compound

The polymerizable compound of the invention is an addition polymerizable compound having at least one ethylenically unsaturated double bond. A compound having 2 or more ethylenically unsaturated double bonds is more preferred. Whereas, in the invention, the one having a low viscosity (coefficient of viscosity) in the vicinity of room temperature is preferred from the viewpoint of the modulus of elasticity. The viscosity at 25° C. is preferably 20000 cP or less, and more preferably 15000 cP or less. When the viscosity of the polymerizable compound is too high, the modulus of elasticity becomes high, resulting in an increase in amount of waste deposited on an ink roller.

Such polymerizable compounds are preferably selected from esters of unsaturated carboxylic acids (e.g., acrylic acid, methacrylic acid, itaconic acid, crotonic acid, isocrotonic acid, and maleic acid). Examples thereof may include esters of acrylic acid or methacrylic acid and polyhydric alcohol compounds. As the polyhydric alcohols, mention may be made of aliphatic polyhydric alcohol, and a hydroxyalkylated product or an ethylene oxide-modified product of isocyamuric acid.

Specific examples of the acrylic acid ester may include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylol ethane triacrylate, haxanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tris(methacryloyloxymethyl)isocyamurate, tris(acryloyloxyethyl)isocyanurate, tris(acryloyloxypropyl)isocyanurate, and bis(acryloyloxyethyl)hydroxyethyl isocyanurate.

The methacrylic acid esters include tetramethylene glycol dimethacrylate, triethylene glycol dimethacrylate, neopentyl glycol dimethacrylate, trimethylolpropane trimethacrylate, trimethylol ethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-metacryloxy-2-hydroxypropoxy)phenyl]dimethylmethane, bis-[p-(methacryloxyethoxy)phenyl]dimethylmethane, tris(methacryloyloxymethyl)isocyanurate, tris(methacryloyloxyethyl)isocyanurate, tris(methacryloyloxypropyl)isocyanurate, bis(methacryloyloxyethyl) hydroxyethyl isocyanurate, and the like.

These polymerizable compounds can improve the compatibility with, or dispersibility in other components (e.g., hydrophobic binder polymer, initiator, and colorant) in the image recording layer, or can adjust the viscosity by the use of a low purity product or by the use of a combination of two or more thereof.

The polymerizable compounds are used in an amount in the range of preferably 10 to 70 mass %, and further preferably 20 to 60 mass % based on the total solid content forming the image recording layer.

(D) Hydrophobic Binder Polymer

In the invention, a hydrophobic binder polymer (which is hereinafter simply referred to as a binder polymer) can be used for the improvement of the film strength and the coating property of the image recording layer, and the improvement of the on-press developability. As the binder polymers, conventionally known ones can be used without restriction, and a linear organic polymer having a coating property is preferred. Examples of such a binder polymer may include an acrylic resin, a polyvinyl acetal resin, a polyurethane resin, a polyurea resin, a polyimide resin, a polyamide resin, an epoxy resin, a methacrylic resin, a polystyrene type resin, a novolak type phenolic resin, a polyester resin, synthetic rubber, and natural rubber.

As more preferred ones, mention may be made of (meth)acrylic resins, i.e., polymers of (meth)acrylic acid esters. Out of these, a (meth)acrylic acid ester copolymer, containing a monomer unit having a —CH₂CH₂O— structure at the R portion of —COOR in a (meth)acrylic acid ester is preferred. Specific non-limiting examples thereof will be shown below.

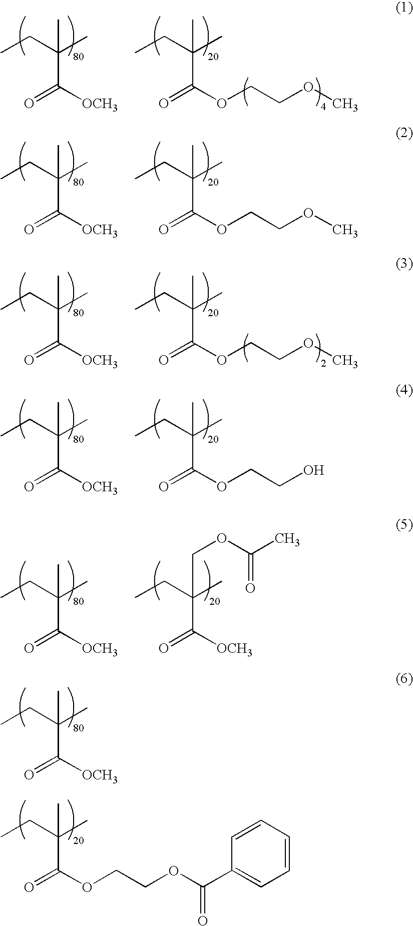

Whereas, the binder polymer preferably has crosslinkability in order to improve the film strength of the image areas. In order for the binder polymer to have crosslinkability, a crosslinkable functional group of an ethylenically unsaturated bond or the like may be desirably introduced into the main chain or the side chain of the polymer. The crosslinkable functional group may be introduced thereto by copolymerization.

Examples of the polymer having an ethylenically unsaturated bond in the main chain of the molecule may include poly-1,4-butadiene and poly-1,4-isoprene.

Examples of the polymer having an ethylenically unsaturated bond in the side chain of the molecule may include polymers of esters or amides of acrylic acid or methacrylic acid, polymers in each of which the ester or amide residue (R of —COOR or CONHR) has an ethylenically unsaturated bond.

Examples of the residue having an ethylenically unsaturated bond (the R) may include —(CH₂)ₙ—CR¹═CR²R³, —(CH₂O)ₙ—CH₂CR¹═CR²R³, —(CH₂CH₂O)ₙ—CH₂CR¹═CR²R³, —(CH₂)ₙ—NH—CO—O—CH₂CR¹═CR²R³, —(CH₂)ₙ—O—CO—CR¹═CR²R³, and —(CH₂CH₂O)₂—X (where R¹ to R³ are each a hydrogen atom, a halogen atom, or an alkyl group, an aryl group, an alkoxy group, or an aryloxy group, having 1 to 20 carbon atoms, and R¹ and R² or R³ may also combine with each other to form a ring; n is an integer of 1 to 10; and X is a dicyclopentadiene residue.).

Specific examples of the ester residue may include: —CH₂CH═CH₂ (described in JP-B-7-21633), —CH₂CH₂O—CH₂CH═CH₂, —CH₂C(CH₃)═CH₂, —CH₂CH═CH-C₆H₅, CH₂CH₂OCOCH=CH-C₆H₅, —CH₂CH₂—NHCOO—CH₂CH═CH₂, and CH₂CH₂O—X (where X represents a dicyclopentadienyl residue).

Specific examples of the amide residue may include: —CH₂CH═CH₂, —CH₂CH₂—Y (where Y represents cyclohexene residue), and —CH₂CH₂—OCO—CH═CH₂.

In the binder polymer having crosslinkability, to the crosslinkable functional group, a free radical (a polymerization initiator radial or a growing radical in the process of polymerization of a polymerizable compound) is added, and addition polymerization occurs directly or through chain polymerization of the polymerizable compound between the polymers. This results in the formation of crosslinking, which causes curing. Alternatively, the atoms in the polymers (such as hydrogen atoms on the carbon atoms adjacent to the functional crosslinkable groups) are attracted by free radicals to generate polymer radicals. These combine with each other to form crosslinking between the polymers, which causes curing.

The content of the crosslinkable groups in the binder polymer (the content of the radical polymerizable unsaturated double bonds by iodoametric titration) is preferably 0.1 to 10.0 mmol, more preferably 1.0 to 7.0 mmol, and most preferably 2.0 to 5.5 mmol per gram of the binder polymer. Within this range, it is possible to obtain favorable sensitivity and favorable storage stability.

The binder polymer has a mass-average molecular weight of preferably 5000 or more, and more preferably 10,000 to 300,000. Further it has a number-average molecular weight of preferably 1000 or more, and more preferably 2000 to 250,000. The degree of polydispersion (mass-average molecular weight/number-average molecular weight) is preferably 1.1 to 10.

The binder polymer may be any of a random polymer, a block polymer, a graft polymer, and the like. However, it is preferably a random polymer.

The binder polymers may be used alone, or may be used in a mixture of two or more thereof.

The content of the binder polymer is preferably 10 to 90 mass %, more preferably 20 to 80 mass %, and further preferably 30 to 70 mass % based on the total solid content of the image recording layer. Within this range, it is possible to obtain favorable strength and the image formability of the image areas.

Whereas, the polymerizable compound and the binder polymer are preferably used in such an amount as to result in a mass ratio of 1/9 to 7/3.

Other Image Recording Layer Components

To the image recording layer of the invention, various additives may be further added. These additives can also be added to the image recording layer, if required, in a form encapsulated in the microcapsules. Below, the additives will be described.

In the invention, for the image recording layer, a nonionic surfactant, an anionic surfactant, a cationic surfactant, an amphoteric surfactant, a fluorine-containing surfactant, and the like can be used in order to promote the on-press developability upon the start of printing, and in order to improve the costing surface conditions. The surfactants may also be used in combination of two or more thereof.

The nonionic surfactants for use in the invention has no particular restriction, and conventionally known ones are usable. Examples thereof may include polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol fatty acid monoesters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenized caster oils, polyoxyethylene glycerin fatty acid partial esters, fatty acid diethanolamides, N,N-bis-2-hydroxyalkylamines, polyoxyethylene alkylamines, triethanolamine fatty acid esters, trialkylamine oxides, polyethylene glycol, and a copolymer of polyethylene glycol and polypropylene glycol.

The anionic surfactants for use in the invention has no particular restriction, and conventionally known ones are usable. Examples thereof may include fatty acid salts, abietates, hydroxyalkane sulfonates, alkanesulfonates, dialkylsulfosuccinic ester salts, straight chain alkylbenzenesulfonates, branched chain alkylbenzenesulfonates, alkylnaphthalenesulfonates, alkylphenoxypolyoxyethylene propylsulfonates, polyoxyethylene alkylsulfophenyl ether slats, N-methyl-N-olcyltaurine sodium slats, N-alkylsulfosuccinic acid monoamide disodium salts, petroleum sulfonic acid salts, sulfated tallow, sulfate salts of fatty acid alkyl esters, alkylsulfate salts, polyoxyethylene alkyl ether sulfate salts, fatty acid monoglyceride sulfate salts, polyoxyethylene alkyl phenyl ether sulfate salts, polyoxyethylene styryl phenyl ether sulfate salts, alkyl phosphate slats, polyoxyethylene alkyl ether phosphate salts, polyoxyethylene alkyl phenyl ether phosphate salts, partially saponified products of styrene/maleic anhydride copolymers, partially saponified products of olefin/maleic anhydride copolymers, and formalin-condensates of naphthalenesulfonates.

The cationic surfactants for use in the invention has no particular restriction, and conventionally known ones are usable. Examples thereof may include alkylamine salts, quaternary ammonium salts, polyoxyethylene alkylamine slats, and polyethylene polyamine derivatives.

The amphoteric surfactants for use in the invention has no particular restriction, and conventionally known ones are usable. Examples thereof may include carboxybetaines, aminocarboxylic acids, sulfobetaines, aminosulfates, and imidazolines.

Incidentally, in the surfactants, the term “polyoxyethylene” can also be read as “polyoxyalkylene” such as polyoxymethylene, polyoxypropylene, or polyoxybutylene, and these surfactants may also be used in the invention.

As further preferred surfactants, mention may be made of fluorine-containing surfactants containing perfluoroalkyl groups in their molecules. Examples of such fluorine-containing surfactants may include anionic type ones such as perfluoroalkylcarboxylates, perfluoroalkylsulfonates, and perfluoroalkylphosphates; amphoteric type ones such as perfluoroalkylbetaines; cationic type ones such as perfluoroalkyl trimethyl ammonium slats; and nonionic type ones such as perfluoroalkylamine oxides, perfluoroalkyl ethylene oxide adducts, oligomers containing perfluoroalkyl groups and hydrophilic groups, oligomers containing perfluoroalkyl groups and oleophilic groups, oligomers containing perfluoroalkyl groups, hydrophilic groups, and oleophilic groups, and urethanes containing perfluoroalkyl groups and oleophilic groups. Further, the fluorine-containing surfactants described in JP-A-62-170950, JP-A-62-226143, and JP-A-60-168144 may also be preferably mentioned.

The surfactants may be used alone, or in combination of two or more thereof.

The content of the surfactants is preferably 0.001 to 10 mass % based on the total solid content of the image recording layer.

For the image recording layer of the invention, a dye having a large absorption in a visible light region can be used as a colorant for the image. Specifically, mention may be made of Oil Yellow #101, Oil Yellow #103, Oil Pink #312, Oil Green BG, Oil Blue BOS, Oil Blue #603, Oil Black BY, Oil Black BS, and Oil Black T-505 (all produced by Orient Chemical Industries, Ltd.), Victoria Pure Blue, Crystal Violet (C.I. 42555), Methyl Violet (C.I. 42535), Ethyl Violet, Rhodamine B (C.I. 145170B), Malachite Green (C.I. 42000), and Methylene Blue (C.I. 52015), and the dyes described in JP-A-62-293247. Further, pigments such as phthalocyanine type pigments, azo type pigments, Carbon Black, and titanium oxide are also preferably usable.

These colorants are preferably added because a discrimination between image areas and non-image areas is made with ease after image formation. Incidentally, they are added in a proportion of 0.01 to 10 mass % based on the total solid content of the image recording materials.

To the image recording layer of the invention, a compound which causes discoloration by an acid or a radical can be added for the formation of a print-out images. As such compounds, for example, various colorants of diphenylmethene type, triphenylmethane type, thiazine type, oxazine type, xanthene type, anthraquinone type, iminoquinone type, azo type, azomethine type, and the like are effectively used.

Specific examples thereof may include dyes such as Brilliant Green, Ethyl Violet, Methyl Green, Crystal Violet, Basic Fuchsine, Methyl Violet 2B, Quinaldine Red, Rose Bengal, Metanil Yellow, Thymolsulfophthalein, Xylenol Blue, Methyl Orange, Paramethyl Red, Congo Red, Benzopurpuria 4B, α-naphthyl Red, Nile Blue 2B, Nile Blue A, Methyl Violet, Malachite Green, Parafuchsinc, Victoria Pure Blue BOH (manufactured by Hodogaya Chemical Co., Ltd.), Oil Blue #603 (manufactured by Orient Chemical Industries, Ltd.), Oil Pink #312 (manufactured by Orient Chemical Industries, Ltd.), Oil Red 5B (manufactured by Orient Chemical Industries, Ltd.), Oil Scarlet #308 (manufactured by Orient Chemical Industries, Ltd.), Oil Red OG (manufactured by Orient Chemical Industries, Ltd.), Oil Red RR (manufactured by Orient Chemical Industries, Ltd.), Oil Green #502 (manufactured by Orient Chemical Industries, Ltd.), Spiron Red BEH Special (manufactured by Hodogaya Chemical Co., Ltd.), m-Cresol Purple, Cresol Red, Rhodamine B, Rhodamine 6G, Sulfo Rhodamine B, Auramine, 4-n-diethylaminophenyliminonaphthoquinone, 2-carboxyanilino-4-p-diethylaminophenyliminonaphthoquinone, 2-carboxystearylamino-4-p-N,N-bis(hydroxyethyl)amino-phenyliminonaphthoquinone, 1-phenyl-3-methyl-4-p-diethylaminophenylimino-5-pyrazolone, and 1-β-naphthyl-4-p-diethylaminophenylimino-5-pyrazolone; and leuco dyes such as p,p′,p″-hexamethyltriaminotriphenylmethane (Leuco Crystal Violet) and Pergascript Blue SRB (manufactured by Ciba-Geigy Corp.).

Other than the foregoing ones, leuco dyes known as materials for thermal recording paper or pressure sensitive paper may also be mentioned as preferred ones. Specific examples thereof may include Crystal Violet lactone, Malachite Green lactone, Benzoyl Leuco Methylene Blue, 2-(N-phenyl-N-methylamino)-6-(N-p-tolyl-N-ethyl)aminofluoran, 2-anilino-3-methyl-6-(N-ethyl-p-toluidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N,N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-piperidino-6-methyl-7-anilinofluoran, 3-pyrrolidino-6-methyl-7-anilinofluoran, 3,3-bis(1-ethyl-2-methylindol-3-yl)phthalide, 3,3-bis(1-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-phthalide, and 3-(4-diethylaminophenyl)-3-(1-ethyl-2-methylindol-3-yl)phthalide.

The dyes which cause discoloration by an acid or a radical are each preferably added in a proportion of 0.01 to 15 mass % based on the total solid content of the image recording layer.

To the image recording layer of the invention, a small amount of a thermal polymerization inhibitor is preferably added in order to inhibit unnecessary thermal polymerization of a radical polymerizable compound during manufacturing of, or during storage of the image recording layer.

Preferred examples of the thermal polymerization inhibitor may include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and N-nitroso-N-phenylhydroxylamine aluminum salt.

The amount of the thermal polymerization inhibitor to be added is preferably about 0.01 to about 5 mass % based on the total solid content of the image recording layer.

To the image recording layer of the invention, a higher fatty acid derivative such as behenic acid or a behenic acid amide may be added to be localized in the surface of the image recording layer in the process of drying after coating, in order to prevent polymerization inhibition due to oxygen. The amount of the higher fatty acid derivative to be added is preferably about 0.1 to about 10 mass % based on the total solid content of the image recording layer.

The image recording layer of the invention may also contain a plasticizer in order to improve the on-press developability.

Preferred examples of the plasticizer may include phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate, and diallyl phthalate; glycol esters such as dimethyl glycol phthalate, ethylphthalyl ethyl glycolate, methylphthalyl ethyl glycolate, butylphthalyl butyl glycolate, and triethylene glycol dicaprylic acid ester; phosphoric acid esters such as tricresyl phosphate, and triphenyl phosphate; aliphatic dibasic acid esters such as diisobutyl adipate, dioctyl adipate, dimethyl sebacate, dibutyl sebacate, dioctyl azelate, and dibutyl maleate; and polyglcidyl methacrylate, triethyl citrate, glycerin triacetyl ester, and butyl laurate.

The content of the plasticizer is preferably about 30 mass % or less based on the total solid content of the image recording layer.

The image recording layer of the invention may contain inorganic fine particles for the improvement of the strength of the cured film of the image areas, and the improvement of the on-press developability of the non-image areas.

Preferred examples of the inorganic fine particles may include silica, alumina, magnesium oxide, titanium oxide, magnesium carbonate, calcium alginate, or mixtures thereof. Even if these are not light-heat convertible, these can be used for strengthening the film, strengthening the interface adhesion due to surface roughening and the like.

The inorganic fine particles has an average particle diameter of preferably 5 nm to 10 μm, and more preferably 0.5 to 3 μm. Within the range, the inorganic fine particles can be dispersed in the image recording layer with stability. This enables the film strength of the image recording layer to be sufficiently kept, and enables the formation of non-image areas excellent in hydrophilicity, which is less susceptible to staining during printing.

The inorganic fine particles as described above are easily available as a commercially available product such as a colloidal silica dispersion.

The content of the inorganic fine particles is preferably 20 mass % or less, and more preferably 10 mass % or less based on the total solid content of the image recording layer.

The image recording layer of the invention may contain a hydrophilic low molecular weight compound for the improvement of the on-press developability. Examples of the hydrophilic low molecular weight compounds may include, as water soluble organic compounds, glycols such as ethylene glycol, diethylene glycol, triethylene glycol, propylene glycol, dipropylene glycol, and tripropylene glycol, and ether or ester derivatives thereof, polyhydroxys such as glycerin and pentaerythritol, organic amines such as triethanolamine, diethanolamine, and monoethanolamine, and salts thereof, organic sulfonic acids such as toluenesulfonic acid and benzenesulfonic acid, and salts thereof, organic phosphonic acids such as phenylphosphonic acid, and salts thereof, and organic carboxylic acids such as tartaric acid, oxalic acid, citric acid, malic acid, lactic acid, gluconic acid, and amino acids, and salts thereof.

In the lithographic printing plate precursor of the invention, the image recording layer preferably contains a microcapsule and (A) an active light absorber, more preferably contains a microcapsule encapsulating a hydrophobic compound, and (A) an active light absorber, and furthermore preferably contains (A) an active light absorber, (B) a polymerization initiator, (C) a polymerizable compound, and (D) a hydrophobic binder polymer, and encapsulates at least one of (A) to (D) in a microcapsule.

As the microcapsules in the invention, mention may be made of a microcapsule (which is hereinafter also referred to as a “microcapsule (1)”) produced by dissolving a multifunctional isocyanate compound having two or more isocyanate groups in a water immiscible solvent, and emulsifying and dispersing the solution in an aqueous solution containing a hydrophilic polymer having one or more active hydrogen groups reactable with isocyanate groups at one terminal, and then, removing the solvent from the oil droplet; and a microcapsule (which is hereinafter also referred to as a “microcapsule (2)”) using polyurea or polyurethane/urea obtained by the polymerization reaction of an isocyanate compound and a compound having an active hydrogen as the wall material, in which at least one of the isocyanate compounds is a reaction product of (1) an at least di-functional isocyanate compound, and (2) a polyether derivative having a terminal amino group represented by the following general formula (I):
R—O [symbol] L-O [symbol] ₙ [symbol] X [symbol] ₘA-NH₂ General Formula (I)
[where in the general formula (I), X represents a linking group, A represents an allylene group or an alkylene group, L represents an alkylene group, and R represents an organic group not having an active hydrogen, m represents 0 or 1; and n is a number of 10 to 500 in terms of the average addition mole number of a polyether group.]

[Microcapsule (1)]

The microcapsule (I) can be produced by dissolving a multifunctional isocyanate compound having two or more isocyanate groups in a water immiscible solvent, and emulsifying and dispersing the solution in an aqueous solution containing a hydrophilic polymer having one or more active hydrogen groups reactable with isocyanate groups at one terminal, and then, removing the solvent from the oil droplet.

For the production method of the microcapsule (1), a known method is applicable as the operation. Namely, as an isocyanate compound to be dissolved in a water immiscible solvent, a multifunctional isocyanate compound having two or more isocyanate groups is dissolved in a water immiscible solvent, resulting in an oil phase solution. In addition, an aqueous solution containing a hydrophilic polymer having one or more active hydrogen groups reactable with isocyanate groups at one terminal, is prepared. Then, both are mixed. By means of an emulsifying and dispersing machine such as homogenizer, the mixture is mixed with vigorous stirring, for example, at 12,000 rpm for 10 to 15 minutes, so that oil droplets are emulsified and dispersed in the aqueous phase. Then, the resulting emulsified dispersion is heated with stirring to evaporate the solvent. As a result, a water dispersion of the objective microcapsule particles can be obtained.

To the aqueous phase, other than the hydrophilic polymer having one or more active hydrogen groups reactable with isocyanate groups at one terminal, a compound having two or more active hydrogen atoms in the molecule is preferably added. Examples of such a compound may include, other than water, polyhydric alcohol type compounds such as ethylene glycol and glycerin, polyhydric amine type compounds such as ethylenediamine and diethylenetriamine, or mixtures thereof. Further, for the improvement of the emulsification and dispersion stability, a surfactant is preferably contained.

The average particle diameter of the microcapsules is preferably 0.01 to 3.0 μm, further preferably 0.05 to 2.0 μm, and in particular preferably 0.10 to 1.0 μm. Within this range, it is possible to obtain favorable dispersibility, plate wear resistance, and stain resistance.

[Multifunctional Isocyanate]

Then, the multifunctional isocyanate having two or more isocyanate groups will be described.

Specific examples of such compounds may include difunctional compounds having two isocyanate groups in the molecule such as m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxy-biphenyl diisocyanate, 3,3′-dimethyl diphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropane diisocyanate, 4,4′-diphenylhexafluoropropane diisocyanate, trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatemethyl)cyclohexane, 1,3-bis(isocyanatemethyl)cyclohexane, isophorone diisocyanate, and lysine diisocyanate.

In the invention, further, tri- or more functional isocyanate compounds can also be utilized. Examples of such compounds usable may include trimers (biurets or isocyanurates) using the bifunctional isocyanate compounds as main raw materials, multifunctionalized ones in the form of adducts of polyols such as trimethylolpropane and bifunctional isocyanate compounds, formalin condensate of benzene isocyanate, polymers of isocyanate compounds having a polymerizable group such as methacryloyloxyethyl isocyanate, and lysine triisocyanate. Particularly, other than the trimers (biurets or isocyanurates) using the xylene diisocyanate and a hydrogenated product thereof, hexamethylene diisocyanate, tolylene diisocyanate and a hydrogenated product thereof as main raw materials, multifunctionalized ones in the form of adducts with trimethylolpropane are also preferred. These compounds are described in POLYURETHANE JYUSHI HANDBOOK (edited by KEJJIIWATA, published by Nikkan Kogyo Shinbunsha (1987).

Out of these, 2,4-tolylene diisocyanate, 2,6-tolylene diisocyanate, xylylene-1,4-diisocyanate, xylylene-1,3-diisocyanate, an adduct of trimethylolpropane and xylylene-1,4-diisocyanate or xylylene-1,3-diisocyanate are preferred. Particularly, xylylene-1,4-diisocyanate and xylylene-1,3-diisocyanate, and an adduct of trimethylolpropane and xylylene-1,4-diisocyanate or xylylene-1,3-diisocyanate are preferred.

[Hydrophilic Polymer Having One or More Active Hydrogen Groups at One Terminal]

Then, the hydrophilic polymer having one or more active hydrogen groups reactable with isocyanate groups at one terminal will be described. As the active hydrogen groups reactable with isocyanate groups, mention may be made of a hydroxyl group, an amino group, a mercapto group, a carboxyl group, and the like. Out of these, a hydroxyl group and an amino group are preferred. The hydrophilic polymers having such active hydrogen groups have no particular restriction. However, examples thereof may include polyethers and polymers of vinyl monomers (which is hereinafter referred to as vinyl polymers), having active hydrogen groups at one terminal.

The hydrophilic polymer has an average molecular weight of preferably 300 to 500,000, and further preferably 500 to 100,000. When it has a molecular weight of 300 or more and 500,000 or less, it has a sufficient function as a protective colloid, and can ensure the dispersion stability of the microcapsules, and can sufficiently provide the hydrophilicity of the surface.

Specific examples of the hydrophilic polymer may include polyether type ones such as polyethylene oxide and ethylene oxide/propylene oxide copolymer. These polymers can be synthesized in the following manner. For example, alcohol, alkoxide, carboxylic acid, carboxylate, or the like is used as a polymerization initiating terminal, to ring opening polymerize a cyclic compound such as ethylene oxide or propylene oxide. The polymerization initiating terminal is converted to a hydroxyl group, an amino group, or the like which is an active hydrogen group by a conventionally known reaction (e.g., hydrolysis reaction or reduction reaction). Alternatively, polyethers having an active hydrogen group at one terminal are also utilized. Out of these, monoether forms of polyethylene oxide (as the monoether forms, mention may be made of monomethyl ether, monoethyl ether, and the like), monoester forms of polyethylene oxide (as the monoester, mention may be made of monoacetic acid ester, mono(meth)acrylic acid ester, and the like) are more preferred.

Whereas, as the vinyl polymer used for the hydrophilic polymer, mention may be made of vinyl polymers having hydrophilic groups such as a carboxyl group and a salt thereof, an amido group, a sulfonic acid group and a salt thereof, a phosphonic acid group and a salt thereof, an ammonium group, an amine oxide group, or an other group on the side chain. Examples thereof may include poly(meth)acrylic acid) and alkali metal or ammonium salts thereof, poly((meth)acrylamide), poly(N-methyl(meth)acrylamide), poly(N,N-dimethyl(meth)acrylamide), poly(N-isopropyl acrylamide), poly(4-(meth)acryloylmorpholine), poly(2-[{(meth)acryloyloxy}ethyl]trimethylammonium chloride, poly(2-[((meth)acryloyloxy}ethyl]triethylammonium chloride, poly(2-(meth)acrylamide-2-methyl-1-propanesulfonic acid) and alkali metal or ammonium salts thereof, poly(2-[((meth)acryloyloxy)ethyl]dimethyl(3-sulfopropyl)ammonium hydroxide inner salt) poly(vinylphosphonic acid) and alkali metal or ammonium salts thereof, poly(4-vinylbenzoic acid) and alkali metal or ammonium salts thereof, poly(4-vinylbenzenesulfonic acid) and alkali metal or ammonium salt thereof, poly(4-vinylpyridine hydrochloride), poly(allylamine hydrochloride), and poly(2-{2-methoxyethoxy}ethyl (meth)acrylate). Such a hydrophilic polymer can be obtained in the form of a vinyl polymer having hydroxyl groups of one terminal by radical polymerizing vinyl type monomers in the presence of a mercapto compound such as mercapto ethanol, and a radical polymerization initiator.

The hydrophilic polymer for use in the invention may include a single repeating unit or may include a copolymer made of two or more repeating units. Further, if required, it is also possible to convert these functional groups to amino groups or the like by using a known reaction. Out of the vinyl polymers, the vinyl polymers having a carboxyl group and a salt thereof, an amido group, a sulfonic acid group and a salt thereof, an ammonium group, or an ether group on the side chain are more preferred.

Specific examples of the hydrophilic polymer having one or more active hydrogen groups at one terminal may include the following compounds. The polymers may each have, on one terminal, two or more active hydrogen groups, and further may have two or more different active hydrogen groups.

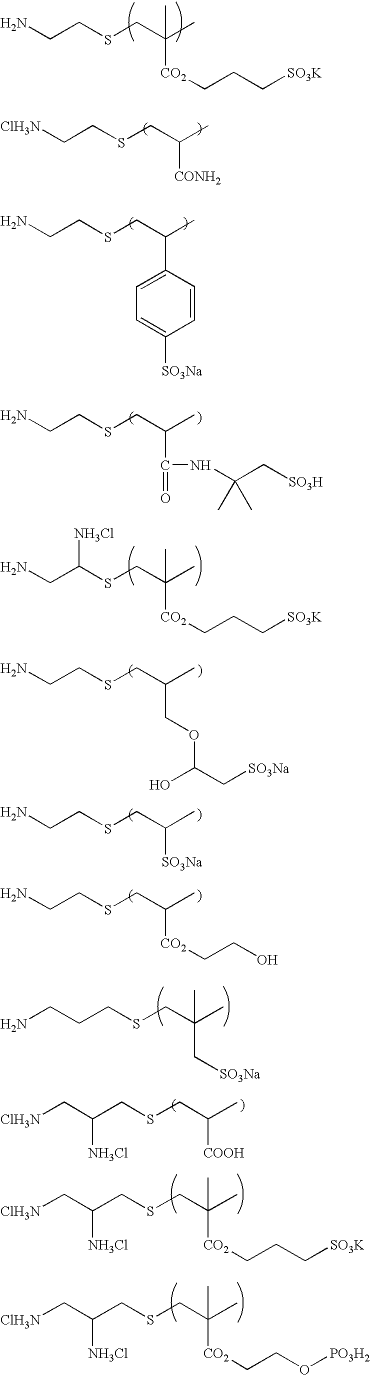

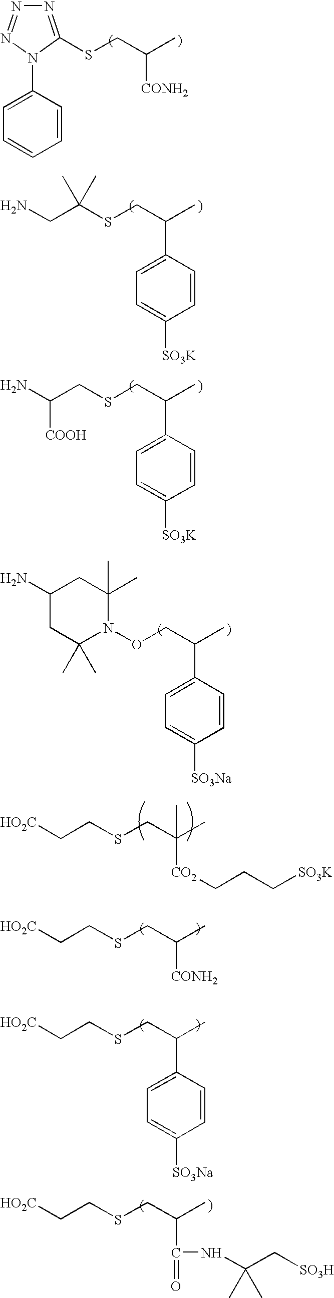

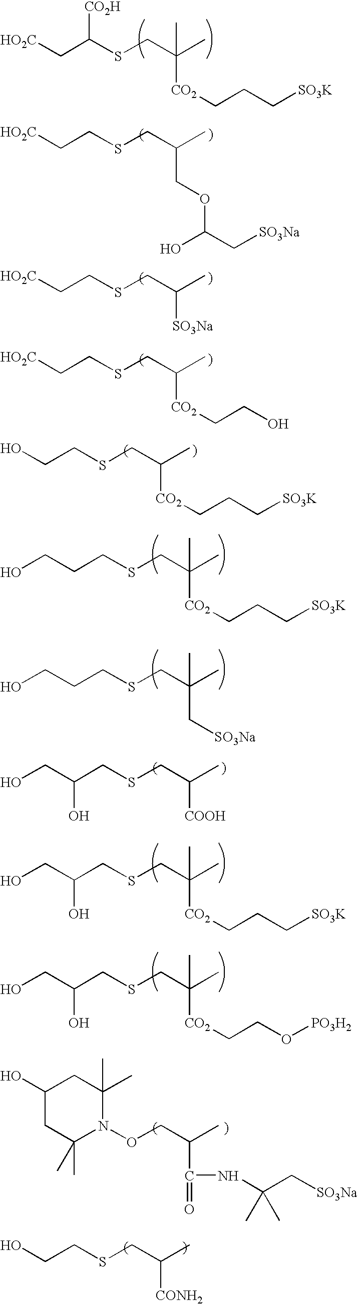

The ratio of the amounts of the multifunctional isocyanate compound and the hydrophilic polymer to be used is preferably 100/1 to 100/60, further preferably 100/2 to 100/30, and most preferably 100/5 to 100/20 in terms of the mole ratio of the isocyanate functional group and the active hydrogen group. Within the foregoing range, the dispersion stability is good, and the stain resistance is also good with no reduction of the wall crosslinking density, nor leakage of the encapsulated matters.

[Compounds Encapsulated in Microcapsule (1)]

The microcapsule (1) for use in the invention preferably encapsulates a hydrophobic compound. The encapsulation of the hydrophobic compound can be achieved in the following manner. The hydrophobic compound is dissolved in the oil phase solvent in the production of the microcapsule (1) together with an isocyanate compound, for use. The hydrophobic compound is preferably a compound having a heat reactive group. All the functional groups causing any reactions are acceptable as the heat reactive group so long as a chemical bond is formed. Preferred examples thereof may include ethylenically unsaturated groups undergoing a radical polymerization reaction (e.g., an acryloyl group, a methacryloyl group, a vinyl group, and an allyl group), cation polymerizable groups (e.g., a vinyl group and a vinyloxy group), an isocyanate group undergoing an addition reaction, or a block form thereof, an epoxy group, a vinyloxy group and functional groups having active hydrogen atoms which are the reaction partners thereof (e.g., an amino group, a hydroxyl group, and a carboxyl group), a carboxyl group undergoing a condensation reaction, and a hydroxyl group or an amino group, which is the reaction partner thereof, acid anhydrides undergoing a ring opening addition reaction, and an amino group or a hydroxyl group, which is the reaction partner thereof.

Below, the compound having a heat reactive group will be described in more details.

As the preferred compounds having radical polymerizable unsaturated group, mention may be made of compounds having at least one, and preferably two or more ethylenically unsaturated bonds, such as an acryloyl group, a methacryloyl group, a vinyl group, or an allyl group. Such a compound group is widely known as a monomer for a polymerizable composition or a crosslinking agent in the industrial field, and can be used without any particular restriction in the invention. The chemical form is a monomer, a prepolymer, i.e., a dimer, a trimer, an oligomer, a polymer, or a copolymer, or a mixture thereof.

Specific examples thereof may include the compounds described as the compounds having polymerizable unsaturated groups in JP-A-2001-277740. Typical examples of the compounds may include trimethylolpropane di(meth)acrylate, trimethylolpropane tri(meth)acrylate, pentaerythritol di(meth)acrylate, pentaerythritol tri(meth)acrylate, pentaerythritol tetra(meth)acrylate, dipentacrythritol di(meth)acrylate, dipentaerythritol penta(meth)acrylate, dipentaerythritol hexa(meth)acrylate, and the adduct of the trimethylolpropane diacrylate and xylylene diisocyanate. However, these are non-limiting.

As the polymer or copolymer form having an ethylenically polymerizable unsaturated group, mention may be made of a copolymer of allyl methacrylate. Examples thereof may include an ally methacrylate/methacrylic acid copolymer, an allyl methacrylate/ethyl methacrylate copolymer, and an allyl methacrylate/butyl methacrylate copolymer. As The styryl type compounds usable in the invention, mention may be made of the compounds described in Japanese Patent Application No. 2004-045114, and the like.

As the compounds having a vinyloxy group preferable for the invention, mention may be made of the compounds described in JP-A-2002-29162. Specific non-limiting examples thereof may include tetramethylene glycol divinyl ether, trimethylolpropane trivinyl ether, tetraethylene glycol divinyl ether, pentaerythritol divinyl ether, pentaerythritol trivinyl ether, pentaerythritol tetravinyl ether, 1,4-bis{2-(vinyloxy)ethyloxy}benzene, 1,2-bis{2-(vinyloxy)ethyloxy}benzene, 1,3-bis{2-(vinyloxy)ethyloxy}benzene, 1,3,5-tris{2-(vinyloxy)ethyloxy}benzene, 4,4′-bis{2-(vinyloxy)ethyloxy}biphenyl, 4,4′-bis{2-(vinyloxy)ethyloxy}diphenyl ether, 4,4′-bis{2-(vinyloxy)ethyloxy}diphenylmethane, 1,4-bis{2-(vinyloxy)ethyloxy}naphthalene, 2,5-bis{2-(vinyloxy)ethyloxy}furan, 2,5-bis{2-(vinyloxy)ethyloxy}thiophene, 2,5-bis{2-(vinyloxy)ethyloxy}imidazole, 2,2-bis[4-{2-(vinyloxy)ethyloxy)}phenyl]propane{bis(vinyloxyethyl)ether of bisphenol A}, 2,2-bis(4-(vinyloxy methyloxy)phenyl}propane, and 2,2-bis{4-(vinyloxy)phenyl}propane.

As the compound having an epoxy group preferable for the invention, the compounds having two or more epoxy groups are preferred, and mention may be made of a glycidyl ether compound obtainable by the reaction of a polyhydric alcohol or a polyhydric phenol with epichlorohydrin, or a prepolymer thereof, further a polymer or copolymer of glycidyl acrylate or glycidyl methacrylate, and the like.

Specific examples thereof may include propylene glycol diglycidyl ether, tripropylene glycol diglycidyl ether, polypropylene glycol diglycidyl ether, neopentyl glycol diglycidyl ether, trimethylolpropane triglycidyl ether, diglycidyl ether of hydrogenated bisphenol A, hydroquinone diglycidyl ether, resorcinol diglycidyl ether, diglycidyl ether or an epichlorohydrin polyaddition product of bisphenol A, diglycidyl ether or an epichlorohydrin polyaddition product of bisphenol F, diglycidyl ether or an epichlorohydrin polyaddition product of halogenated bisphenol A, diglycidyl ether or an epichlorohydrin polyaddition product of biphenyl type bisphenol, a glycidyl etherified product of novolak resin, further, a methyl methacrylate/glycidyl methacrylate copolymer and an ethyl methacrylate/glycidyl methacrylate copolymer.

Examples of the commercially available products of the foregoing compounds may include Epikote 1001 (with a molecular weight of about 900 and an epoxy equivalent of from 450 to 500), Epikote 1002 (with a molecular weight of about 1,600 and an epoxy equivalent of from 600 to 700), Epikote 1004 (with a molecular weight of about 1,060 and an epoxy equivalent of from 875 to 975), Epikote 1007 (with a molecular weight of about 2,900 and an epoxy equivalent of 2,000), Epikote 1009 (with a molecular weight of about 3,750 and an epoxy equivalent of 3,000). Epikote 1010 (with a molecular weight of about 5,500 and an epoxy equivalent of 4,000), Epikote 1100L (with an epoxy equivalent of 4,000), and Epikote YX31575 (with an epoxy equivalent of 1,200) each manufactured by Japan Epoxy Resins Co., Ltd.; and Sumi-Epoxy ESCN-195XHN, ESCN-195XL, and ESCN-195XF each manufactured by Sumitomo Chemical Co., Ltd.

Examples of the isocyanate compounds preferable for the invention may include tolylene diisocyanate, diphenylmethane diisocyanate, polymethylene polyphenyl polyisocyanate, xylylene diisocyanate, naphthalene diisocyanate, cyclohexanephenylene diisocyanate, isophorane diisocyanate, hexamethylene diisocyanate, cyclohexyl diisocyanate, or, compounds obtained by blocking these with alcohols or amines.

As the amine compounds preferable for the invention, mention may be made of ethylenediamine, diethylenetriamine, triethylenetetramine, hexamethylenediamine, propylenediamine, polyethyleneimine, and the like.

As the compounds having hydroxyl groups preferable for the invention, mention may be made of the compounds having a terminal methylol group, polyhydric alcohols such as pentaerythritol, bisphenols, polyphenols, and the like.

As the compounds having carboxyl groups preferable for the invention, mention may be made of aromatic polyhydric carboxylic acids such as pyromellitic acid, trimellitic acid and phthalic acid, and aliphatic polyhydric carboxylic acids such as adipic acid.

As the acid anhydrides preferable for the invention, mention may be made of pyromellitic acid anhydride, benzophenonetetracarboxylic acid anhydride, and the like.

In the microcapsule (1), as the hydrophobic compound, at least one of (A) the active light absorber, (B) the polymerization initiator, (C) the polymerizable compound, and (D) the hydrophobic binder polymer is more preferably used.

The hydrophobic compound encapsulated in the microcapsule (1) is in an amount of preferably 2 mass % to 90 mass %, more preferably 5 mass % to 80 mass %, and most preferably 10 mass % to 60 mass % based on the total solid content of the microcapsule. Within this range, the hydrophobicity of the exposed areas are sufficient, and the inking property is enough, and further, the wall thickness is also sufficient, causing no leakage, which results in excellent printing stain resistance.

The precursor for a lithographic printing plate of the invention preferably has, on a support, an image recording layer to be made hydrophobic by heat, containing a microcapsule (1) and (A) an active light absorber.

The content of the microcapsule (1) in the image recording layer is preferably 10 to 80 mass %, and further preferably 20 to 60 mass % based on the solid content of the image recording layer. When the amount thereof to be added is less than 10 mass %, the oleophilicity of the light exposed areas is insufficient, and the inking property is inferior. Whereas, when the amount exceeds 80 mass %, the hydrophilicity is insufficient, causing printing stain.

When the microcapsules are contained in the image recording layer of the invention, it is possible to add a solvent for dissolving the encapsulated matters, and swelling the wall material in a microcapsule dispersion medium. Such a solvent promotes the diffusion of the compound having a heat reactive group encapsulated therein out of the microcapsule. Such a solvent depends upon the microcapsule dispersion medium, the material for the microcapsule wall, the wall thickness, and the encapsulated matters, but can be selected with ease from a large number of commercially available solvents. For example, for the water dispersible microcapsules including crosslinked polyurea and polyurethane walls, alcohols, ethers, acetals, esters, ketones, polyhydric alcohols, amides, amines, fatty acids, and the like are preferred.

Specific non-limiting examples of compounds may include methanol, ethanol, tertiary butanol, n-propanol, tetrahydrofuran, methyllactate, ethyllactate, methyl ethyl ketone, propylene glycol monomethyl ether, ethylene glycol diethyl ether, ethylene glycol monomethyl ether, γ-butyl lactone, N,N-dimethylformamide, and N,N-dimethylacetamide. Further, these solvents may be used in combination of two or more thereof. It is also possible to use the solvent which is not dissolved in the microcapsule dispersion, but which is dissolved therein when any of the foregoing solvents has been mixed therein.

The amount of such a solvent to be added is determined by the combination of the materials, but in general, it is effectively 5 to 95 mass % of the costing solution. The preferred range is 10 to 90 mass %, and the more preferred range is 15 to 85 mass %.

<Hydrophilic Binder>

In the invention, the image recording layer containing the microcapsule (1) and (A) the active light absorber is preferably a hydrophilic layer containing a hydrophilic binder.

The hydrophilic binder is a sol-gel transformable material including a hydrophilic polymer, or a system of a metal hydroxide and a metal oxide. Out of these, a sol-gel transformation system having a property of forming a gel structure of polysiloxane is most preferred. When the surface hydrophilic layer of a light-heat converting agent having a surface hydrophilicity or a hydrophobic precursor fine particles having a surface hydrophilicity also has a function as a binder, another binder may not be used. The binder acts as a dispersion medium for the components forming the hydrophilic layer, and has a structure suitable for various objects such as the improvement of the physical strength of the layer, the improvement of the mutual dispersibility of the compositions forming the layer, the improvement of the coatability, the improvement of the printing suitability, and the improvement of the convenience of the plate making workability.

The hydrophilic binder is preferably in an amount of 30 to 50 mass %, and further preferably 35 mass % to 45 mass % based on the total solid content of the hydrophilic layer. When the amount is 30 mass % or less, the hydrophilic layer cannot obtain sufficient water resistance and wear resistance. Whereas, when the amount is 50 mass % or more, the hydrophilic layer cannot be sufficiently made hydrophobic, resulting in no formation of an image.

As the hydrophilic polymer binder preferably used for the hydrophilic layer of the precursor for a lithographic printing plate of the invention, an organic polymer compound having a hydroxyl group for the purpose of imparting the appropriate strength and surface hydrophilicity as the hydrophilic layer can be used. Specifically, mention may be made of water soluble resins such as polyvinyl alcohol (PVA), modified PVA such as carboxy modified PVA, starch and derivatives thereof, cellulose derivatives such as carboxymethylcellulose and hydroxyethylcellulose, casein, gelatin, polyvinyl pyrrolidone, a vinyl acetate-crotonic acid copolymer, a styrene-maleic acid copolymer, a water-soluble acrylic copolymer containing as a main constituent a water soluble acrylic monomer such as polyacrylic acid or a salt thereof, polyacrylamide, acrylic acid, or acrylamide.

Whereas, as the water-resisting agent for crosslinking and curing the organic polymer compound having a hydroxyl group, mention may be made of glyoxal, an initial condensate of an aminoplast such as a melamine formaldehyde resin or an urea formaldehyde resin, a methylolated polyamide resin, a polyamide/polyamine/epichlorohydrin adduct, a polyamide epichlorohydrin resin, a modified polyamide polyimide resin, and the like. In addition, further, a crosslinking catalyst such as ammonium chloride or a silane coupling agent can be used in combination.

The system capable of undergoing sol-gel transformation preferably suitable for the invention is described in details in books such as Sumio Sakka, Zoru-Geru Hou no Kagaku, Agne Shofusha, (publisher) (1988), and Yutaka Hirashima, Saishin Zoru-Geru Hou ni voru Kinosci Hakumaku Sakasei Gijutsu, General Technique Center, (Publisher) (1992).

Namely, the system is a polymer form in which the bonding groups extending from polyvalent elements form a network structure via oxygen atoms, and at the same time, polyvalent metals also have unbonded hydroxyl groups and alkoxy groups, and these are mixed to form a resinous structure. The system is in a sol form at the stage in which it has a large number of alkoxy groups and hydroxyl groups before coating. As the ester bonding proceeds after coating, the network resinous structure strengthens, resulting in a gel form. Further, the system has, in addition to the property of changing in degree of hydrophilicity of the resin structure, the action of allowing a part of the hydroxyl groups to be bonded to the solid fine particles and hence modifying the surface of the solid fine particles to change the degree of the hydrophilicity. The polyvalent bonding elements of the compound having hydroxyl groups or alkoxy groups performing sol-gel transformation include aluminum, silicon, titanium, and zirconium. All of these can be used in the invention. However, below, a description will be given to the more preferably usable sol-gel transformation system through a siloxane bond. The sol-gel transformation using aluminum, titanium and zirconium can be accomplished in the same manner as described below except that silicon is replaced by the each element.

The hydrophilic matrix formed by sol-gel transformation is preferably a resin having a siloxane bond and a silanol group. The hydrophilic layer of the precursor for a lithographic printing plate of the invention is formed by coating a coating solution which is a system of a sol containing a silane compound having at least one silanol group, and then, with time, allowing hydrolytic condensation of the silanol group to proceed with time, causing the formation of a siloxane skeleton structure which causes gelatin to proceed. The siloxane resin forming the gel structure is represented by the following general formula (I), and the silane compound having at least one silanol group is represented by the following general formula (II). Whereas, the material system changing from being hydrophilic to being hydrophobic, contained in the image-recording layer is not necessary required to be a silane compound of the general formula (II), alone, but generally may be made of an oligomer obtained by partial hydrolytic polymerization of a silane compound or may be made of a mixed composition of a silane compound and its oligomer.

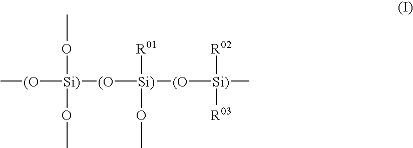

The siloxane type resin of the general formula (I) is formed by the sol-gel transformation form a dispersion containing at least one of the silane compounds represented by the following general formula (II). At least one of R⁰¹ to R⁰⁰ in the general formula (I) represents a hydroxyl group, and the others each represent an organic residue selected from the signs R⁰ and Y¹ in the following general formula (II):
(R⁰)ₙSi(Y¹)₄₋ₙ General formula (II)

In the general formula (II), R⁰ represents a hydroxyl group, a hydrocarbon group, or a heterocyclic group; Y¹ represents a hydrogen atom, a halogen atom, —OR¹¹, —OCOR¹², or, —N(R¹³)(R¹⁴) where R¹¹ and R¹² each represent a hydrocarbon group, and R¹³ and R¹⁴ may be the same or different, and each represent a hydrogen atom or a hydrocarbon group); and n represents 0, 1, 2 or 3.

As the hydrocarbon group or the heterocyclic group of R⁰ in the general formula (II), mention may be made of a straight chain or branched alkyl group having 1 to 12 carbon atoms, which may be substituted (e.g., a methyl group, an ethyl group, a propyl group, a butyl group, a pentyl group, a hexyl group, a heptyl group, an octyl group, a nonyl group, a decyl group, or a dodecyl group; the group substitutable on each of these groups represents a halogen atom (a chlorine atom, a fluorine atom, or a bromine atom), a hydroxy group, a thiol group, a carboxy group, a sulfo group, a cyano group, an epoxy group, a —OR′ group (where R′ represents a method group, an ethyl group, a propyl group, a butyl group, a heptyl group, a hexyl group, an octyl group, a decyl group, a propenyl group, a butenyl group, a hexenyl group, an octenyl group, a 2-hydroxyethyl group, a 3-chloropropyl group, a 2-cyanoethyl group, a N,N-dimethylaminoethyl group, a 2-bromoethyl group, a 2-(2-methoxyethyl)oxyethyl group, a 2-methoxycarbonylethyl group, a 3-carboxypropyl group, a benzyl group, or the like), a —OCOR″ group (where R″ represents the same substance as with the R′), a —COOR″ group, a COR″ group, —N(R^{′″})(R^{′″}) (where R′″s each represent a hydrogen atom or the same substance as with the R′, and may be respectively the same or different), a —NHCONHR″ group, a —NHCOOR″ group, a Si(R″)₃ group, a —CONHR″ group, a —NHCOR″ group, or the like; a plurality of the groups may substitute in an alkyl group), a straight chain or branched alkenyl group having 2 to 12 carbon atoms, which may be substituted (e.g., a vinyl group, a propenyl group, a butenyl group, a pentenyl group, a hexenyl group, an octenyl group, a decenyl group, or a dodecenyl group, and as the groups substitutable on the groups, mention may be made of the same substances as the groups substitutable on the alkyl groups), an aralkyl group having 7 to 14 carbon atoms, which may be substituted (e.g., a benzyl group, a phenethyl group, a 3-phenylpropyl group, a naphthylmethyl group, or a 2-naphthylethyl group; as the groups substitutable on the groups, mention may be made of the same substances substitutable on the alkyl groups, and a plurality of groups may substitute thereon), an alicyclic group having 5 to 10 carbon atoms, which may be substituted (e.g., a cyclopentyl group, a cyclohexyl group, a 2-cyclohexylethyl group, a 2-cyclopentylethyl group, a norbonyl group, or an adamantyl group, as the groups substitutable on the groups, mention may be made of the same substances as with the substituents of the alkyl group, and a plurality of groups may substitute thereon), an aryl group having 6 to 12 carbon atoms, which may be substituted (e.g., a phenyl group, or a naphthyl group, as the substituents, mention may be made of the same substances as with the groups substitutable on the alkyl group, and a plurality of groups may substitute thereon), or, a heterocyclic group containing at least one selected from a nitrogen atom, an oxygen atom, and a sulfur atom, which may be ring condensed (examples of the heterocyclic ring may include a pyran ring, a furan ring, a thiophene ring, a morpholine ring, a pyrrole ring, a thiazole ring, an oxazole ring, a pyridine ring, a piperidine ring, a pyrrolidone ring, a benzothiazole ring, a benzoxazole ring, a quinoline ring, and a tetrahydrofuran ring, which may have a substituent; and as the substituent, mention may be made of the same substances as the substituents in the alkyl group, and a plurality of groups may substitute thereon).

The —OR¹¹ group, the —OCOR¹² group, or the N(R¹³)(R¹⁴) group of Y¹ in the general formula (II) represents, for example, the following groups. In the —OR¹¹ group, R¹¹ represents, an aliphatic group having 1 to 10 carbon atoms, which may be substituted (e.g., a methyl group, an ethyl group, a propyl group, a butoxy group, a heptyl group, a hexyl group, a pentyl group, an octyl group, a nonyl group, a decyl group, a propenyl group, a butenyl group, a heptenyl group, a hexenyl group, an octenyl group, a decenyl group, a 2-hydroxyethyl group, a 2-hydroxypropyl group, a 2-methoxyethyl group, a 2-(methoxyethyloxo)ethyl group, a 2-(N,N-diethyl amino) ethyl group, a 2-methoxypropyl group, a 2-cyanoethyl group, a 3-methyloxapropyl group, a 2-chloroethyl group, a cyclohexyl group, a cyclopentyl group, a cyclooctyl group, a chlorocyclohexyl group, a methoxycyclohexyl group, a benzyl group, a phenethyl group, a dimethoxybenzyl group, a methylbenzyl group, or a bromobenzyl group may be mentioned).

In the —OCOR¹² group, R¹² represents an aliphatic group having the same contents as those of R¹¹ or an aromatic group having 6 to 12 carbon atoms, which may be substituted (as the aromatic groups, mention may be made of the same ones as those exemplified for the aryl group in the R). Whereas, in the —N(R¹³)(R¹⁴) group, R¹³ and R¹⁴ may be mutually the same or different, and each represent a hydrogen atom or an aliphatic group having 1 to 10 carbon atoms, which may be substituted (for example, mention may be made of those having the same contents as those of R¹¹ of the —OR¹¹ group). More preferably, a total number of carbon atoms of R¹¹ and R¹² is 16 or less. Specific examples of the silane compounds represented by the general formula (II) may include the following ones:

Mention may be made of tetrachlorosilane, tetrabromosilane, tetramethoxysilane, tetraethoxysilane, tetraisopropoxysilane, tetrabutoxysilane, methyltrichlorosilane, methyltribromosilane, methyltrimethoxysilane, methyltriethoxysilane, methyltriisopropoxysilane, methyltri t-butoxysilane, ethyltrichlorosilane, ethyltribromosilane, ethyltrimethoxysilane, ethyltriethoxysilane, ethyltriisopropoxysilane, ethyltri t-butoxysilane, n-propyltrichlorosilane, n-propyltribromosilane, n-propyltrimethoxysilane, n-propyltriethoxysilane, n-propyltriisopropoxysilane, n-propyltri t-butoxysilane, n-hexyltrichlorosilane, n-hexyltribromosilane, n-hexyltrimethoxysilane, n-hexyltriethoxysilane, n-hexyltriisopropoxysilane, n-hexyltri t-butoxysilane, n-decyltrichlorosilane, n-decyltribromosilane, n-decyltrimethoxysilane, n-decyltriethoxysilane, n-decyltriisopropoxysilane, n-decyltri t-butoxysilane, n-octadecyltrichlorosilane, n-octadecyltribromosilane, n-octadecyltrimethoxysilane, n-octadecyltriethoxysilane, n-octadecyltriisopropoxysilane, n-octadecyltri t-butoxysilane, phenyltrichlorosilane, phenyltribromosilane, phenyltrimethoxysilane, phenyltriethoxysilane, phenyltriisopropoxysilane, phenyltri t-butoxysilane, dimethoxy diethoxysilane, dimethyldichlorosilane, dimethyldibromosilane, dimethyldimethoxysilane, dimethyl diethoxysilane, diphenyldichlorosilane, diphenyldibromosilane, diphenyldimethoxysilane, diphenyldiethoxysilane, phenylmethyldichlorosilane, phenylmethyldibromosilane, phenylmethyldimethoxysilane, phenylmethyldiethoxysilane, triethoxyhydrosilane, tribromohydrosilane, trimethoxyhydrosilane, isopropoxyhydrosilane, tri t-butoxy-hydrosilane, vinyl trichlorosilane, vinyl tribromosilane, vinyl trimethoxysilane, vinyl triethoxysilane, vinyl triisopropoxysilane, vinyl tri t-butoxysilane, trifluoropropyltrichlorosilane, trifluoropropyltribromosilane, trifluoropropyltrimethoxysilane, trifluoropropyltriethoxysilane, trifluoro propyl triisopropoxysilane, trifluoropropyltri t-butoxysilane, γ-glycidoxypropylmethyldimethoxysilane, γ-glycidoxypropylmethyldiethoxysilane, γ-glycidoxypropyltrimethoxysilane, γ-glycidoxypropyltriethoxysilane, γ-glycidoxypropyltriisopropoxysilane, γ-glycidoxypropyltri t-butoxysilane, γ-methacryloxypropylmethyldimethoxysilane, γ-methacryloxypropylmethyldiethoxysilane, γ-methacryloxypropyltrimethoxysilane, γ-methacryloxypropyltriisopropoxysilane, γ-methacryloxypropyltri t-butoxysilane, γ-aminopropylmethyldimethoxysilane, γ-aminopropylmethyldiethoxysilane, γ-aminopropyltrimethoxysilane, γ-aminopropyltriethoxysilane, γ-aminopropyltriisopropoxysilane, γ-aminopropyltri t-butoxysilane, γ-mercaptopropylmethyldimethoxysilane, γ-mercaptopropylmethyldiethoxysilane, γ-mercaptopropyltrimethoxysilane, γ-mercaptopropyltriethoxysilane, γ-mercaptopropyltriisopropoxysilane, γ-mercaptopropyltributoxysilane, β-(3,4-epoxycyclohexyl)ethyltrimethoxysilane, β-(3,4-epoxycyclohexyl)ethyltriethoxysilane, and the like.

With the silane compounds represented by the general formula (II) used for the formation of the hydrophilic layer of the invention, metal compounds capable of forming a film by being bonded to the resin in the sol-gel transformation, such as Ti, Zn, Sn, Zr, or Al can be used in combination. Examples of the metal compounds to be used may include Ti(OR″)₄ (where R″ is a methyl group, an ethyl group, a propyl group, a butyl group, a pentyl group, a hexyl group, or the like), TiCl₄, Zn(OR″)₂, Zn(CH₃COCHCOCH₃)₂, Sn(OR″)₄, Sn(CH₃COCHCOCH₃)₄, Sn(OCOR″)₄, SnCl₄, Zr(OR″)₄, Zr(CH₃COCHCOCH₃)₄, and Al(OR″)₃.

Further, in the matrix of this gel structure, a hydrophilic polymer having a silane coupling group at the polymer main chain terminal, and a crosslinking agent can be added for the purposes of the improvement of the physical performances such as the film strength and the flexibility, the improvement of the coatability, and the control of the hydrophilicity.

As the hydrophilic polymer having a silane coupling group at the polymer main chain terminal, mention may be made of the polymer represented by the following general formula (1):

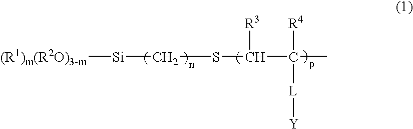

In the formula (1), R¹, R², R³, and R⁴ each represent a hydrogen atom or a hydrocarbon group having 8 or less carbon atoms, m represents 0, 1 or 2, n represents an integer of 1 to 8, p represents an integer of 30 to 300; and Y represents —NHCOCH₃, —CONH₂, —CON(CH₃)₂, —COCH₃, —OCH₃, —OH, —CO₂M or CONHC(CH₃)₂SO₃M, in which M represents any one selected from the group consisting of a hydrogen atom, an alkali metal, an alkaline-earth metal and onium.

L represents a single bond or an organic linking group, wherein the organic linking group represents a polyvalent linking group including non-metal atoms, and specifically it is a group made up of 1 to 60 carbon atoms, 0 to 10 nitrogen atoms, 0 to 50 oxygen atoms, 1 to 100 hydrogen atoms, 0 to 20 sulfur atoms. As more specific linking groups, mention may be made of the following structural units or the groups formed of a combination of these.

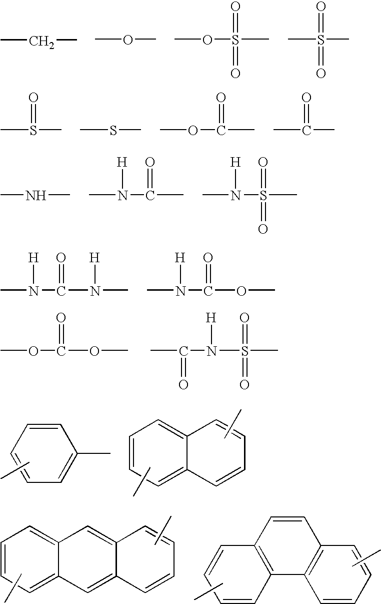

Specific examples of the hydrophilic polymer having the silane coupling group of the general formula (1) may include the following polymers. Incidentally, in the following specific examples, p can take any between 100 and 250.

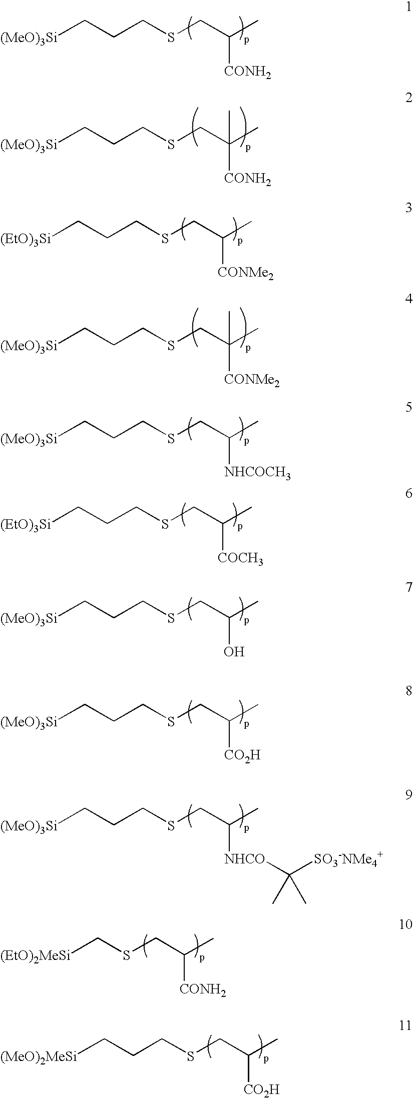

The hydrophilic polymer in accordance with the invention can be synthesized by effecting radical polymerization using radical polymerizable monomers represented by the following general formula (2), and a silane coupling agent having a chain transfer capability in the radical polymerization represented by the following general formula (3). The silane coupling agent, the formula (3) has a chain transfer capability, which enables the synthesis of the polymer having a silane coupling group which has been introduced at the polymer main chain terminal in the radical polymerization.

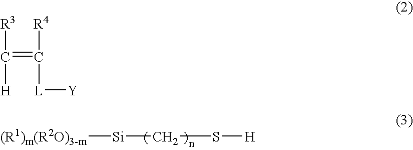

As described above, the image recording layer manufactured by the sol-gel method is particularly preferable for the precursor for a lithographic printing plate of the invention.

[Microcapsule (2)]

The microcapsule (2) is a microcapsule having a polyurea or polyurethane/urea wall, in which in production of the microcapsule by polymerizing an isocyanate compound with a compound having an active hydrogen, at least one of the isocyanate compounds used is a reaction product of (1) an at least di-functional isocyanate compound, and (2) a polyether derivative having a terminal amino group represented by the following general formula (1):
R—O [symbol] L-O [symbol] ₙ [symbol] X [symbol] ₘA-NH₂ General Formula (I)
[where in the general formula (I), X represents a linking group, A represents an allylene group or an alkylene group, L represents an alkylene group and R represents an organic group not having an active hydrogen, m represents 0 or 1; and n is a member of 10 to 500 in terms of the average addition mole number of a polyether group.]

By the use of the microcapsule, it is possible to obtain a lithographic printing plate precursor excellent in stability with time of the image recording layer coating solution containing an organic solvent, and further good in on-press developability and printing performances.

When the content of the organic solvent in the coating solvent is 50 mass % or more, the advantage of the invention is more remarkable.

(Polyether Derivative of the General Formula (I))

First, the polyether derivative having a terminal amino group of the invention represented by the general formula (I) will be described.

In the general formula (I), X represents a linking group. As preferred linking groups, mention may be made of —CO— or SO₂—. Especially, —CO— is preferred. A in the general formula (I) represents an allylene group or an alkylene group.

The allylene group represented by A is preferably an allylene group having a total of 6 to 30 carbon atoms, and in particular preferably an allylene group having a total of 6 to 20 carbon atoms, which may have a substituent. The substituent for the substituted one is preferably a halogen atom, an allyl group, an alkoxy group an alkoxycarbonyl group, an aryloxycarbon group, or a cyano group, and in particular preferably a halogen atom, an alkyl group, or an alkoxy group. Specific examples of such an allylene group may include phenylene, biphenylene, naphthalene, methylphenylene, and methoxyphenylene.

The alkylene group represented by A is preferably an alkylene group having a total of 1 to 30 carbon atoms, and in particular preferably an alkylene group having a total of 1 to 20 carbon atoms, which may have a substituent, or may be branched. The substituent for the substituted one is preferably an aryl group, an alkenyl group, an alkoxy group, or an alkoxycarbonyl group, and especially in particular preferably an aryl group. Specific examples of such an alkylene group may include methylene, ethylene, propylene, tetramethylene, and phenylmethylene.

In the general formula (I), m represents 0 or 1, and preferably 1.

Specific examples of such a group represented by —(X)ₘ-A-NH₂ as described above may include an aminoethyl group, an aminopropyl group, a 4-aminobenzoyl group, a 3-aminobenzoyl group, a 4-aminobenzenesulfonyl group, an aminoacetyl group, and an aminoethylsulfonyl group.

In the general formula (I), L represents an alkylene group. The alkylene group represented by L is preferably an alkylene group having a total of 2 to 20 carbon atoms, and in particular preferably an alkylene group having a total of 2 to 10 carbon atoms, which may have a substituent, or may be branched. The substituent for the substituted one is preferably an aryl group, an alkenyl group, an alkoxy group, or an acyl group, and especially in particular preferably an aryl group. Specific examples of such an alkylene group may include ethylene, propylene, tetramethylene, phenyl ethylene, cyclohexylene, vinyl ethylene, and phenoxy methylethylene.

In the general formula (I), n repeating units -(L-O)ₙ— may each have an independent group, but in particular preferably have the same group. Specific examples of polyether having such repeating units may include polyethylene oxide, polypropylene oxide, polytetramethylene oxide, polystyrene oxide, polycyclohexylene oxide, a polyethylene oxide-polypropylene oxide bloc copolymer, and a polyethylene oxide-polypropylene oxide random copolymer.

In the general formula (I), R represents an organic group not having an active hydrogen. R has no particular restriction so long as it is an organic group not having active hydrogen reactable with an isocyanate group. However, as preferred organic groups, mention may be made of an alkyl group, an aryl group, a heterocyclic group, and an acyl group. As more preferred ones, mention may be made of an alkyl group, an aryl group, and an acyl group.

The alkyl group represented by R is preferably the one having a total of 1 to 30 carbon atoms, and in particular preferably the one having a total of 1 to 20 carbon atoms, which may have a substituent, or may be branched. The substituent for the substituted one is preferably an aryl group, an alkenyl group, or an alkoxy group. Specific examples of such an alkyl group may include a methyl group, an ethyl group, a butyl group, an isopropyl group, a behenyl group, a benzyl group, an allyl group, an oleyl group, and a methoxyethyl group.

The aryl group represented by R is preferably the one having a total of 6 to 30 carbon atoms, and in particular preferably the one having a total of 6 to 20 carbon atoms, which may have a substituent. The substituent for the substituted one is preferably a halogen atom, an alkyl group, an alkenyl group, an alkynyl group, or an alkoxy group, and especially in particular preferably an alkyl group or an alkoxy group. Specific examples of such an aryl group may include a phenyl group, a nonylphenyl group, an octylphenyl group, a fluorophenyl group, a styrylphenyl group, a phenylethenylphenyl group, and a methoxyphenyl group.

The acyl group represented by R is preferably the one having a total of 2 to 30 carbon atoms, and in particular preferably the one having a total of 2 to 20 carbon atoms, which may be either an aliphatic or aromatic acyl group, and may have a substituent, and further may be branched. The substituent for the substituted one includes no amino group nor nitro group, and is preferably an alkyl group, an aryl group, an alkenyl group, or an alkoxy group. Specific examples such an acyl group may include an acetyl group, a benzoyl group, a (meth)acryloyl group, an oleoyl group, a lauroyl group, a stearoyl group, and a methoxybenzoyl group.

Out of the groups represented by R described up to this point, an alkyl group and an acyl group are more preferred, and in particular preferably an alkyl group.

In the general formula (I), n is a number of 10 to 500 in terms of the average addition mole number of polyether group. The average addition mole number is preferably a number of 10 to 400, and in particular, most preferably a number of 10 to 300.

Below, specific examples of the polyether derivative having a terminal amino group represented by the general formula (I) of the invention will be shown. However, the invention is not limited thereto.

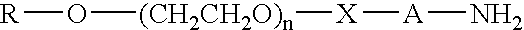

| No | R | —X—A—NH₂ | n |
|---|---|---|---|
| 1-1 | CH₃ | 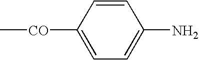 | 98 |
| 1-2 | CH₃ | 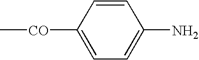 | 113 |
| 1-3 | CH₃ | 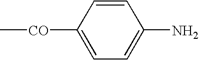 | 45 |
| 1-4 | CH₃ | 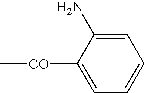 | 46 |
| 1-5 | CH₃ | 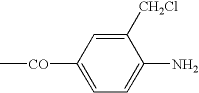 | 17 |
| 1-6 | CH₃ | 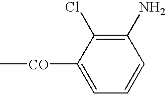 | 98 |
| 1-7 | CH₃ | 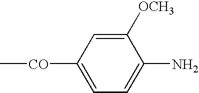 | 113 |
| 1-8 | C₂H₅ | 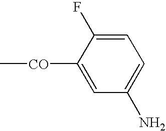 | 220 |
| 1-9 | C₁₈H₃₇ | 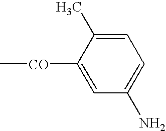 | 110 |
| 1-10 | C₁₂H₂₅ | 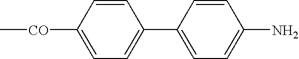 | 98 |
| 1-11 | 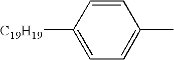 | 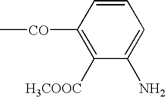 | 90 |
| 1-12 | 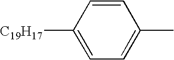 | 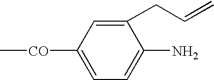 | 98 |
| 1-13 | 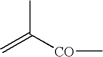 | 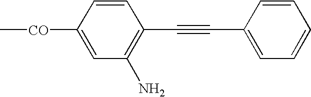 | 98 |
| 1-14 | C₈H₁₇CH═CHC₇H₁₆CO— | 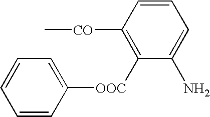 | 98 |
| 1-15 | CH₃ | 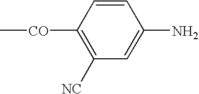 | 98 |
| 1-16 | CH₃ | 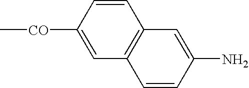 | 90 |
| 1-17 | CH₃ | 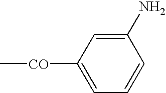 | 45 |
| 1-18 | CH₃ | 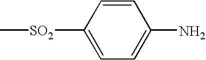 | 98 |
| 1-19 | CH₃ | 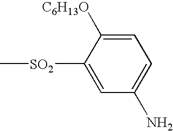 | 113 |
| 1-20 | CH₃ | —COCH₂NH₂ | 98 |
| 1-21 | CH₃ | —COCH₂CH₂NH₂ | 45 |
| 1-22 | C₄H₉ | —CO—(CH₂)₃—NH₂ | 17 |
| 1-23 | 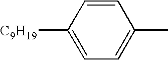 | 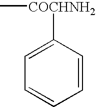 | 113 |
| 1-24 | C₁₁H₂₃CO— | —SO₂CH₂CH₂NH₂ | 98 |
| 1-25 | CH₃ | 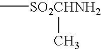 | 113 |

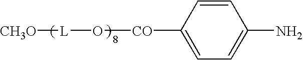

| No | 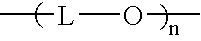 |
|---|---|
| 2-1 | 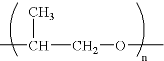 |
| 2-2 | 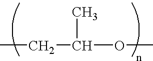 |
| 2-3 | 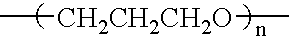 |
| 2-4 | 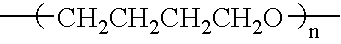 |
| 2-5 | 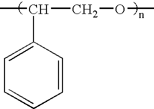 |
| 2-6 | 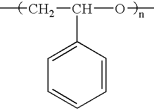 |
| 2-7 | 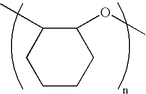 |
| 2-8 | 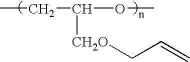 |
| 2-9 | 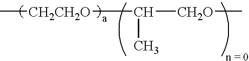 |

“a”: natural number less than “n”

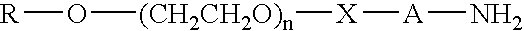

| No. | R | —A—NH₂ | n |
|---|---|---|---|
| 3-1 | CH₃ | —CH₂CH₂NH₂ | 113 |
| 3-2 | CH₃ | —CH₂CH₂NH₂ | 98 |
| 3-3 | CH₃ | —CH₂CH₂CH₂NH₂ | 98 |
| 3-4 | CH₃ | —CH₂CH₂CH₂NH₂ | 45 |
| 3-5 | CH₃ | —(CH₂)₅NH₂ | 30 |
| 3-6 | C₆H₁₃ | —(CH₂)₅NH₂ | 17 |
| 3-7 | C₂₂H₄₅ | 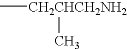 | 300 |
| 3-8 | 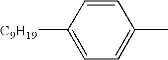 | 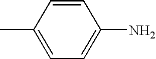 | 500 |
| 3-9 | 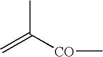 | 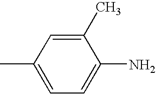 | 98 |
| 3-10 | C₈H₁₇CH═CHC₇H₁₅CO— | 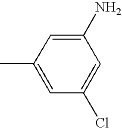 | 113 |

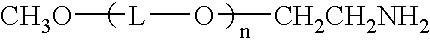

| No | 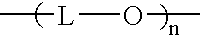 |
|---|---|
| 4-1 | 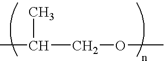 |
| 4-2 | 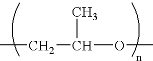 |
| 4-3 | 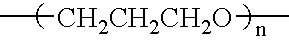 |
| 4-4 | 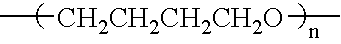 |
| 4-5 | 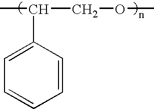 |
| 4-6 | 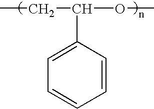 |
| 4-7 | 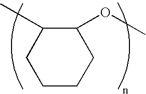 |
| 4-8 | 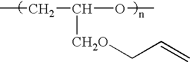 |
| 4-9 | 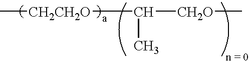 |

“a” natural number less than “n”

(Method for Producing a Polyether Derivative of the General Formula (I))

Then, a method for producing a polyether derivative of the invention will be described. The polyether derivative having a terminal amino group represented by the general formula (I) can be synthesized by using a commercially available product or a known method. As the known synthesis method, J. Org. Chem., <45>, 5364 (1980), JP-A-11-263834, Eur. Poly. J. <19>, 341 (1983), J. Am. Chem. Soc. <118>, 10150 (1996), Tetrahedron Letters <43>, 1529 (2002), or the like can serve as a reference.

Alternatively, when m represents 1 in the general formula (I), a polyether derivative represented by the following general formula (II) and an aromatic nitro compound represented by the following general formula (III) are allowed to react with each other to produce a nitro compound of the following general formula (IV), followed by hydrogen reduction in the presence of a catalyst for catalytic hydrogen reduction. Thus, it is possible to produce a polyether derivative (m=1) of the general formula (I).

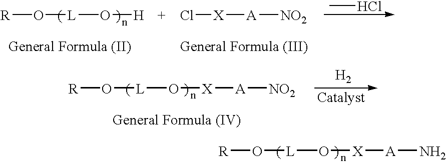

R, L, A, X, and n have the same definitions as with the general formula (I)

For the reaction of the polyether derivative and the aromatic nitro compound, a base such as triethylamine, pyridine, DBU, or sodium hydride is preferably used. For the reaction, a solvent may be used. The solvent is preferably toluene, acetonitrile tetrahydrofuran, or methylene chloride. The temperature of the reaction is preferably 0° C. to 100° C., or the reflux temperature of the solvent to be used.

As the catalysts for catalytic hydrogen reduction for use in the hydrogen reduction of the nitro compound of the general formula (IV), known catalysts can be used. The catalysts are described in details in Fourth edition, JIKKENN KAGAKU KOUZA 26, pages 251 to 266 (edited by the Chemical Society of Japan, Maruzen, 1992). Further, a solvent may be used. The solvent is preferably methanol, ethanol, 2-propanol, tetrahydrofuran, or chloroform. The reaction temperature of the reaction is preferably 0° C. to 60° C., or the reflux temperature of the solvent to be used.

(Microcapsule)

The microcapsule of the invention is a microcapsule having a polyurea or polyurethane/urea wall material formed by polymerizing an isocyanate compound containing a reaction product of (1) an at least di-functional isocyanate compound, and (2) a polyether derivative having a terminal amino group represented by the general formula (1) with a compound having an active hydrogen.

The preferred isocyanate compound used in accordance with the invention is a reaction product bonded through the urea group obtained by the reaction of (1) a multifunctional isocyanate compound having two or three or more functional groups and (2) the polyether derivative having an amino group at the terminal represented by the general formula (I).

Further specifically, the polyisocyanate compound to be used in accordance with the invention is a reaction product obtained by allowing (1) an aliphatic, cyclic aliphatic and/or aromatic multifunctional isocyanate compound, preferably aliphatic and/or cyclic aliphatic multifunctional isocyanate compound having at least 2, and preferably 3 or more functional groups to react with (2) the polyether derivative having an amino group at the terminal represented by the general formula (I).

Specific examples of at least di-functional isocyanate compounds usable for the reaction may include the compounds having two isocyanate groups in the molecule, such as m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxy-biphenyl diisocyanate, 3,3′-dimethyl diphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropane diisocyanate, 4,4′-diphenylhexafluoropropane diisocyanate, trimethylene diisocyanate, hexamethyl diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatemethyl)cyclohexane, and 1,3-bis(isocyanatemethyl)cyclohexane, isophorane diisocyanate, and lysine diisocyanate. Alternatively, addition reaction products of these difunctional isocyanate compounds and difunctional alcohols or phenols such as ethylene glycols or bisphenols may also be utilized.

Further, multifunctional isocyanate compounds may also be utilized. Examples of such a multifunctional compound usable may include trimers (biurets or isocyanurates) using the bifunctional isocyanate compounds as main raw materials, multifunctionalized ones in the form of adducts of polyols such as trimethylolpropane and bifunctional isocyanate compounds, formalin condensate of benzene isocyanate, isocyanate compounds having a polymerizable group such as methacryloyloxyethyl isocyanate, and lysine triisocyanate.

Particularly, other than the trimers (biurets or isocyanates) using the xylene diisocyanate and a hydrogenated product thereof, hexamethylene diisocyanate, tolylene diisocyanate and a hydrogenated product thereof, multifunctionalized ones in the form of adducts with trimethylolpropane are also preferred. These compounds are described in POLYURETHANE JYUSHI HANDBOOK (edited by KEJJIIWATA, published by Nikkan Kogyo Shinbunsha (1987)).

Out of these, 2,4-tolylene diisocyanate, 2,6-tolylene diisocyanate, xylylene-1,4-diisocyanate, xylylene-1,3-diisocyanate, an adduct of trimethylolpropane and xylylene-1,4-diisocyanate or xylylene-1,3-diisocyanate are preferred. Particularly, xylylene-1,4-diisocyanate and xylylene-1,3-diisocyanate, and an adduct of trimethylolpropane and xylylene-1,4-diisocyanate or xylylene-1,3-diisocyanate are preferred.

In the invention, reaction ratio of the polyether derivative having an amino group at the terminal represented by the general formula (I) and the at least di-functional isocyanate compound is preferably 1/100 to 50/100 mol ratio, and in particular preferably 2/100 to 40/100. When the mole reaction ratio is smaller than 1/100, the agglomerating and precipitating property with time of the microcapsules in the coating solution containing an organic solvent is deteriorated. Whereas, when the mole reaction ratio exceeds 50/100, the amount of the residual isocyanate groups is too small, which may make the capsule formation difficult. The addition reaction of the polyether derivative having an amino group at the terminal represented by the general formula (I) and the at least di-functional isocyanate compound can be effected by, for example, leaving both the compounds at room temperature, or heating it (at about 20 to 80° C.), with stirring in an organic solvent not having active hydrogen. Examples of the organic solvent may include ethyl acetate, chloroform, tetrahydrofuran, methyl ethyl ketone, acetone, acetonitrile, and toluene.

Incidentally, as the isocyanate compounds for use in the invention, the addition reaction products of the polyether derivative having an amino group at the terminal represented by the general formula (I) and at least di-functional isocyanate may be used singly alone, or may be used in combination of two or more thereof.

For the isocyanate compound for use in the invention, as the raw material of the microcapsule, other than the addition reaction product of the polyether derivative having an amino group at the terminal represented by the general formula (I) and the at least di-functional isocyanate compound, a known multifunctional isocyanate having two or more isocyanate groups may also be used in combination. As the examples of such multifunctional isocyanate, the compounds exemplified as the di-functional isocyanate can be used in an appropriate ratio in combination.

These multifunctional isocyanate compounds may be used singly alone, or in a mixture of two or more thereof. However, when they are used in combination, the mass ratio of the addition reaction product of the polyether derivative having an amino group at the terminal represented by the general formula (I) and the at least di-functional isocyanate compound and the multifunctional isocyanate to be used in combination of the invention is preferably in the range of 100/0 to 10/90, and more preferably in the range of 90/10 to 15/85.

The formation of the microcapsule of the invention can be carried out in the following manner. In a low boiling point solvent, the reaction product of the polyether derivative having an amino group at the terminal represented by the general formula (I) and at least di-functional isocyanate, a multifunctional iscoyanate used in combination, and at least one of (A) an active light absorber, (B) a polymerization initiator, (C) a polymerizable compound, and (D) a hydrophobic binder polymer are dissolved or dispersed, resulting in an oil phase component. The oil phase component and an aqueous phase component are mixed, and emulsified and dispersed with stirring by a high shear stirrer such as a homogenizer. The low boiling point solvent is evaporated and removed by heating with stirring, or the like from the resulting emulsion.

The low boiling point solvent is preferably an organic solvent having a boiling point of 40 to 100° C. Specifically, mention may be made of ethyl acetate, butyl acetate, methylene chloride, tetrahydrofuran, acetone, and the like. Further, these may be used in a mixture of two or more thereof.

In the invention, for the formation of the microcapsule, as the compound having active hydrogen for use in the polymerization of an isocyanate compound for forming the microcapsule wall, water is generally used. However, polyol is added in an organic solvent or an aqueous solution, which may be used as the compound having active hydrogen (one of the raw materials for the microcapsule wall). Specifically, mention may be made of propylene glycol, glycerin, trimethylolpropane, and the like. Alternatively, an amine compound such as diethylenetriamine or tetraethylenepentamine may be used in place of polyol, or in combination.

Further, for dispersing the oil phase of the microcapsule in the aqueous phase, a surfactant can be used. The surfactant may be added to any of the oil phase or the aqueous phase to be used. However, it is low in solubility in an organic solvent, and hence it is easier to add in the aqueous phase. It is added in an amount of preferably 0.1 to 5 mass %, and in particular preferably 0.5 to 2 mass % based on the mass of the oil phase. In general, as the surfactant to be used for emulsification and dispersion, a surfactant having a relatively long chain hydrophobic group is regarded as being excellent, as in kaimenn kasscizai binnrann (Ichiro Nishi, et al., published by Sangyo Tosho, 1980), and alkali metal salts such as alkyl sulfonate and alkyl benzenesulfonate can be used.

As the water soluble polymers for dispersing the oil phase of the microcapsules in an aqueous phase, in general, polyvinyl alcohol and modified products thereof, polyacrylic acid amide and derivatives thereof, an ethylene/vinyl acetate copolymer, a styrene/maleic acid anhydride copolymer, an ethylene/maleic acid anhydride copolymer, an isobutylene/maleic acid anhydride copolymer, polyvinyl pyrrolidone, an ethylene/acrylic acid copolymer, vinyl acetate/acrylic acid copolymer, carboxymethylcellulose, methylcellulose, casein gelatin, starch derivatives, gum arabic, and sodium alginate, and the like are known. In the invention, these can be used, but preferably it is not used because the stability with time of the image recording layer coating solution containing an organic solvent as a main component is reduced.

The image recording layer can further contain another microcapsule or micro gel encapsulating at least one of the components (A) to (D).

As a method for manufacturing another microcapsule or micro gel, a known method is applicable.

Non-limiting examples of a method for manufacturing a microcapsule include the methods utilizing coacervation disclosed in U.S. Pat. Nos. 2,800,457 and 2,800,458, the methods by an interfacial polymerization method disclosed in U.S. Pat. No. 3,287,154, JP-B-38-19574, and JP-B-42-446, the methods by precipitation of polymers disclosed in U.S. Pat. Nos. 3,418,250 and 3,660,304, the method using an isocyanate polyol wall material disclosed in U.S. Pat. No. 3,796,696, the method using an isocyanate wall material disclosed in U.S. Pat. No. 3,914,511, the methods using an urea-formaldehyde type or urea-formaldehyde-resorcinol type wall forming material disclosed in U.S. Pat. Nos. 4,001,140, 4,087,376, and 4,089,802, the methods using a wall material such as melamine-formaldehyde resin or hydroxy cellulose disclosed in U.S. Pat. No. 4,025,455, an in situ method by monomer polymerization disclosed in JP-B-36-9163 and JP-B-51-9079, a spray drying method disclosed in U.K. Patent No. 930,422 and U.S. Pat. No. 3,111,407, and an electrolytic dispersion and cooling method disclosed in U.K. Patent Nos. 952,807 and 965,074.

The preferred microcapsule wall for use in the invention has three dimensional crosslinks, and has a property of swelling by a solvent. From such a viewpoint, the wall materials of the microcapsule are preferably polyurea, polyurethane, polyester, polycarbonate, polyamide, and a mixture thereof, and in particular preferably polyurea and polyurethane. Further, to the microcapsule wall, a compound having a crosslinkable functional group of an ethylenically unsaturated bond or the like, capable of being introduced into the hydrophobic binder polymer, may be introduced.

On the other hand, non-limiting usable examples of a method for preparing a micro gel include granulation by interfacial polymerization disclosed in JP-B-38-19574 and JP-B-42-446, and granulation by non-aqueous dispersion polymerization as disclosed in JP-A-5-61214.

As the method using interfacial polymerization, the foregoing known method for manufacturing a microcapsule is applicable.

The preferred micro gels for use in the invention is granulated by interfacial polymerization, and have three dimensional crosslinks. From such a viewpoint, the materials to be used are preferably, polyurea, polyurethane, polyester, polycarbonate, polyamide, and a mixture thereof, and in particular preferably polyurea and polyurethane.

The average particle diameter of the microcapsules or the micro gels is preferably 0.01 to 3.0 μm, further preferably 0.05 to 2.0 μm, and in particular preferably 0.10to 1.0 μm. Within this range, it is possible to obtain favorable resolution and stability with time.

(Formation of Image Recording Layer)

The image recording layer of the invention is formed by dispersing or dissolving the foregoing required components in a solvent, preparing a coating solution, and coating the resulting solution. Non-limiting examples of the solvent herein used may include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, and toluene. The solvents may be used alone or in mixture thereof. The concentration of the solid content of the coating solution is preferably 1 to 50 mass %.

The image recording layer of the invention can also be formed by dispersing or dissolving the same or different respective components in the same or different solvents, thus preparing a plurality of coating solutions, and repeatedly carrying out coating and drying thereof plural times.

Further, the amount (solid content) of the image recording layer to be coated on a support, obtainable after coating and drying varies according to the intended use, but it is in general preferably 0.3 to 3.0 g/m². Within this range, it is possible to obtain favorable sensitivity and favorable film characteristics of the image recording layer.

As the coating processes, various processes can be employed. Examples thereof may include bar coater coating, rotary coating, spray coating, curtain coating, dip coating, air knife coating, blade coating, and roll coating.

[Support]

As the support of the lithographic printing plate precursor of the invention has no particular restriction so long as it is a dimensionally stable plate-like article. Examples thereof may include paper, paper laminated with plastic (e.g., polyethylene, polypropylene, or polystyrene), metal plates (e.g., aluminum, zinc, and copper), plastic films (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, and polyvinylacetal), and paper or plastic films laminated or vapor deposited with the above-mentioned metals. As preferred supports, mention may be made of a polyester film and an aluminum plate. Out of these, an aluminum plate which is good in dimensional stability and is relatively inexpensive is preferred.

The aluminum plates are a pure aluminum plate and alloy plates containing aluminum as a main component and containing foreign elements in slight amounts, or plastic-laminated aluminum or aluminum alloy thin film. The foreign elements contained in the aluminum alloys include silicon, iron, manganese, copper, magnesium, chromium, zinc, bismuth, nickel, and titanium. The content of the foreign elements in the alloy is preferably 10 mass % or less. In the invention, a pure aluminum plate is preferred, but the perfectly pure aluminum is difficult to manufacture in terms of the smelting technique. For this reason, aluminum containing trace amounts of foreign elements is also acceptable. Thus, the appropriately usable aluminum plates are not the ones specified in their compositions but the ones of conventional raw materials well known in the art.

The thickness of the support is preferably 0.1 to 0.6 mm, more preferably 0.15 to 0.4 mm, and further preferably 0.2 to 0.3 mm.

Prior to the use of the aluminum plate, a surface treatment such as a surface roughening treatment or an anodic oxidation treatment is preferable preferred. By the surface treatment, it becomes easy to improve the hydrophilicity and to ensure the adhesion between the image recording layer and the support. Prior to surface roughening of the aluminum plate, if desired, a degreasing treatment for removing a rolling oil on the surfaces thereof is carried out with a surfactant, an organic solvent, an alkali aqueous solution, or the like.

The surface roughening treatment of the aluminum plate is carried out by various methods, examples of which may include a mechanical surface roughening treatment, an electrochemical surface roughening treatment (a surface roughening treatment for dissolving the surface electrochemically), and chemical surface roughening treatment (a surface roughening treatment for selectively dissolving the surface chemically).

As the mechanical surface roughening treatment methods, known methods such as a ball polishing method, a brush polishing method, a blast polishing method, and a buff polishing method can be used.

As the electrochemical surface roughening treatment methods, mention may be made of methods which are carried out in an electrolyte containing an acid such as hydrochloric acid or nitric acid with alternating current or direct current. Further, the method of a mixed acid as described in JP-A-54-63902 may also be mentioned.

The aluminum plate subjected to a surface roughening treatment is subjected to, if required, an alkali etching treatment using an aqueous solution of potassium hydroxide, sodium hydroxide, or the like. Further, it is subjected to a neutralization treatment, and then, it is subjected to an anodic oxidization treatment for enhancing the abrasion resistance, if desired.

As the electrolytes to be used for the anodic oxidation treatment of the aluminum plate, various electrolytes for forming a porous oxide film can be used. In general, sulfuric acid, hydrochloric acid, oxalic acid, or chromic acid, or a mixed acid thereof is used. The concentration of the electrolyte is appropriately determined according to the kind of the electrolyte.

The conditions of the anodic oxidation treatment vary variously according to the electrolyte to be used, and hence cannot be determined indiscriminately. However, in general, preferable conditions are as follows: a solution with an electrolyte concentration of 1 to 80 mass %; the solution temperature, 5 to 70° C., the electric current density, 5 to 60 A/dm²; the voltage, 1 to 100 V; and the electrolysis time, 10 seconds to 5 minutes. The amount of anodic oxidation coating film to be formed is preferably 1.0 to 5.0 g/m², and more preferably 1.5 to 4.0 g/m². Within this range, it is possible to obtain favorable plate wear resistance and favorable scratch resistance of the non-image areas of the lithographic printing plate.

As the support for use in the invention, the substrate which has been subjected to the foregoing surface treatment, and has an anodic oxidation film may be used as it is. However, for the further improvement of the adhesion with the upper layer, the hydrophilicity, the stain resistance, the heat insulating property, and the like, if required, it is possible to appropriately select and carry out the expanding treatment of micropores of the anodic oxidation film, the sealing treatment of micropores, the surface hydrophilization treatment in which a film is immersed in an aqueous solution containing a hydrophilic compound, and the like, described in JP-A-2001-253181 and JP-A-2001-322365. Naturally, the expansion treatment and the sealing treatment are not limited to the ones described therein, and conventionally known methods can be used.

The sealing treatment may be, other than vapor sealing, a sealing treatment by an aqueous solution containing an inorganic fluorine compound such as a treatment with fluorozirconic acid alone or a treatment by sodium fluoride, lithium chloride-added vapor sealing, or a sealing treatment by hot water.

Out of these, the sealing treatment by an aqueous solution containing an inorganic fluorine compound, the sealing treatment by water vapor, and the sealing treatment by hot water are preferred.

As the hydrophilization treatment, there is an alkali metal silicate method as disclosed in U.S. Pat. Nos. 2,714,066, 3,181,461, 3,280,734 and 3,902,734. With this method, the support is subjected to an immersion treatment or an electrolysis treatment in an aqueous solution of sodium silicate, or the like. Alternatively, there are used methods of carrying out the treatment with potassium fluorozirconate as described in JP-B-36-22063, and the method of treatment with polyvinyl phosphonic acid as disclosed in U.S. Pat. Nos. 3,276,868, 4,153,461, and 4,689,272, and other methods.

When a support with insufficient surface hydrophilicity such as a polyester film is used as the support of the invention, desirably, a hydrophilic layer is applied to make the surface hydrophilic. The hydrophilic layer is preferably a hydrophilic layer obtained by applying a coating solution containing a colloid of an oxide or a hydroxide of at least one element selected from beryllium, magnesium, aluminum, silicon, titanium, boron, germanium, tin, zirconium, iron, vanadium antimony, and transition metals, described in JP-A-2001-199175, a hydrophilic layer having an organic hydrophilic matrix obtainable by crosslinking or pseudo-crosslinking an organic hydrophilic polymer described in JP-A-2002-79772, a hydrophilic layer having an inorganic hydrophilic matrix obtainable by sol-gel transformation resulting from the hydrolysis or the condensation reaction of polyalkoxysilane, titanate, zirconate, or aluminate, or a hydrophilic layer including an inorganic thin film having the surface containing a metal oxide. Out of these, the hydrophilic layer obtained by coating the coating solution containing a colloid of oxide or hydroxide of silicon is preferred.

Whereas, when a polyester film or the like is used as the support of the invention, an antistatic layer is preferably provided on the hydrophilic layer side, or on the opposite side, or on both the sides of the support. The antistatic layer is provided between the support and the hydrophilic layer. This contributes to the improvement of the adhesion with the hydrophilic layer. The antistatic layer usable is the polymer layer in which metal oxide fine particles and a matting agent are dispersed, described in JP-A-2002-79772, or the like.

The support has a center line average roughness of preferably 0.10 to 1.2 μm. Within the range, it is possible to obtain the good adhesion with the image recording layer, the good plate wear resistance, and the good stain resistance.

Whereas, the color concentration of the support is preferably 0.15 to 0.65 in terms of the reflection density value. Within this range, it is possible to obtain the good image formability by antihalation upon image exposure, and the good plate detectability after development.

[Undercoat Layer]

In the lithographic printing plate precursor of the invention, an undercoat layer of a compound containing a polymerizable group is preferably provided on a support. When the undercoat layer is used, the image recording layer is provided on the undercoat layer. The undercoat layer strengthens the adhesion between the support and the image recording layer in the exposed areas. Whereas, at unexposed areas, it facilitates the occurrence of peeling of the support from the image recording layer, resulting in the improved on-press developability.

As the undercoat layers, specifically, mention may be preferably made of the silane coupling agents having an addition polymerizable ethylenical double bond reactive group described in JP-A-10-282679, a phosphorus compound having an ethylenical double bond reactive group described in JP-A-2-304441, and the like. Further, the compounds having a polymerizable group such as a methacrylic group or an allyl group, and a support adsorptive group such as a sulfonic acid group, a phosphoric acid group, or a phosphoric acid ester are also preferred. The compounds obtained by further adding a hydrophilicity-imparting group such as an ethylene oxide group to the compounds are also preferred.

The amount (solid content) of the undercoat layer to be coated is preferably 0.1 to 100 mg/m², and more preferably 1 to 30 mg/m².

[Overcoat Layer]

In the lithographic printing plate precursor of the invention, an overcoat layer soluble in fountain solution can be provided on the image recording layer for the prevention of the occurrence of scratches or the like on the image recording layer, oxygen blockage, and the prevention of ablation upon high illuminance laser exposure.

In the invention, in general, light exposure is carried out in the air. The overcoat layer prevents the low molecular weight compounds such as oxygen present in the air and basic substances inhibiting the image-forming reaction caused by light exposure in the image recording layer from entering the image recording layer, and prevents the inhibition of the image-forming reaction by light exposure in the air. Therefore, the overcoat layer is demanded to have the following characteristics; the permeability of the low molecular weight compounds such as oxygen is low, further the permeability of light to be used for the exposure is favorable, the adhesion with the image recording layer is excellent; and being removable with ease by fountain solution in an on-press development treatment step after light exposure. Various studies have been heretofore made on the overcoat layers having such characteristics, which are described in details in, for example, U.S. Pat. No. 3,458,311 and JP-B-55-49729.

Examples of the material for use in the overcoat layer may include water soluble polymer compounds relatively excellent in crystallinity. Specifically, mention may be made of water soluble polymers such as polyvinyl alcohol, polyvinyl pyrrolidone, acidic cellulose, gelatin, gum arabic, and polyacrylic acid. Use of polyvinyl alcohol (PVA) as a main component, out of these, provides best results in basic characteristics such as oxygen blocking property and development removability. Polyvinyl alcohol may be partially substituted with ester, ether, or acetal, and may partially have other copolymer components, so long as it contains an unsubstituted vinyl alcohol unit for providing the oxygen blocking property and water solubility necessary for the overcoat layer.

Specific preferred examples of polyvinyl alcohol may include 71 to 100 mol % hydrolyzed ones with a degree of polymerization in the range of 300 to 2400. Specific examples thereof may include PVA-105, PVA-110, PVA-117, PVA-117H, PVA-120, PVA-124, PVA-14H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, and L-8.

The components of the overcoat layer (selection of PVA, use of additives, and the like), the coating amount, and the like are appropriately selected in consideration of, other than the oxygen blocking property and the development removability, the fogging property, the adhesion, the scratch resistance, and the like. Generally, the oxygen blocking property is enhanced with an increase in hydrolysis ratio of PVA (i.e., with an increase in content of the unsubstituted vinyl alcohol unit in the overcoat layer), and with an increase in film thickness. This is preferably in terms of sensitivity. Whereas, in order to prevent the unnecessary polymerization reaction during manufacturing and during storage, unnecessary fogging during image light exposure, the overgrowth of printing areas, and the like, it is preferable that the oxygen permeability is not too high. Therefore, the oxygen permeability at 25° C. under 1 atmospheric pressure is preferably: 0.2≦A≦20 (cc/m²-day).

As other compositions of the overcoat layer, glycerin, dipropylene glycol, or the like can be added in an amount equivalent to several mass percent based on the amount of the (co)polymer to impart the flexibility. Whereas, an anionic surfactant such as sodium alkyl sulfate or sodium alkyl sulfonate; an amphoteric surfactant such as alkylaminocarboxylic acid salt or allylaminodicarboxylic acid salt; or a nonionic surfactant such as polyoxyethylene alkyl phenyl ether can be added in an amount of several mass percent based on the amount of the water soluble polymer compound.

Further, the adhesion with the image areas, the scratch resistance, and the like are also very important in handling of the lithographic printing plate precursor. Namely, when the overcoat layer which is hydrophilic for the inclusion of the water soluble polymer compound is stacked on the image recording layer which is oleophilic, peeling of the overcoat layer due to insufficient adhesion power tends to occur. At the peeled portions, defects such as insufficient film curing caused by inhibition of polymerization by oxygen may occur.

In contrast, various proposals have been made to improve the adhesion between the image recording layer and the overcoat layer. For example, JP-A-49-70702 an GB No. 1303578 describes as follows. In a hydrophilic polymer mainly containing polyvinyl alcohol, an acrylic emulsion, a water insoluble vinyl pyrrolidone-vinyl acetate copolymer, and the like are mixed in an amount of 20 to 60 mass %, and the resulting mixture is stacked on the image recording layer. This results in sufficient adhesion. In the invention, all of these known techniques can be used.

Further, to the overcoat layer, other functions can also be imparted. For example, it is possible to add a colorant (e.g., water soluble dye) excellent in permeability of infrared rays for use in light exposure, and capable of efficiently absorbing light rays of other wavelengths, and thereby to improve the safelight suitability without causing a reduction of the sensitivity.

The film thickness of the overcoat layer is suitably 0.1 to 5 μm, and in particular preferably 0.2 to 2 μm.

The coating method of the overcoat layer is described in details in, for example, U.S. Pat. No. 3,458,311 and JP-B-55-49729.

[Backcoat Layer]

A support is subjected to a surface treatment, and then, or an undercoat layer is formed, an then, if required, a backcoat can be provided on the back side of the support.

Examples of the backcoat may include coating layers made of organic polymer compounds described in JP-A-5-45885, or metal oxides obtained by hydrolyzing or polycondensating the organometallic compounds or the inorganometallic compounds described in JP-A-6-35174. Out of these, alkoxy compounds of silicon such as Si(OCH₃)₄, Si(OC₂H₅)₄, Si(OC₃H₇)₄, and Si(OC₄H₉)₄ are preferably used because of the low cost and high availability of the raw materials.

[Lithographic Printing Method]

In the lithographic printing method of the invention, the foregoing lithographic printing plate precursor of the invention is exposed to light through a transparent original picture having line images, dot images, or the like, or is subjected to laser scanning exposure, thereby to the imagewise exposed to light. Examples of the exposure light source may include a carbon arc, a high pressure mercury lamp, a xenon lamp, a metal halide lamp, a fluorescent lamp, a tungsten lamp, a halogen lamp, an ultraviolet laser, a visible light laser, and an infrared laser. In particular, lasers are preferred, and mention may be made of a solid laser and a semiconductor laser emitting an infrared ray of 760 to 1200 nm, a semiconductor laser emitting a light of 250 to 420 nm, and the like. When a laser is used, imagewise scanning exposure is preferably carried out in accordance with digital data. Whereas, in order to shorten the exposure time, a multibeam layer device is preferably used. The exposure time per pixel is preferably 20μ seconds or less. Whereas, the irradiation energy amount is preferably 10 to 300 mJ/cm².

In the lithographic printing method of the invention, after imagewise light exposure, printing is carried out by supplying a printing ink and fountain solution without going through any development treatment step. Specifically, mention may be made of a method in which a lithographic printing plate precursor is exposed to light by a laser, and then mounted on a printer press without going through a development treatment step for printing, a method in which a lithographic printing plate precursor is mounted on a printer press, and then exposed to light by a laser on the printer press without going through a development treatment step for printing, and other methods.

The lithographic printing plate precursor is imagewise exposed by a laser. Then, printing is carried out by supplying a printing ink and fountain solution without going through a development treatment step such as a wet development treatment step. As a result, at the exposed areas of the image recording layer, the image recording layer cured by light exposure forms printing ink-receptive areas having an oleophilic surface. On the other hand, at unexposed areas, the uncured portions of the image recording layer are dissolved or dispersed by the supplied fountain solution and printing ink, or both of them to be removed, so that the hydrophilic surface is exposed at the portions.

As a result, fountain solution is deposited on the exposed portions of the hydrophilic surface, and the printing ink is deposited on the exposed areas of the image recording layer, so that printing is started. Herein, the one which is first supplied to the plate surface may be fountain solution or printing ink. However, a printing ink is preferably first supplied from the viewpoint of preventing the contamination of the fountain solution by the unexposed areas of the image recording layer.

Thus, the lithographic printing plate precursor is subjected to on-press development on an offset printing press, and used as it is for the printing of a large number of sheets.

### EXAMPLES

Below, the invention will be described in details by way of examples, which should not be construed as limiting the scope of the invention.

### Synthesis Example of a Hydrophilic Polymer (1) Having One or More Active Hydrogen Groups Reactable with an Isocyanate Group at One Terminal

Methacrylic acid 3-sulfopropyl ester potassium salt: 100 g, 2-mercaptoethylamine hydrochloride: 2.0 g, and a polymerization initiator VA-044 manufactured by Wako Pure Chemical Industries, Ltd.: 0.3 g were dissolved in water: 100 g, resulting in an aqueous solution. The resulting aqueous solution was added dropwise to water: 100 g kept at 50° C. under a nitrogen atmosphere for 2 hours, and further added dropwise, and then the solution was stirred at 50° C. for 2 hours, and at 60° C. for 2 hours. After cooling, the solution was gradually added dropwise to acetone; 3L, so that a white solid precipitated. The resulting solid was filtrated and dried, resulting in 95 g of a hydrophilic polymer (1) of terminal amine hydrochloride. (Molecular weight 2.1×10³).

### Synthesis Example of a Hydrophilic Polymer (2) Having One or More Active Hydrogen Groups Reactable with an Isocyanate Group at One Terminal

Acrylamide: 50 g and 2-mercaptoethylamine hydrochloride: 5 g were dissolved in ethanol: 100 g. Then, the resulting mixture was heated to 60° C. under a nitrogen atmosphere. A thermal polymerization initiator 2,2-azobisisobutylnitrile (AIBN): 0.5 g was added thereto for a 6-hour reaction. After the reaction, a white precipitate was filtered, and sufficiently washed with methanol, resulting in 48 g of a hydrophilic polymer (2) of terminal amine hydrochloride. (Molecular weight 2.2×10³).

### Manufacturing Example 1 of Microcapsule Particles

As an oil phase component, 10 g of an adduct of trimethylolpropane and xylene diisocyanate (manufactured by Mitsui Takeda Chemicals, Inc., TAKENATE D-110N), 4.5 g of pentacrylthritol triacrylate (manufactured by Nippon Kayaku Co., Ltd., SR444), 1.5 g of the following infrared absorber (1), 0.5 g of 3-(N,N-diethylamino)-6-methyl-7-anilinofluoran (manufactured by Yamamoto Kasei Co., Ltd., ODB), 0.75 g of the following polymerization initiator (1), and 0.1 g of PAIONIN A-41C (manufactured by TAKEMOTO OIL & FAT Co., Ltd.) were dissolved in 17 g of ethyl acetate. As an aqueous phase component, to 1.5 g of the hydrophilic polymer (1) formed in Synthesis Example 1 and 0.7 g of a 1 N sodium hydroxide aqueous solution, 333 g of water was added for preparation. The oil phase component and the aqueous phase component were mixed, and emulsified at 12000 rpm for 10 minutes by a homogenizer. The resulting emulsion was added to 25 g of distilled water. The mixture was stirred at room temperature for 30 minutes, and then, stirred at 60° C. for 2 hours. The microcapsule solution thus obtained was diluted with distilled water so that the solid content concentration was 15 mass %. The average particle diameter was 0.3 μm.

To the dispersion of the microcapsule particles, methanol was added in an amount of 20 wt %, and the dispersion stability was evaluated. The particles did not precipitate even after an elapse of 7 days, and were dispersed with stability. Further, the microcapsules were coated on an aluminum support, and dried, to form a 1 g/m² microcapsule layer, and a 3-day heat treatment at 60° C. was performed. The water droplet contact angle before and after performing the heat treatment was examined. As a result, either showed extended wetting at a contact angle of 0 degree, indicating that the microcapsules were good in surface hydrophilicity, and were not susceptible to the leakage of the encapsulated substances due to heat.

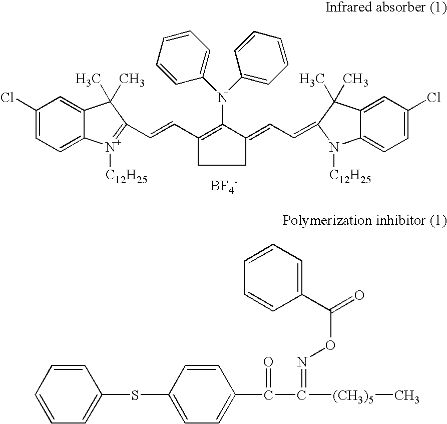

### Manufacturing Example 2 of Microcapsule Particles

A microcapsule particle dispersion was manufactured in the same manner as in Manufacturing Example 1 of microcapsule particles, except that the hydrophilic polymer used in Manufacturing Example 1 of microcapsule particles was changed to the hydrophilic polymer (2) manufactured in Synthesis Example 2. The average particle diameter was 0.4 μm.

The microcapsule particle dispersion was evaluated for the dispersion stability, the surface hydrophilicity, and the leakage of the encapsulated substances in the same manner as in the Manufacturing Example 1. As a result, the same results as those in Manufacturing Example 1 were obtained, indicating that all were good.

### Manufacturing Example 1 of Comparative Microcapsule Particles

A microcapsule dispersion was manufactured in the same manner as in Manufacturing Example 1 of microcapsule particles, except that the hydrophilic polymer used in Manufacturing Example 1 of microcapsule particles was changed to PVA 405 (polyvinyl alcohol manufactured by Kuraray Co., Ltd., degree of saponification 81.5 mol %). The average particle diameter was 0.2 μm.

The microcapsule particle dispersion was evaluated for the dispersion stability, the surface hydrophilicity, and the leakage of the encapsulated substances in the same manner as in the Manufacturing Example 1. As for the dispersion stability, precipitation occurred upon an elapse of 1 day, indicating that the stability was inferior. Further, for the surface hydrophilicity and the leakage of the encapsulated substances, the contact angle before the heat treatment was 25 degrees, and the contact angle after the heat treatment was 42 degrees. Thus, both were inferior.

### Manufacturing Example 2 of Comparative Microcapsule Particles

As an oil phase component, 10 g of an isocyanate compound (1) of the following synthesis method, 4.5 g of pentaerythritol triacrylate (manufactured by Nippon Kayaku Co., Ltd., SR444), 1.5 g of the infrared absorber (1), 0.5 g of 3-(N,N-diethylamine)-6-methyl-7-anilinofluoran (manufactured by Yamamoto Kasei Co., Ltd., ODB), 0.75 g of the polymerization initiator (1), and 0.1 g of PAIONIN A-41C (manufactured by TAKEMOTO OIL & FAT Co., Ltd.) were dissolved in 17 g of ethyl acetate. As an aqueous phase component, 37 g of water was added for preparation. The oil phase component and the aqueous phase component were mixed, and emulsified at 12000 rpm for 10 minutes by a homogenizer. The resulting emulsion was added to 25 g of distilled water. The mixture was stirred at room temperature for 30 minutes, and then, stirred at 60° C. for 2 hours. The microcapsule solution thus obtained was diluted with distilled water so that the solid content concentration was 15 mass %. The average particle diameter was 0.3 μm.

(Synthesis of Isocyanate Compound (1))

10 g of acrylamide, and 1 g of 2-mercapto ethanol were dissolved in 50 g of ethanol. Then, the mixture was heated to 70° C. under a nitrogen atmosphere, and 0.1 g of AIBN (2,2-azobisisobutylnitrile) was added thereto for a 7-hour reaction. After the reaction, a white precipitate was filtrated, and sufficiently washed with methanol, resulting in 10 g of polyacrylamide having a hydroxyl group at the terminal (Molecular weight 1,500). 150 parts of the polyacrylamide was dissolved in 250 parts of dry chloroform, and 15 parts of molecular sieve 4A was added thereto. Drying was carried ;out for 5 hours under the dry nitrogen gas flow. A polyvalent isocyanate compound (xylylene diisocyanate/trimethylolpropane adduct (TAKENATE D-110N, 75 mass % ethyl acetate solution, manufactured by Mitsui Takeda Chemicals, Inc.,) was added thereto. In a water bath, 0.3 g of stannous octylate (Stanoct, manufactured by Yoshitomi Pharmaceutical Industries, Ltd.) was added. The mixture was stirred at room temperature for 2 hours, and then stirred at 70° C. for 2 hours. Thus, a solution of an isocyanate compound (1) (50 mass %) was obtained.

The microcapsule particle dispersion was evaluated for the dispersion stability, the surface hydrophilicity, and the leakage of the encapsulated substances in the same manner as in the Manufacturing Example 1. As for the dispersion stability, no precipitation occurred even after an elapse of 7 days, but coarse particles were formed, indicating that the stability was insufficient. Further, for the surface hydrophilicity and the leakage of the encapsulated substances, the contact angle before the heat treatment was 5 degrees, and the contact angle after the heat treatment was 15 degrees. Thus, both were insufficient.

### Example 1

### Manufacturing Example 1 of Precursor for a Lithographic Printing Plate

(1) Manufacturing of Support

A molten metal of JIS A1050 aluminum alloy containing Al: 99.5 mass % or more Fe: 0.30 mass %, Si: 0.10 mass %, Ti: 0.02 mass %, and Cu: 0.013 mass %, and the balance being inevitable impurities was subjected to a purification treatment, and cast. In the purification treatment, a degassing treatment was carried out for removing unnecessary gases such as hydrogen in the molten metal, and further, a ceramic tube filter treatment was carried out. Casting was accomplished by a DC casting method. The solidified ingot with a plate thickness of 500 mm was machined to a depth of 10 mm from the surface, and subjected to a homogenization treatment at 550° C. for 10 hours so as to prevent the intermetallic compound from increasing in size too much. Then, the ingot was hot rolled at 400° C., and subjected to an intermediate annealing in a continuous annealing furnace at 500° C. for 60 seconds, followed by cold rolling. This resulted in an aluminum rolled plate with a thickness of 0.30 mm. By controlling the roughness of the reduction roll, the center line average height R, after cold rolling was controlled to 0.2 μm. Thereafter, the plate was treated in a tension leveler in order to improve its flatness. The resulting aluminum plate was subjected to the following surface treatment.

First, a degreasing treatment was carried out with a 10 mass % sodium aluminate aqueous solution at 50° C. for 30 seconds in order to remove the rolling oil on the aluminum plate surface. Thereafter, neutralization and desmutting treatments were carried out with a 30 mass % nitric acid aqueous solution at 50° C. for 30 seconds.

Then, a surface roughening treatment was carried out in order to achieve a favorable adhesion between the image recording layer and the support, and to impart water retentivity to non-image areas. Specifically, while drifting a web of an aluminum plate in an aqueous solution containing 1 mass % nitric acid and 0.5 mass % aluminum nitrate (solution temperature 45° C.) supplied to an indirect feed cell, electrolysis was carried out so that the electrical quantity when the aluminum plate served as an anode was 240 C/dm² with a current density of 20 A/dm² and an a.c. waveform having a duty factor of 1:1. Thus, an electrochemical surface roughening treatment was performed.

Further, by the use of a 10 mass % sodium hydroxide aqueous solution, an etching treatment was performed at 35° C. for 30 seconds. Then, neutralization and desmutting treatments were carried out with a 30 mass % sulfuric acid aqueous solution at 50° C. for 30 seconds.

Thereafter, an anodic oxidation treatment was carried out in order to improve the wear resistance, the chemical resistance, and the water retentivity.

Specifically, while drifting a web of an aluminum plate in a 20 mass % sulfuric acid aqueous solution (solution temperature 35° C.) supplied to an indirect feed cell, electrolysis was carried out with a DC current of a current density of 15 A/dm² to manufacture a 2.5 g/m² anodic oxidation film.

Thereafter, in order to ensure the hydrophilicity of the non-image areas, a silicate treatment was performed with a 1.5 mass % aqueous solution of sodium silicate No. 3 at 70° C. for 15 seconds. The amount of Si to be deposited was 10 mg/m². Then, washing with water was carried out to obtain a support. The center line average roughness R₂₁ of the resulting support was 0.25 μm.

(2) Formation of Image Recording Layer

On the support, the image recording layer coating solution of the following composition was bar coated, and then, oven dried at 80° C. for 10 minutes, thereby to form an image recording layer in a dry coating amount of 3.0 g/m². Thus, an precursor for a lithographic printing plate was manufactured.

| | |
|---|---|
| 20 Mass % aqueous solution of colloidal silica dispersion | 100 g |
| (Snowtex C) | |
| The following sol / gel preparation solution | 500 g |
| Microcapsule particles of Manufacturing Example 1 of | 550 g |
| microcapsule particles (15 mass % water dispersion) | |
| 5 Mass % aqueous solution of anionic surfactant (manufactured by | 30 g |
| Nikko Chemicals Co., Ltd., NIKKOL OTP-75) | |
| Purified water | 450 g |

<Sol/Gel Preparation Solution>

In 19.2 g of ethyl alcohol, 0.86 g of acetylacetone, 0.98 g of tetraethyl orthotitanate, and 8.82 g of purified water, 1.04 g of tetramethoxysilane (manufactured by Tokyo Kogyou Co., Ltd.) and 0.34 g of the following hydrophilic polymer having a silane coupling group at the terminal were mixed, and the mixture was aged at room temperature for 2 hours for preparation.

<Synthesis of Hydrophilic Polymer Having a Silane Coupling Group at the Terminal>

In a 3-neck flask, 25 g of acrylamide, 3.5 g of 3-mercaptopropyltrimethoxysilane, and 51.3 g of dimethylformamide were charged, and the flask was heated under a nitrogen flow up to 65° C. 0.25 Gram of 2,2′-azobis(2,4-dimethylvaleronitrile) was added, so that the reaction was started. The solution was stirred for 6 hours, and returned to room temperature, and charged in 1.5 L of ethyl acetate. As a result, a solid precipitated. Then, the solid was filtrated, sufficiently washed with ethyl acetate, and dried (yield 21 g). By GPC (polyethylene standard), it was found to be a polymer having a mass-average molecular weight of 5000.

### Example 2

An precursor for a lithographic printing plate was manufactured in the same manner as in Example 1, except that the microcapsule particles used in Example 1 were changed to the microcapsule particles manufactured in Manufacturing Example 2 of microcapsule particles.

### Example 3

On the image recording layer formed in Example 1, the overcoat layer coating solution of the following composition was bar coated, and then, oven dried at 80° C. for 2 minutes, thereby to form an overcoat layer in a dry coating amount of 1.0 g/m². Thus, an precursor for a lithographic printing plate was manufactured.

| | |
|---|---|
| Polyvinyl alcohol (degree of saporification 95 mol %, | 40 g |
| degree of polymerization 800) | |
| Polyvinyl pyrrolidone (molecular weight 50,000) | 5 g |
| Poly(vinyl pyrrolidone/vinyl acetate (1/1)) molecular | 5 g |
| weight 70,000 | |
| Water | 950 g |

### Comparative Example 1

An precursor for a lithographic printing plate was manufactured in the same manner as in Example 1, except that the microcapsule particles used in Example 1 were changed to the microcapsule particles manufactured in Manufacturing Example 1 of comparative Microcapsule particles.

### Comparative Example 2

An precursor for a lithographic printing plate was manufactured in the same manner as in Example 1, except that the microcapsule particles used in Example 1 were changed to the microcapsule particles manufactured in Manufacturing Example 2 of comparative microcapsule particles.

[Light Exposure and Printing]

The resulting precursor for a lithographic printing plate was exposed to light by means of a Trendsetter 3244VX, manufactured by Creo Corp, equipped with a water cooling type 40 W infrared semiconductor laser under the conditions of an output of 9 W, a number of revolutions of external drum of 210 rpm, and a resolution of 2400 dpi. The exposure image was allowed to include a thin line chart. The resulting exposed precursor was attached on a cylinder of a printing press SOR-M manufactured by Heidelberg Co., without undergoing a development treatment. By the use of fountain solution (EU-3 (etchant manufactured by Fuji Photo Film Co., Ltd.)/water/isopropyl alcohol=1/89/10 (volume ratio)) and TRANS-G(N) Sumi ink (manufactured by Dainippon Ink & Chemicals, Inc.), fountain solution was supplied. Then, 500 sheets were printed at a printing speed of 6000 sheets per hour. Thereafter, once, an ink was deposited on the plate surface, and fountain solution was supplied. Thus, the maximum number of sheets until the ink disappeared from the top surface of the plate, and greasing of non-image areas of the printed matter ceased to occur was determined. Then, printing was carried out until greasing occurred.

[Evaluation]

The greasing, the ink repellency, and the plate wear resistance were evaluated in the following manner. The results are shown in Table 1.

(1) Greasing

When printing of 500 sheets had been completed, the amount of ink deposited on the non-image areas of the printed matter was visually evaluated. The state in which no ink was deposited at all was rated as o, and the state in which ink was deposited in even a small amount was rated as x.

(2) Ink Repellency

Upon the start of printing, an ink was firstly supplied on the plate to deposit an ink on the entire plate surface, and then fountain solution was supplied on the plate to determine the number of printing sheets until the ink on the non-image area was completely removed as the number of sheets for ink repellency. A hydrophilic layer more excellent in hydrophilicity requires a smaller number of sheets for ink repellency.

(3) Plate Wear Resistance

The time instant when the non-image areas were worn, and greasing occurred was taken as the completion of printing, an the number of printed sheets until that time was determined. The number of printed sheets increases with an increase in strength of the hydrophilic layer, and accordingly the plate wear resistance is more excellent.

TABLE 1

| | | Number of sheets | Number of print wear |
|---|---|---|---|
| | | for ink repellency | resistant sheets |
| | Greasing | (number of sheets) | (number of sheets) |
| Example 1 | ∘ | 10 | 15000 |
| Example 2 | ∘ | 15 | 12000 |
| Example 3 | ∘ | 10 | 20000 |
| Comparative | x | — | — |
| Example 1 | | | |
| Comparative | ∘ | 100 | 8000 |
| Example 2 | | | |

The results shown above indicates that each precursor for a lithographic printing plate of Examples using the microcapsule of the invention has an excellent performance against printing stain, and is also excellent in plate wear resistance.

1. <Manufacturing of Support>

In order to remove the rolling oil on the surface of an aluminum plate (material 1050) with a thickness of 0.3 mm, a degreasing treatment was carried out with a 10% sodium aluminate aqueous solution at 50° C. for 30 seconds. Then, by the use of 3 nylon brushes implanted with 0.3-mm hair diameter bundles, and a pumice aqueous suspension (specific gravity 1.1 g/cm³), the aluminum surface was grained, and well washed with water. This plate was immersed in a 25 mass % sodium hydroxide aqueous solution for 9 seconds for etching. After washing with water, the plate was further immersed in a 20 mass % nitric acid at 60° C. for 20 seconds, and washed with water. The etching amount of the grained surface at this step was about 3 g/m².

Then, an electrochemical surface roughening treatment was continuously carried out using an AC voltage of 60 Hz. The electrolyte at this step was a 1 mass % aqueous solution of nitric acid (containing aluminum ions in an amount of 0.5 mass %), and had a solution temperature of 50° C. For an AC power waveform, a trapezoidal square alternating current having a time TP required for current value to reach from zero to peak of 0.8 msec and a duty ratio of 1:1 was used. Thus, an electrochemical surface roughening treatment was carried out with a carbon electrode as a counter electrode. The auxiliary anode used was ferrite. The current density in terms of the current peak value was 30 A/dm², and 5% of the current flown from the power source was diverted into the auxiliary anode. The quantity of electricity in nitric acid electrolysis was 175 C/dm² in terms of the quantity of electricity when the aluminum plate served as an anode. Thereafter, water washing by means of spraying was carried out.

Then, an electrochemical surface roughening treatment was carried out in the same manner as in nitric acid electrolysis with an electrolyte of a 0.5 mass % aqueous solution of hydrochloric acid (containing aluminum ions in an amount of 0.5 mass %) at a solution temperature of 50° C. under the condition of a quantity of electricity when the aluminum plate served as an anode of 50 C/dm². Thereafter, water washing by means of spraying was carried out. This plate was provided with a 2.5 g/m² DC anodic oxidation film with a 15 mass % sulfuric acid (containing aluminum ions in an amount of 0.5 mass %) as an electrolyte and at a current density of 15 A/dm², followed by washing with water, and drying.

The center line average roughness (Ra) of the support thus obtained was measured by means of a probe with a diameter of 2 μm, and found to be 0.51 μm.

Further, the following undercoat solution (1) was coated so as to achieve a dry coating amount of 6 mg/m² to manufacture a support having an undercoat layer for use in the following experiments.

| | |
|---|---|
| Undercoat compound (1) | 0.017 g |
| Methanol | 9.00 g |
| Water | 1.00 g |

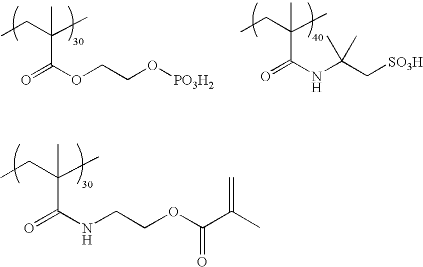

Undercoat compound (1)

2. <Synthesis of Isocyanate Compound>

### Synthesis Example 1

### Synthesis of Isocyanate Compound (1)

According to the following synthesis procedure, an isocyanate compound (1) was synthesized. 75 parts of the compound of the specific compound example (3-1) was dried at an external temperature of 80° C. over 2 hours by means of a vacuum pump, and then, it was returned to room temperature. Thus, 125 parts of dry ethyl acetate and 100 parts of a polyvalent isocyanate compound (xylene diisocyanate/trimethylolpropane adduct (“TAKENATE D-110N” manufactured by Mitsui Takeda Chemicals, Inc., 75 mass % ethyl acetate solution) were added thereto, and stirring was carried out at 50° C. for 3 hours. Thus, a 50 mass % solution of the isocyanate compound (1) was obtained.

### Synthesis Example 2

### Synthesis of Isocyanate Compound (2)

A 50 mass % solution of an isocyanate compound (2) was obtained in the same manner as in Synthesis Example 1, except that the compound of the specific compound example (3-1) used in Synthesis Example 1 was changed to the compound of the specific compound example (3-2).

### Synthesis Example 3

### Synthesis of Isocyanate Compound (3)

A 50 mass % solution of an isocyanate compound (3) was obtained in the same manner as in Synthesis Example 1, except that the compound of the specific compound example (3-1) used in Synthesis Example 1 was changed to the compound of the specific compound example (1-20).

### Synthesis Example 4

### Synthesis of Isocyanate Compound (4)

A 50 mass % solution of an isocyanate compound (4) was obtained in the same manner as in Synthesis Example 1, except that the compound of the specific compound example (3-1) used in Synthesis Example 1 was changed to the compound of the specific compound example (1-1).

3. <Synthesis of Microcapsule>

### Synthesis Example 1

### Synthesis of Microcapsule (1)

As an oil component, 7.0 g of an trimethylolpropane/xylene diisocyanate adduct (“TAKENATE D-110N” manufactured by Mitsui Takeda Chemicals, Inc., 75 mass % ethyl acetate solution), 4.5 g of the isocyanate compound (1) (50 mass % ethyl acetate solution), 6.00 g of ARONIX M-215 (manufactured by Toa Gosci Kagaku Kogyo Co., Ltd.), and 0.18 g of PAIONIN A-41C (manufactured by TAKEMOTO OIL & FAT Co., Ltd.) were dissolved in 15.61 g of ethyl acetate. As an aqueous component, 37.5 g of distilled water was weighed. The oil phase component and the aqueous phase component were mixed and emulsified at 12000 rpm for 10 minutes by means of a homogenizer. The resulting emulsion was added to 23 g of distilled water, and the mixture was stirred at room temperature for 30 minutes, and then, stirred at 40° C. for 2 hours. The microcapsule solution thus obtained was diluted with distilled water so that the solid content concentration was 15 mass %. The particle diameter of the microcapsule herein obtained was measured by means of a particle diameter distribution measuring apparatus “LA-910” manufactured by Horiba Seisakusho Co., Ltd., and as a result, it was found to be 0.17 μm in terms of the median diameter.

### Synthesis Example 2

### Synthesis of Microcapsule (2)

A 15 mass % aqueous solution of microcapsule (2) was obtained in the same manner as in Synthesis Example 1, except that the trimethylolpropane/xylene diisocyanate adduct used in Synthesis Example 1 was changed to the isocyanate compound (2). The particle diameter of the resulting microcapsule was 0.18 μm.

### Synthesis Example 3

### Synthesis of Microcapsule (3)

A 15 mass % aqueous solution of microcapsule (3) was obtained in the same manner as in Synthesis Example 1, except that the trimethylolpropane/xylene diisocyanate adduct used in Synthesis Example 1 was changed to the isocyanate compound (3). The particle diameter of the resulting microcapsule was 0.18 μm.

### Synthesis Example 4

### Synthesis of Microcapsule (4)

A 15 mass % aqueous solution of microcapsule (4) was obtained in the same manner as in Synthesis Example 1, except that the trimethylolpropane/xylene diisocyanate adduct used in Synthesis Example 1 was changed to the isocyanate compound (4). The particle diameter of the resulting microcapsule was 0.18 μm.

### Synthesis Example 5

### Synthesis of Microcapsule (5)

A 15 mass % aqueous solution of microcapsule (5) was obtained in the same manner as in Synthesis Example 1, except that the aqueous phase component used in Synthesis Example 1 was changed to a 4 mass % aqueous solution of PVA-205. The particle diameter of the resulting microcapsule was 0.16 μm.

### Synthesis Example 6

### Synthesis of Microcapsule (6)

As an oil component, 10 g of a trimethylolpropane/xylene diisocyanate adduct (“TAKENATE D-110N” manufactured by Mitsui Takeda Chemicals, Inc., 75 mass % ethyl acetate solution), 6.00 g of ARONIX M-215 (manufactured by Toa Gosci Kagaku Kogyo Co., Ltd.), and 0.18 g of PAIONIN A-41C (manufactured by TAKEMOTO OIL & FAT Co., Ltd.) were dissolved in 16.61 g of ethyl acetate. As an aqueous component, 37.5 g of a 4 mass % aqueous solution of PVA-205 was prepared. The oil phase component and the aqueous phase component were mixed. A 15 mass % aqueous solution of microcapsule (6) was obtained in the same manner as in Synthesis Example 1. The particle diameter of the resulting microcapsule was be 0.16 μm.

### Example 4

(a) Preparation of Image Recording Layer Coating Solution

An organic solvent solution and an aqueous solvent solution with the following compositions were respectively prepared. Then, while stirring the organic solvent solution, the aqueous solvent solution was added. Stirring was stopped at 15 minutes after the addition to complete an image recording layer coating solution.

<Organic Solvent Solution>

| | |
|---|---|
| The following infrared absorber (1) | 0.2 g |
| The following polymerization initiator (1) | 1.0 g |
| The following binder polymer (1) (average molceular weight 80,000) | 1.6 g |
| Polymerizable compound ARONIX M-215 (manufactured by Toa Gosei Kagaku Kogyo Co., Ltd.) | 3.9 g |
| Propylene glycol monomethyl ether | 86.1 g |
| Methyl ethyl ketone | 11.0 g |
| <Aqueous solvont solution> | |
| Microcapsule (1) | 26.5 g |
| Distilled water | 47.1 g |
| Fluorine-containing surfactant (1) | 0.05 g |

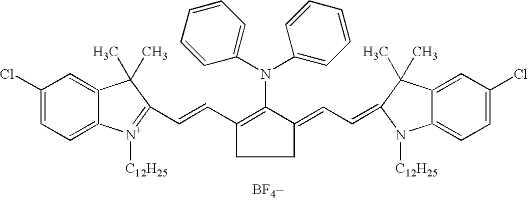

Infrared absorber (1)

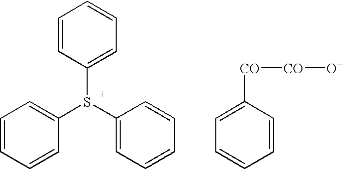

Polymerization initiator (1)

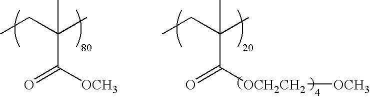

Binder polymer (1)

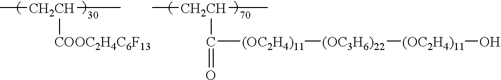

Fluorine-containing surfactant (1)

(b) Evaluation of Stability with Time of Image Recording Layer Coating Solution

The resulting image recording layer coating solution was stored at room temperature, and the time required until the microcapsule precipitation became visually observable was evaluated as the coating solution expiration date.

(C) Formation of Image Recording Layer

The image recording layer coating solution obtained in the item (a) was bar coated on the support having the undercoat layer after 1 hour, after 12 hours, and after 3 days from the preparation of the solution, and then, oven dried at 120° C. doe 40 seconds. Thus, an image recording layer in a dry coating amount of 1.0 g/m² was formed, resulting in a lithographic printing plate precursor.

(d) On-Press Developability and Printing Evaluation

The resulting lithographic printing plate precursor was exposed to light by means of a Trendsetter 3244VX, manufactured by Creo Corp, equipped with a water cooling type 40 W infrared semiconductor laser under the conditions of an output of 9 W, a number of revolutions of external drum of 210 rpm, and a resolution of 2400 dpi. The resulting exposed precursor was attached on a cylinder of a SPRINT 25 printing press manufactured by KOMORI Corporation, without undergoing a development treatment. By the use of fountain solution (EU-3 (etchant manufactured by Fuji Photo Film Co., Ltd.)/water/isopropyl alcohol=1/89/10 (volume ratio)) and TRANS-G(N) Sumi ink (manufactured by Dainippon Ink & Chemicals, Inc.), fountain solution and ink were supplied. Then, printing was carried out at a printing speed of 8000 sheets per hour. As a result, on-press development was carried out to obtain favorable printed matters without stains. At this step, the number of printed sheets required for obtaining a favorable printed matter was evaluated as the on-press developability. The results are shown in Table 3.

### Examples 5 to 8 and Comparative Example 4

Each lithographic printing plate precursor was manufactured by preparing its corresponding image recording layer coating solution in the same manner as in Example 4, except that the microcapsule (1) used in the preparation of the image recording layer coating solution of Example 4 was changed as shown in the Table 2 shown below. The evaluation of the stability with time of each resulting image recording layer coating solution, and the evaluation of printing of each lithographic printing plate precursor were carried out in the same manner as in Example 4. The results are shown in Table 3.

The greasing, the ink repellency and the plate wear resistance in Examples 4 to 8 and Comparative Example 4 were evaluated in the above manner. The results are shown in Table 3.

TABLE 2
Micracapsule used

| | Microcapsule used |
|---|---|
| Example 5 | Microcapsule (2) |
| Example 6 | Microcapsule (3) |
| Example 7 | Microcapsule (4) |
| Example 8 | Microcapsule (5) |
| Comparative | Microcapsule (6) |
| Example 4 | |

TABLE 3
Evaluation results

| | Coating | On-press developability | | |
|---|---|---|---|---|
| | solution | Coating after | Coating after | Coating after |
| | expiration date | 1 hour | 12 hours | 3 days |
| Example 4 | 10 days | 20 sheets | 20 sheets | 20 sheets |
| Example 5 | 7 days | 20 sheets | 20 sheets | 20 sheets |
| Example 6 | 7 days | 20 sheets | 20 sheets | 20 sheets |
| Example 7 | 7 days | 20 sheets | 20 sheets | 20 sheets |
| Example 8 | 24 hours | 20 sheets | 20 sheets | 100 sheets |
| Comparative | 5 hours | 20 sheets | 70 sheets | 100 sheets |
| Example 4 | | | | |

| | | Number of sheets | Number of print wear |
|---|---|---|---|
| | | for ink repellency | resistant sheets |
| | Greasing | (number of sheets) | (number of sheets) |
| Example 4 | ∘ | 10 | 15000 |
| Example 5 | ∘ | 10 | 15000 |
| Example 6 | ∘ | 15 | 20000 |
| Example 7 | ∘ | 15 | 25000 |
| Example 8 | ∘ | 10 | 20000 |
| Comparative | ∘ | 50 | 10000 |
| Example 4 | | | |

As apparent from Table 3, the image recording layer coating solutions using the microcapsules of the invention (Examples 4 to 8) are superior in stability with time of the coating solution to the image recording layer coating solution using a conventional microcapsule (Comparative Example 4) as well as greasing, the ink repellency and the plate wear resistance. Even after the storage of the image recording layer coating solution for a long period, the deterioration of the on-press developability caused by the reduction of the microcapsule content of the image recording layer due to the microcapsule precipitation is not entailed. As a result, it becomes possible to obtain favorable printing performances.

As the result in Table 4, the lithographic printing plate precursors of Examples including a microcapsule in the invention have a excellent property in view of a printing stain and press life.

### Example 9

A lithographic printing plate precursor was fabricated in the same manner as in Example 4, except that the following aqueous solvent solution (A) was used in place of the aqueous solvent solution in Example 4, and the evaluations were carried out in the same manner as in Examples 1 and 4.

Greasing was o; the number of sheets for ink repellency was 15 sheets; The number of print wear resistant sheets (press life) was 15,000 sheets; the coating solution expiration date was 2 days; the on-press developability (coating after 1 hour) was 20 sheets; the on-press developability (coating after 12 hours) was 20 sheets; and the on-press developability (coating after 3 days) was 100 sheets.

| | |
|---|---|
| Micro gel (1) synthesized as described below | 10.0 g |
| Distilled water | 47.1 g |
| Fluorine-containing surfactant (1) | 0.05 g |
| (Synthesis of micro gel (1)) | |

As an oil phase component, 10 g of an adduct of trimethylolpropane and xylene diisocyanate (manufactured by Mitsui Takeda Chemicals, Inc., TAKENATE D-110N), 3.15 g of pentaerythritol triacrylate (manufactured by Nippon Kayaku Co., Ltd., SR444), and 0.1 g of PAIONIN A-41C (manufactured by TAKEMOTO OIL & FAT Co., Ltd.) were dissolved in 17 g of ethyl acetate. As an aqueous phase component, 40 g of a 4 mass % aqueous solution of PVA-205 was prepared. The oil phase component and the aqueous phase component were mixed, and emulsified at 12,000 rpm for 10 minutes by a homogenizer. The resulting emulsion was added to 25 g of distilled water. The mixture was stirred at room temperature for 30 minutes, and then, stirred at 50° C. for 3 hours. The micro gel solution thus obtained was diluted with distilled water so that the solid content concentration was 15 mass %. The average particle diameter was 0.2 μm.

This application is based on Japanese patent applications JP 2004-222932, filed on Jul. 30, 2004 and JP 2004-264982, filed on Sep. 13, 2004, the entire content of which is hereby incorporated by reference, the same as if set forth at length.

What is claimed is:

1. A lithographic printing plate precursor comprising a support and an image recording layer removable by a printing ink and/or fountain solution, the image recording layer containing a microcapsule and (A) an active light absorber, wherein the microcapsule is produced by
dissolving a multifunctional isocyanate compound having two or more isocyanate groups in a water immiscible solvent,
emulsifying and dispersing the solution in an aqueous solution containing a hydrophilic polymer having one or more active hydrogen groups reactable with isocyanate groups at one terminal, and then,
removing the solvent from the oil droplet in the emulsified and dispersed solution.

2. A lithographic printing plate precursor comprising a support and an image recording layer removable by a printing ink and/or fountain solution, the image recording layer containing (A) an active light absorber and a microcapsule encapsulating a hydrophilic compound, wherein the microcapsule is produced by
dissolving a multifunctional isocyanate compound having two or more isocyanate groups and the hydrophobic compound in a water immiscible solvent,
emulsifying and dispersing the solution in an aqueous solution containing a hydrophilic polymer having one or more active hydrogen groups reactable with isocyanate groups at one terminal, and then,
removing the solvent from the oil droplet in the emulsified and dispersed solution.

3. A lithographic printing plate precursor comprising a support and an image recording layer removable by a printing ink and/or fountain solution, the image recording layer containing (A) an active light absorber, (B) a polymerization initiator, (C) a polymerizable compound, (D) a hydrophobic binder polymer and a microcapsule, in which the microcapsule encapsulates at least one of the (A) to (D), wherein the microcapsule is produced by
dissolving a multifunctional isocyanate compound having two or more isocyanate groups and at least one of (A) the active light absorber, (B) the polymerization initiator, (C) the polymerizable compound, and (D) the hydrophobic binder polymer in a water immiscible solvent,
emulsifying and dispersing the solution in an aqueous solutions containing a hydrophilic polymer having one or more active hydrogen groups reactable with isocyanate groups at one terminal, and then,
removing the solvent from the oil droplet in the emulsified and dispersed solution.

4. A lithographic printing plate precursor comprising a support and an image recording layer removable by a printing ink and/or fountain solution, the image recording layer containing (A) an active light absorber, (B) a polymerization initiator, (C) a polymerizable compound, (D) a hydrophobic binder polymer and a microcapsule, wherein the microcapsule encapsulates at least one of the (A) to (D), and the microcapsule includes polyurea or polyurethane/urea obtained by the polymerization reaction of an isocyanate compound and a compound having an active hydrogen as the wall material, in which the isocyanate compound includes a reaction product of (1) an at least di-functional isocyanate compound and (2) a polyether derivative having a terminal amino group, represented by the following general formula (I):
(I)
where X represents a linking group, A represents an allylene group or an alkylene group, L represents an alkylene group, and R represents an organic group not having an active hydrogen, m represents 0 or 1; and n is a number of 10 to 500 in terms of the average addition mole number of a polyether group.

5. The lithographic printing plate precursor according to claim 1, wherein the image recording layer further contains another microcapsule or micro gel encapsulating at least one of the components (A) to (D).

6. The lithographic printing plate precursor according to claim 2, wherein the image recording layer further contains another microcapsule or micro gel encapsulating at least one of the components (A) to (D).

7. The lithographic printing plate precursor according to claim 3, wherein the image recording layer further contains another microcapsule or micro gel encapsulating at least one of the components (A) to (D).

8. The lithographic printing plate precursor according to claim 4, wherein the image recording layer further contains another microcapsule or micro gel encapsulating at least one of the components (A) to (D).

9. A lithographic printing method comprising:
mounting the lithographic printing plate precursor according to claim 1 on a printer press and then imagewise exposing the plate precursor to light by an infrared laser, or imagewise exposing the plate precursor to light by an infrared laser and then mounting the plate precursor on a printer press; and
feeding a printing ink and fountain solution to the plate precursor and thereby removing the infrared laser unexposed areas of the image recording layer to perform a printing.

10. A lithographic printing method comprising:
mounting the lithographic printing plate precursor according to claim 2 on a printer press and then imagewise exposing the plate precursor to light by an infrared laser, or imagewise exposing the plate precursor to light by an infrared laser and then mounting the plate precursor on a printer press; and
feeding a printing ink and fountain solution to the plate precursor and thereby removing the infrared laser unexposed areas of the image recording layer to perform a printing.

11. A lithographic printing method comprising:
mounting the lithographic printing plate precursor according to claim 3 on a printer press and then imagewise exposing the plate precursor to light by an infrared laser, or imagewise exposing the plate precursor to light by an infrared laser and then mounting the plate precursor on a primer press; and
feeding a printing ink and fountain solution to the plate precursor and thereby removing the infrared laser unexposed areas of the image recording layer to perform a printing.

12. A lithographic printing method comprising:
mounting the lithographic printing plate precursor according to claim 4 on a printer press and then imagewise exposing the plate precursor to light by an infrared laser, or imagewise exposing the plate precursor to light by an infrared laser and then mounting the plate precursor on a printer press; and
feeding a printing ink and fountain solution to the plate precursor and thereby removing the infrared laser unexposed areas of the image recording layer to perform a printing.
